(19) United States
(12) Patent Application Publication
(10) Pub. No.: US 2025/0035226 A1
(43) Pub. Date: Jan. 30, 2025

(54) Plurality of Studs being Friction Welded to an Exterior Surface of a Storage Tank having a Block Patch and a Member between the Exterior Surface and the Studs

(71) Applicant: Forge Tech, Inc., Kemah, TX (US)

(72) Inventors: Michael Lee Miller, Kamah, TX (US); Daniel J. Rybicki, Kemah, TX (US); Mathew A. Rybicki, Kemah, TX (US); Lawrence J. Povse, Kemah, TX (US); Kenneth R. Vejr, Kemah, TX (US); Andre S. Todd, Kemah, TX (US); John M. Griffin, Kemah, TX (US)

(73) Assignee: Forge Tech, Inc., Bldg. 15, TX (US)

(21) Appl. No.: 18/912,582

(22) Filed: Oct. 11, 2024

Related U.S. Application Data
(63) Continuation of application No. 18/507,049, filed on Nov. 11, 2023.
Application No. 18/507,049 is a continuation of application No. 18/176,475, filed on Feb. 28, 2023, now Pat. No. 11,815,192.
Application No. 18/176,475 is a continuation of application No. 17/694,526, filed on Mar. 14, 2022, now Pat. No. 11,592,117.
Application No. 17/694,526 is a continuation of application No. 16/999,056, filed on Aug. 20, 2020, now Pat. No. 11,274,763.
Application No. 16/999,056 is a continuation of application No. 16/174,162, filed on Oct. 29, 2018, now abandoned.
Application No. 16/174,162 is a continuation of application No. 15/832,759, filed on Dec. 5, 2017, now Pat. No. 10,113,659.
Application No. 15/832,759 is a continuation of application No. 15/187,776, filed on Jun. 20, 2016, now Pat. No. 9,835,262.
Application No. 15/187,776 is a continuation of application No. 13/918,956, filed on Jun. 15, 2013, now Pat. No. 9,371,951.
(63) Continuation of application No. 18/186,938, filed on Mar. 20, 2023.
Application No. 18/186,938 is a continuation of application No. 16/188,196, filed on Nov. 12, 2018, now Pat. No. 11,607,756.
Application No. 16/188,196 is a continuation of application No. 14/930,570, filed on Nov. 2, 2015, now Pat. No. 10,124,448.
Application No. 14/930,570 is a continuation of application No. 13/678,668, filed on Nov. 16, 2012, now Pat. No. 9,174,313.
(60) Provisional application No. 61/760,646, filed on Feb. 4, 2013.
(60) Provisional application No. 61/835,563, filed on Jun. 15, 2013.
(60) Provisional application No. 61/582,329, filed on Dec. 31, 2011.

(51) Int. Cl. F16K 27/00; B23K 20/12; B23K 20/14; B23P 6/00; B23P 6/04; F16K 41/00; F16K 43/00; F16L 3/00; F16L 3/24; F16L 23/16; F16L 55/168; F16L 55/18; F16M 13/00

(52) U.S. Cl. CPC F16K 27/00; B23K 20/122; B23K 20/123; B23P 6/00; B23P 6/04; F16K 41/00; F16K 43/00; F16L 23/165; F16L 55/1683; F16L 55/18; F16M 13/00; B23K 20/1285; B23K 20/14; F16L 3/00; F16L 3/24; F16L 55/168; Y10T 29/49405; Y10T 29/49407; Y10T 29/49746; Y10T 29/49826; Y10T 137/0491; Y10T 137/598; Y10T 408/567

(57) ABSTRACT

In some implementations, an apparatus includes a curved portion of a storage tank having an exterior surface, having an interior surface and having a defect, the apparatus also includes a steel patch positioned over the curved portion of a storage tank, a plurality of studs and nuts positioned near an outer perimeter of the steel patch, in which the plurality of studs being friction welded to the exterior surface of the curved portion of a storage tank.

### RELATED APPLICATIONS

This application is a continuation of, and claims the benefit and priority under 35 U.S.C. 120 of co-pending U.S. application Ser. No. 18/186,938 filed 20 Mar. 2023 having docket ‘Forge.0001.Cont-E’, which under 35 U.S.C. 120 claims priority to and benefit of copending U.S. application Ser. No. 16/188,196 filed 12 Nov. 2018 having docket ‘Forge.0001.Cont-D’, now patent Ser. No. 11/607,756 issued on 21 Mar. 2023 which under 35 U.S.C. 120 claims priority to and benefit of copending U.S. application Ser. No. 14/930,570 filed 2 Nov. 2015 having docket ‘Forge.0001.Cont-C’, now U.S. Pat. No. 10,124,448 issued on 13 Nov. 2018 which under 35 U.S.C. 120 claims priority to and benefit of copending U.S. application Ser. No. 13/678,668 filed 16 Nov. 2012 having docket ‘Forge.0001’ now U.S. Pat. No. 9,174,313 issued on 3 Nov. 2015, which under 35 U.S.C. 119 (e) claims priority to U.S. Provisional Application Ser. No. 61/582,329 filed 31 Dec. 2011.

This application is also a continuation of, and claims the benefit and priority under 35 U.S.C. 120 of co-pending U.S. application Ser. No. 18/507,049 filed on 11 Nov. 2023 having docket ‘Forge.0002.D-Cont-7’, which is a continuation of, and claims the benefit and priority under 35 U.S.C. 120 of U.S. application Ser. No. 18/176,475 filed on 28 Feb. 2023 having docket ‘Forge.0002.D-Cont-6’ now patent Ser. No. 11/815,192 issued on 14 Nov. 2023, which is a continuation of, and claims the benefit and priority under 35 U.S.C. 120 of U.S. application Ser. No. 17/694,526 filed on 14 Mar. 2022 having docket ‘Forge.0002.D-Cont-5’ now patent Ser. No. 11/592,117 issued on 28 Feb. 2023, which is a continuation of, and claims the benefit and priority under 35 U.S.C. 120 of U.S. application Ser. No. 16/999,056 filed on 20 Aug. 2020 having docket ‘Forge.0002.D-Cont-4’ now patent Ser. No. 11/274,763 issued on 15 Mar. 2022, which is a continuation of, and claims the benefit and priority under 35 U.S.C. 120 of U.S. application Ser. No. Ser. No. 16/174,162 filed on 29 Oct. 2018 having docket ‘Forge.0002.D-Cont-3’, abandoned on 15 Sep. 2020, which is a continuation of, and claims the benefit and priority under 35 U.S.C. 120 of U.S. application Ser. No. 15/832,759 filed on 5 Dec. 2017 having docket ‘Forge.0002.D-Cont-2’ now patent Ser. No. 10/113,659 issued on 30 Oct. 2018 which is a continuation of, and claims the benefit and priority under 35 U.S.C. 120 of co-pending U.S. application Ser. No. 15/187,776 filed on 20 Jun. 2016 having docket ‘Forge.0002.D-Cont’ now U.S. Pat. No. 9,835,262 issued on 5 Dec. 2017 which is a continuation of, and claims the benefit and priority under 35 U.S.C. 120 of U.S. application Ser. No. 13/918,956 having docket ‘Forge.0002.D’ filed on 15 Jun. 2013 now U.S. Pat. No. 9,371,951 issued on 21 Jun. 2016, which is hereby incorporated by reference in its entirety, which claims the benefit of U.S. Provisional Application Ser. No. 61/760,646 filed 4 Feb. 2013 under 35 U.S.C. 119 (e), expired in 4 Feb. 2014, which also claims the benefit of U.S. Provisional Application Ser. No. 61/835,563 filed 15 Jun. 2013 under 35 U.S.C. 119 (e), expired on 15 Jun. 2014.

### FIELD

The present disclosure generally relates to repair of tanks and more specifically relates to techniques and apparatus of repair of tank components.

### BACKGROUND

Conventional welding techniques and apparatus can include an ignition source, which may ignite combustible materials. An ignition source is particularly dangerous when repairing defects in petroleum product storage tanks. Conventional techniques include arc welding, brazing, adhesives, drill and tap, mechanical fasteners, clamps and polymer patches.

Many tanks contain chemicals that are volatile or caustic with unsafe leakage levels measured in parts per million (ppm). Not only are these chemicals hazardous to the environment, but also to the technicians who are repairing them.

### BRIEF DESCRIPTION OF THE DRAWINGS

It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is an isometric top-side view of a tank having a floating steel roof,

FIG. 2 is a method of a process of tank repair;

FIG. 3 is a flowchart of a method of a tank repair process;

FIG. 4 is a flowchart of a method of a tank repair process;

FIG. 5 is a side-view of a block diagram of a friction welding apparatus that uses inert gas;

FIG. 6 is a top view block diagram of a friction welding apparatus that uses inert gas;

FIG. 7 is a side view of block diagram of a friction welding apparatus that uses inert gas;

FIG. 8 is a side-view of a block diagram of a friction welding apparatus that uses inert gas;

FIG. 9A is a side-view of a block diagram of a friction welding apparatus that uses a vacuum chamber formed from a flexible seal; a housing and a magnetic apparatus;

FIG. 9B is a top-view of a block diagram of a friction welding apparatus that uses a vacuum formed from a flexible seal; a housing and a magnetic apparatus;

FIG. 10 is a side-view of a block diagram of a friction welding apparatus that uses a vacuum chamber formed from a flexible outer seal; a housing and a flexible inner seal;

FIG. 11 is a top-view of a block diagram of a friction welding apparatus that uses a vacuum formed from flexible seals and a housing;

FIG. 12 is a side-view of a block diagram of a friction welding apparatus that uses an inert gas chamber formed from a flexible outer seal; a housing and a flexible inner seal;

FIG. 13 is a top-view of a block diagram of a friction welding apparatus that uses a vacuum formed from flexible seals and a housing;

FIG. 14 is a side-view of a block diagram of a friction welding apparatus that uses a chamber of inert gas formed from a flexible seal; a housing and a magnetic apparatus;

FIG. 15 is a side view of a block diagram of a friction welding apparatus that uses a chamber of inert gas formed from a flexible seal; a housing and a magnetic apparatus;

FIG. 16 is a side-view of a block diagram of a friction welding apparatus that uses a chamber of inert gas formed from a flexible seal; a housing and an adhesive apparatus;

FIG. 17 is a side view of a block diagram of a friction welding apparatus that uses wing-nut tensioners and levers;

FIG. 18 is a side-view of a block diagram of a motor or other rotational means;

FIG. 19 is a top-view of a block diagram of a motor or other rotational means;

FIG. 20 is a motor or other rotational means;

FIG. 21 is a motor or other rotational means;

FIG. 22 is a motor or other rotational means;

FIG. 23 is a pneumatic motor propulsion source;

FIG. 24 is a pneumatic motor propulsion source;

FIG. 25 is a pneumatic motor propulsion source;

FIG. 26 is a pneumatic motor propulsion source;

FIG. 27 is a top-view of a block diagram of a defect perimeter sealing system;

FIG. 28 is a cross-section side-view of a block diagram of a defect perimeter sealing system;

FIG. 29 is a cross-section side-view of a block diagram of a defect perimeter sealing system;

FIG. 30 is a side view of a block diagram of a defect perimeter sealing system;

FIG. 31 is a side view of a block diagram of a defect perimeter sealing system;

FIG. 32 is a top-view of a block diagram of a defect perimeter sealing system;

FIG. 33A is a side-view of a block diagram of interlocking sections of a perimeter gasket of a defect perimeter sealing system;

FIG. 33B is a side-view of a block diagram of interlocking sections of a perimeter gasket of a defect perimeter sealing system;

FIG. 33C is a side-view of a block diagram of interlocking sections of a perimeter gasket of a defect perimeter sealing system;

FIG. 34 is a cross-section side-view of a block diagram of a layered defect perimeter sealing system;

FIG. 35 is a side view of a block diagram of interlocking sections of a perimeter gasket of a defect perimeter sealing system;

FIG. 36 is a side-view of a block diagram of T-channel interlocking sections of a perimeter gasket of a defect perimeter sealing system;

FIG. 37 is an isometric view of a block diagram of T-channel interlocking sections of a perimeter gasket of a defect perimeter sealing system;

FIG. 38A is a cross-section side-view of a block diagram of sections of a perimeter gasket of a defect perimeter sealing system;

FIG. 38B is a top-view of a block diagram of sections of a perimeter gasket of a defect perimeter sealing system;

FIG. 39 is a top-view of a block diagram of sections of a perimeter gasket of a defect perimeter sealing system;

FIG. 40 is a side-view of a cross section block diagram of a friction welding apparatus;

FIG. 41 illustrates eight different stud geometries;

FIG. 42 is a block diagram of a side view of a magnet clamp being used on a large pipe, according to an implementation;

FIG. 43 is cross section block diagram of a top view of the magnet clamp shown in FIG. 63, according to an implementation;

FIG. 44A is an isometric diagram and 44B is a cross section diagram of a repaired pipe using a metal patch, according to an implementation;

FIG. 45A is an isometric diagram and 45B is a cross section diagram of a repair plate that uses a channel gasket, according to an implementation;

FIGS. 46A and 46B are cross section diagrams of a plate that is pre-warped to mismatch the curvature of a pipe, according to an implementation;

FIG. 47A is an isometric diagram and 47B is a block diagram of a plate that is pre warped with a gradient to alter the location of the maximum pressure on the pipe to enhance sealing at the defect area, according to an implementation;

FIG. 48A is an isometric diagram and 48B is a cross section diagram of a block patch used to add more pressure at a defect area of a pipe to enhance sealing of the defect, according to an implementation;

FIG. 49A is a cross section diagram and 49B is a cross section diagram of a block patch with tensioners, according to an implementation;

FIG. 50 is cross section diagram of a block patch with adjusters, according to an implementation;

FIG. 51 is a cross section diagram of portable friction forge bonder (PFFB) with studs being used to secure a walkway to a pipe, according to an implementation;

FIG. 52 is a cross section diagram of a portable friction forge bonder used to attach cathodes for cathodic protection systems on pipelines, according to an implementation;

FIG. 53 is a cross section diagram of a large 2″ fitting attached for testing of chemicals in a pipe, testing of the environment outside the pipe or both, according to an implementation;

FIG. 54 is a block diagram of a portable friction forge bonder, according to an implementation;

FIG. 55 is a cross-sectional drawing of a preferred embodiment of the actuator, according to an implementation;

FIG. 56 is the cross-sectional drawing of another embodiment of the actuator, according to an implementation

FIG. 57 is an isometric diagram of a boss or Permanent Universal Receiver (PUR) attached through friction welding to an in-service pipe, pressure component or a valve, according to an implementation;

FIGS. 58A and 58B are an isometric drawing of a PUR or boss that is bonded to a work surface through friction welding and subjected to a lateral force at the top of the PUR or boss, according to an implementation;

FIG. 59 is PUR or boss that has been attached to a work surface and is threaded with a tapered thread such as a National Pipe Thread (NPT), according to an implementation;

FIG. 60 is a very low-profile boss or PUR that is solid-state welded to a work piece, the PUR for receiving a threaded stud and jam nut which is screwed into a chuck, according to an implementation;

FIG. 61 is a cross section side view of the very low-profile boss in FIG. 60, according to an implementation having internal threads on the very low-profile boss;

FIG. 62 is a cross section side view of the very low-profile boss in FIG. 60, according to an implementation having external threads on the very low-profile boss;

FIG. 63 is a cross section side view of the very low-profile boss in FIG. 60, according to an implementation;

FIG. 64 is a cross section diagram of an apparatus for measuring, sensing and/or controlling stud or PUR displacement during the friction welding process, according to an implementation;

FIG. 65 is side view diagram of an ultrasonic enhanced friction welder, according to an implementation;

FIG. 66 is an isometric view of a threaded cup containment device for adding a backup seal for the isolation gate, according to an implementation;

FIG. 67A is an isometric diagram of a multi-motor drive system for doubling the drive capability of a portable friction welding system, according to an implementation;

FIG. 67B is a bottom view block diagram of a multi-motor drive system for doubling the drive capability of a portable friction welding system, according to an implementation;

FIG. 68 is a block diagram of a multi-motor drive system for doubling the drive capability of a portable friction welding system, according to an implementation.

### DETAILED DESCRIPTION OF THE DRAWINGS

The detailed description below describes methods and apparatus for repairing and sealing of valves, pipes and pipe components.

The numerous innovative teachings of the present application will be described with particular reference to the exemplary embodiments. However, it should be understood that this class of embodiments provides only a few examples of the many advantageous uses of the innovative teachings herein. In general, statements made in the specification of the present application do not necessarily limit any of the various claimed inventions. To the contrary, the description of the exemplary embodiments are intended to cover alternative, modifications, and equivalents as may be included within the spirit and scope of the invention as defined by the claims. Moreover, some statements may apply to some inventive features but not to others.

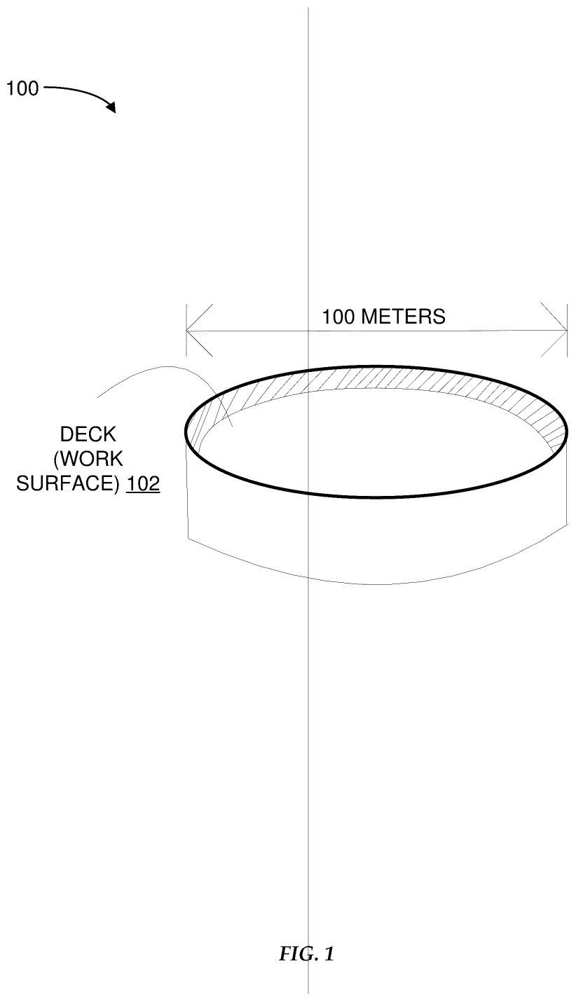

FIG. 1 is an isometric top-side view of a tank 100 having a floating steel roof. Tanks are used to store every known hydrocarbon liquid or gas. The tank 100 includes a deck 102, which is the top of the tank 100. In some implementations, the deck 102 is made of steel and floats above the contents of the tank 100 through floats that are on the bottom of the deck 102. In some implementations, the deck 102 is 3/16 inches of hot rolled steel. Tanks made of steel are exposed to weather, ocean salt and caustic or acidic chemicals which causes corrosion over time.

Tanks are manufactured in many different sizes but in the implementation shown in FIG. 1 tank 100 is 100 meters in diameter.

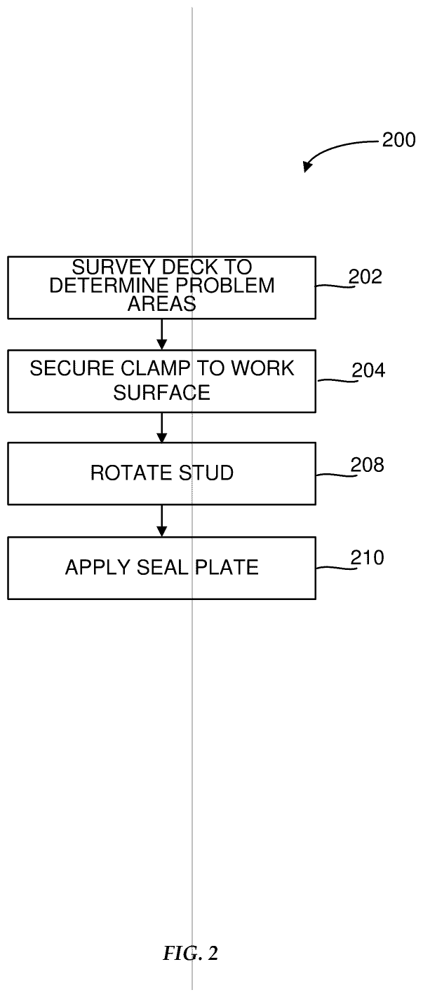

FIG. 2 is a method 200 of a process of tank repair. At block 202, method 200 includes surveying a deck of a tank such as deck 102 in FIG. 1 to identify problem and or defect areas on the deck. Thereafter at block 204 method 200 further includes a securing a clamp to the deck in proximity to the problem or defect area to begin repair work on the surface of the deck in the area of the problem or defect area. In some implementations, method 200 includes using the clamp to apply an axial load to a stud. Thereafter at block 208, method 200 includes rotating the stud and at block 210, and at block 210 applying a seal plate to the problem or defect area on the deck. Alternatives to the stud include a threaded boss, or nut, a pass through apparatus, fittings, nozzles, nodes, zerts and nails.

In some implementations of rotating the stud at block 208, rotating the stud further includes rotating the stud until a weld reaches a predetermined temperature, number of rotations, stud link reduction (displacement), time or combination. In some implementations of method 200, method 200 includes deburring the stud after rotating the stud at block 208. In some implementations of applying the seal plate at block 210, compression, injection or a gravity fill seal is used to apply the seal plate.

Advantages of methods and other portions of this disclosure include dissimilar metals can be bonded, final strength is greater than either of the two metals used, bonding can be performed in hazardous environments (ie: explosive environments) and portability for ease of use at worksites.

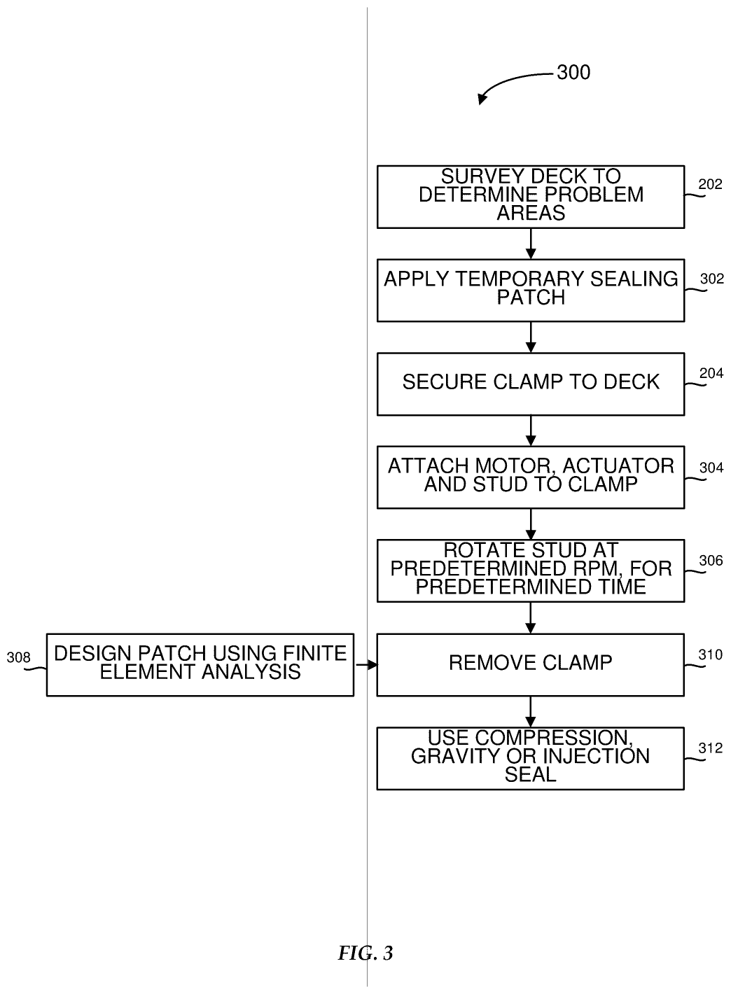

FIG. 3 is a flowchart of a method 300 of a tank repair process. At block. 202, method 300 includes surveying a deck of a tank such as deck 102 in FIG. 1 to identify problem and or defect areas on the deck. At block 302, method 300 includes applying a temporary sealing patch to the identified problem or defect areas. Thereafter at block 204 method 200 further includes a securing a clamp to the deck in proximity to the problem or defect area to begin repair work on the surface of the deck in the area of the problem or defect area. Thereafter at block 304, method 300 includes attaching a motor, an actuator and a stud to the clamp. In some implementation, humans perform the function of the clamp. Some implementations of using the clamp to apply an axial load to a stud includes using the clamp to apply an axial load to a stud. Thereafter at block 306, method 300 includes rotating the stud at a predetermined RPM speed for a predetermined time. At block 308, method 300 also includes designing a patch using finite element analysis. Thereafter, at block 310, method 300 includes removing the clamp, and at block 312, method 300 includes using compression, gravity or an injection seal to apply a seal plate.

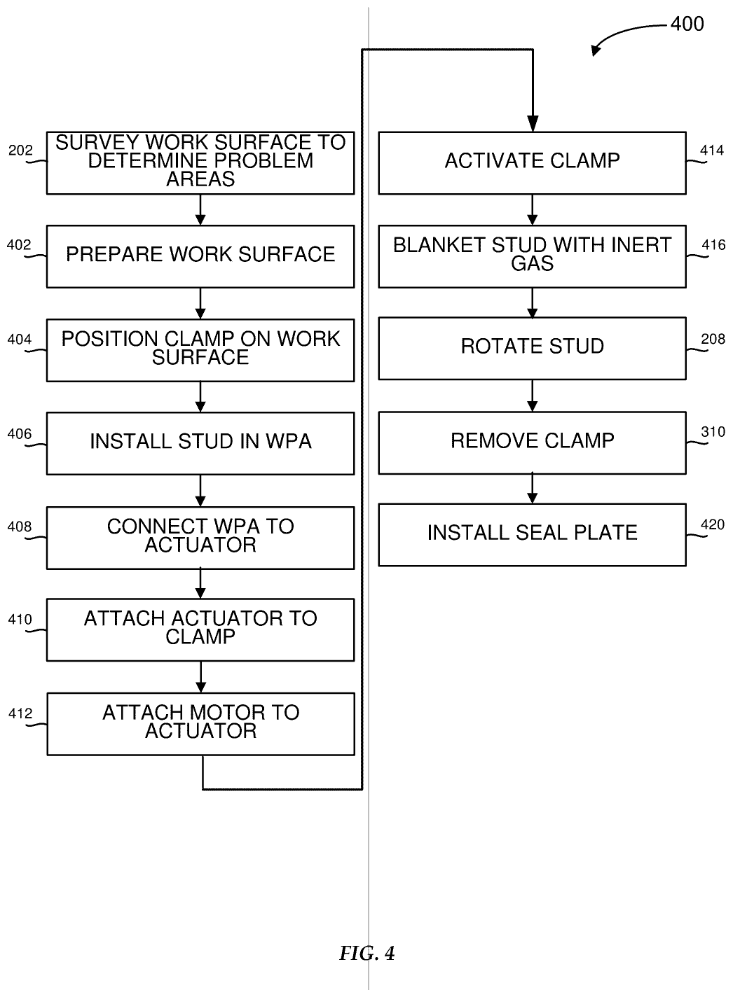

FIG. 4 is a flowchart of a method 400 of a tank repair process. At block 202 method 400 includes surveying a deck of a tank such as deck 102 in FIG. 1 to identify problem and or defect areas on the deck. At block 302, method 300 includes applying a temporary sealing patch to the identified problem or defect areas. Thereafter, at block 402, method 400 includes preparing a work surface in the vicinity of the identified problem or defect areas.

Thereafter, at block 404, method 400 includes positioning a clamp on the work surface in the vicinity of the identified problem or defect areas. At block 406, method 400 thereafter includes installing a stud in a work piece adapter (WPA). Thereafter at block 408, method 400 includes connecting the WPA to an actuator. Thereafter at block 410, method 400 includes attaching the actuator to a clamp. Thereafter, at block 412, method 400 includes attaching a motor to the actuator. Thereafter, at block 414 method 400 includes activating the clamp. Thereafter at block 416, method 400 includes blanketing the stud with inert gas. In some implementations, method 400 includes pre-loading the stud axially. Thereafter at block 208, method 400 includes rotating the stud and at block 310, method 400 includes removing the clamp, and at block 420 method 400 includes installing a seal plate.

In one particular method, a deck is inspected, surveyed and measured for seal plate dimensions and lay-out. Then leaks and near leaks are identified and temporarily leak sealed prior to preparation of work area. A vacuum clamp is placed over a prepared work area and aligned with intended lay out or evacuation is performed by a hand pump, a mechanical pump or a simple suction cup design. A work area is cleaned prepared and stud positions are marked. Thereafter, a forging actuator with a pre-loaded stud is inserted into a first work chamber position. Thereafter, an inert atmosphere is created to allow the forging to be accomplished safely. And a required hold down force is generated to allow for the pre-determined load to be applied to the work piece prior to rotation and friction. Thereafter, hydraulics are actuated to achieve pre-determined axial load, and a pneumatic rotational device is locked onto actuator. A controller activates rotation and the friction forge process is sequenced to a timed completion. Actual process is complete in seconds from start to cool-down. The unit can be repositioned to complete the balance of required fasteners in a similar manner. Once all fasteners are completed, the rigid, mechanically attached seal plate is installed. The seal plate can be flexible, such as being a thick rubber gasket with a rigid perimeter bolt plate (akin to a window frame). The method provides both positive containment and improved structural integrity of weakened or distorted decking.

In general various implementations of the seal include compression, gravity fill and injection. Various attachments can be installed to improve existing integrity of storage tank including over lays and stiffeners.

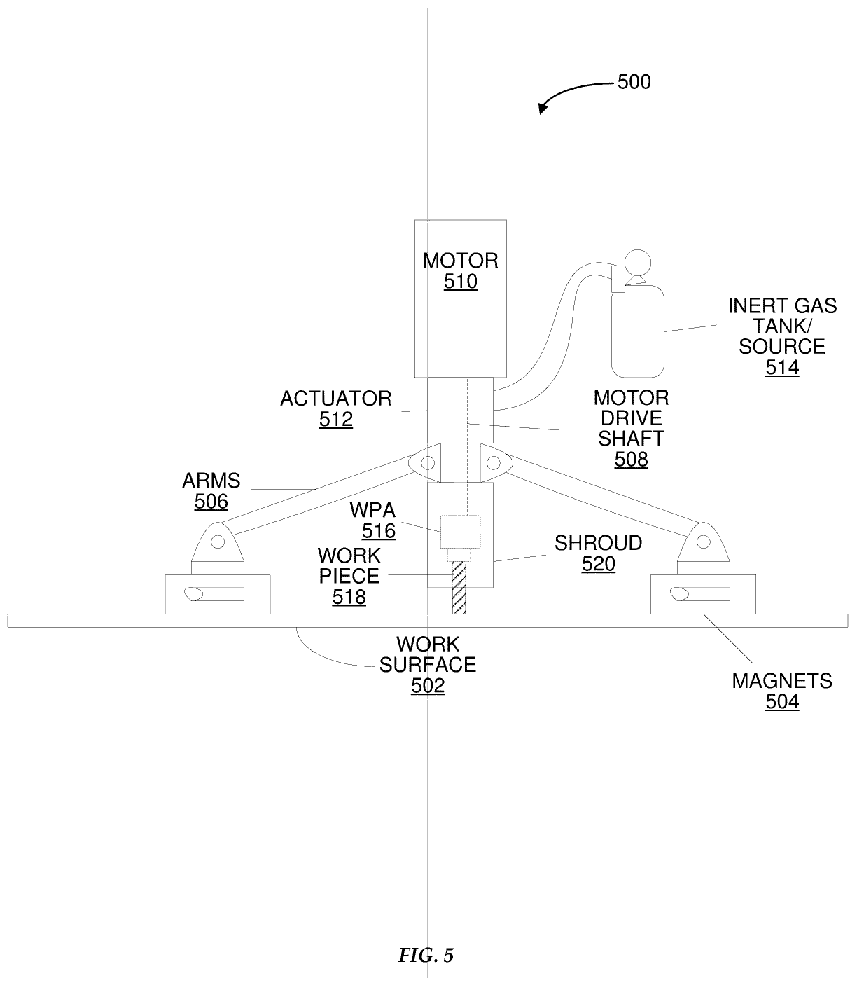

FIG. 5 is a side-view of a block diagram of a friction welding apparatus 500 that uses inert gas. Friction welding includes inertial welding, solid phase friction welding, ultrasonic welding or rotational friction welding. The friction welding apparatus 500 generates less heat to the extent that combustible materials are not combusted. Examples of the inert gas are nitrogen, argon and helium. The friction welding apparatus 500 is positioned over a work surface 502 such as deck 102 in FIG. 1. The friction welding apparatus 500 includes magnets 504 that are placed in direct contact to the work surface 502. The friction welding apparatus also includes arms 506 that are rotatably attached to the magnets 504 and that are rotatably attached to a body of the friction welding apparatus. The friction welding apparatus 500 also includes a motor drive shaft 508 that is mechanically coupled to a motor 510. In some implementations, the motor 510 is a pneumatic vane motor, or another motor that is made of materials that do not create sparks or an ignition source. Friction welding apparatus 500 also includes an actuator 512 that is removably coupled to an inert gas tank 514. The motor drive shaft 508 is mechanically coupled to a WPA 516, and the WPA is operably coupled to a work piece 518. A shroud 520 encompasses a portion of the work piece 518, the WPA 516 and a lower portion of the motor drive shaft 508. When the inert gas from the inert gas tank 514 is released into the actuator 512, the inert gas flows through the actuator 512 and down to and through the shroud 520 and then out the bottom of the shroud 520, the worksite where the work piece 518 meets the work surface 502 and envelopes the worksite in a non-combustible inert gas thus preventing combustion in the vicinity of the tank.

In regards to all magnet peripheral seals described in the drawings and detailed description herein, a magnet with a peripheral seal can implement an inlet and outlet for injection. As injection occurs, displacement of product will evacuate through the outlet while simultaneously being replaced by sealant when sealant is detected through the outlet. The outlet is closed as long as sealant pressure remains below the holding force of the magnet seal. Various sizes of the outlet are implemented for various needs, which can be straddled with a donut shaped clamp. For mechanical long term repair, a prototype of the magnet can be fairly inexpensive. The motor 510, the actuator 512, the donut shaped clamp and the shroud 520 operate using positive pressure from the inert gas tank 514.

Applications for friction welding of storage tanks include storage tank rooftops, walls and bottoms (floors). Friction welding of storage tanks can performed to repair, improve structural integrity, alter/modify and reconstruct the storage tanks.

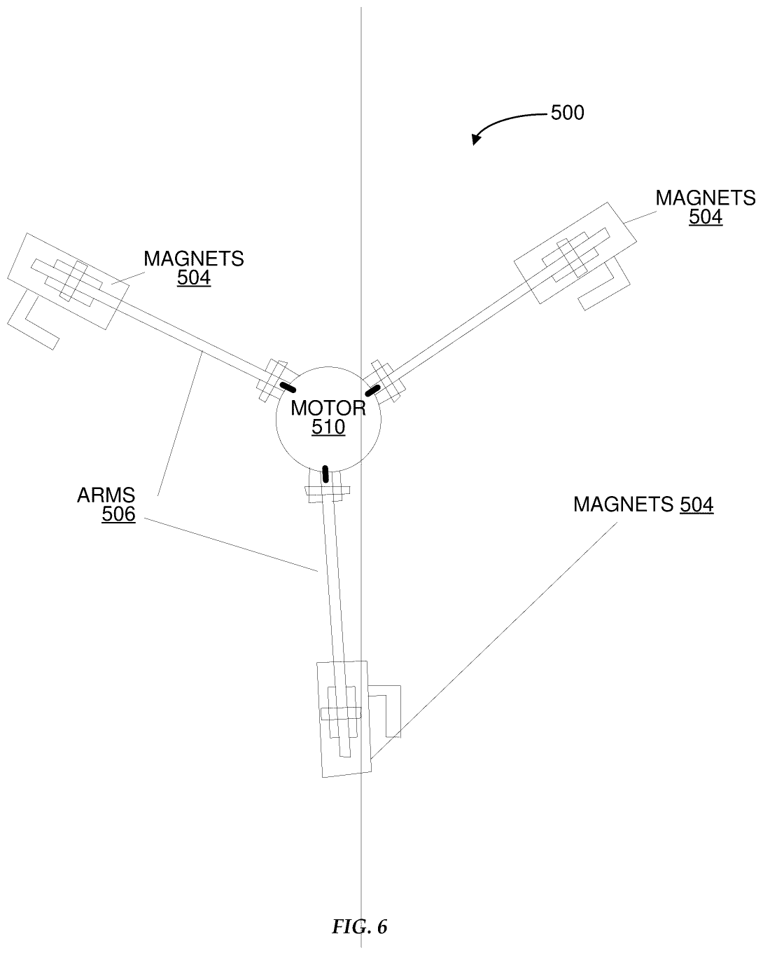

FIG. 6 is a top-view block diagram of a friction welding apparatus 500 that uses inert gas. The friction welding apparatus 500 is positioned over a work surface 502 such as deck 102 in FIG. 1. The friction welding apparatus 500 includes magnets 504 that are placed in direct contact to the work surface 502. The friction welding apparatus 500 also includes arms 506 that are rotatably attached to the magnets 504 and that are rotatably attached to a body of the friction welding apparatus. The friction welding apparatus 500 also includes the motor 510.

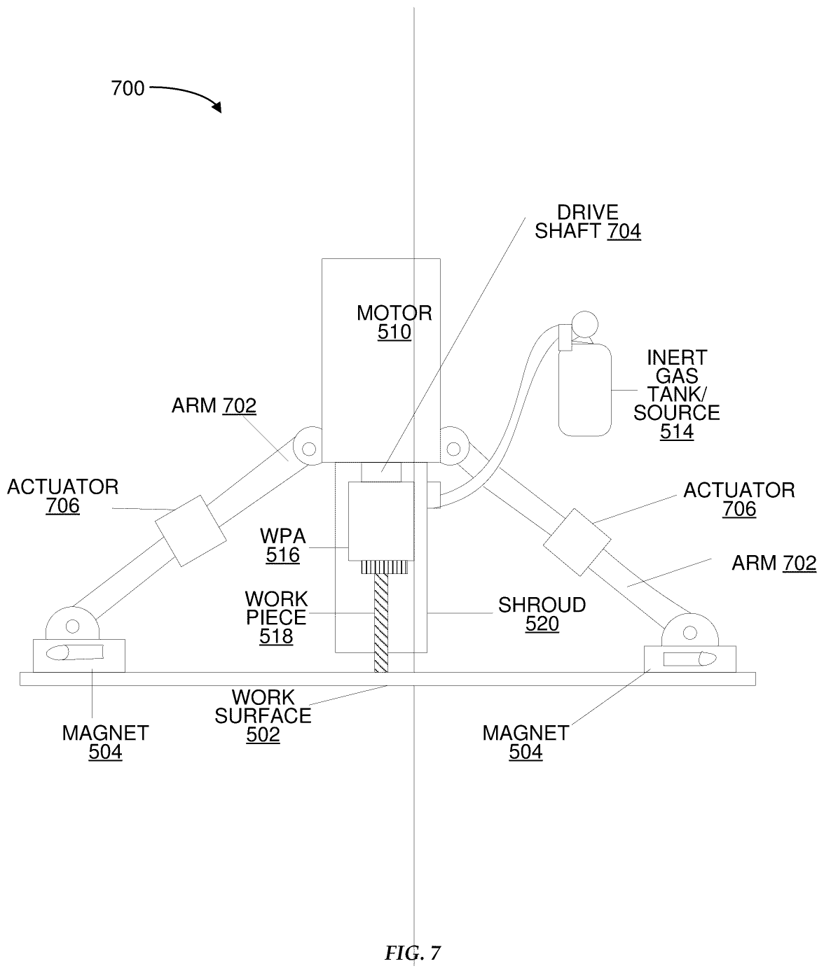

FIG. 7 is a side-view of block diagram of a friction welding apparatus 700 that uses inert gas. The friction welding apparatus 500 generates less heat to the extent that combustible materials are not combusted. Examples of the inert gas are nitrogen, argon and helium. The friction welding apparatus 500 is positioned over a work surface 502 such as deck 102 in FIG. 1. The friction welding apparatus 700 includes magnets 504 that are placed in direct contact to the work surface 502. The friction welding apparatus 700 also includes arms 702 that are rotatably attached to the magnets 504 and that are rotatably attached to a body of the friction welding apparatus 700. The friction welding apparatus 700 also includes a drive motor shaft 704 that is mechanically coupled to motor 510. Friction welding apparatus 700 also includes actuators 706 that is removably coupled to inert gas tank 514. The drive motor shaft 704 is mechanically coupled to a WPA 516, and the WPA is operably coupled to a work piece 518. Shroud 520 encompasses an upper portion of the work piece 518, the WPA 516 and a lower portion of the drive motor shaft 704. When the inert gas from the inert gas tank 514 is released, the inert gas flows down to and through the shroud 520 and then out the bottom of the shroud 520, the worksite where the work piece 518 meets the work surface 502 and envelopes the worksite in a non-combustible inert gas thus preventing combustion in the vicinity of the tank.

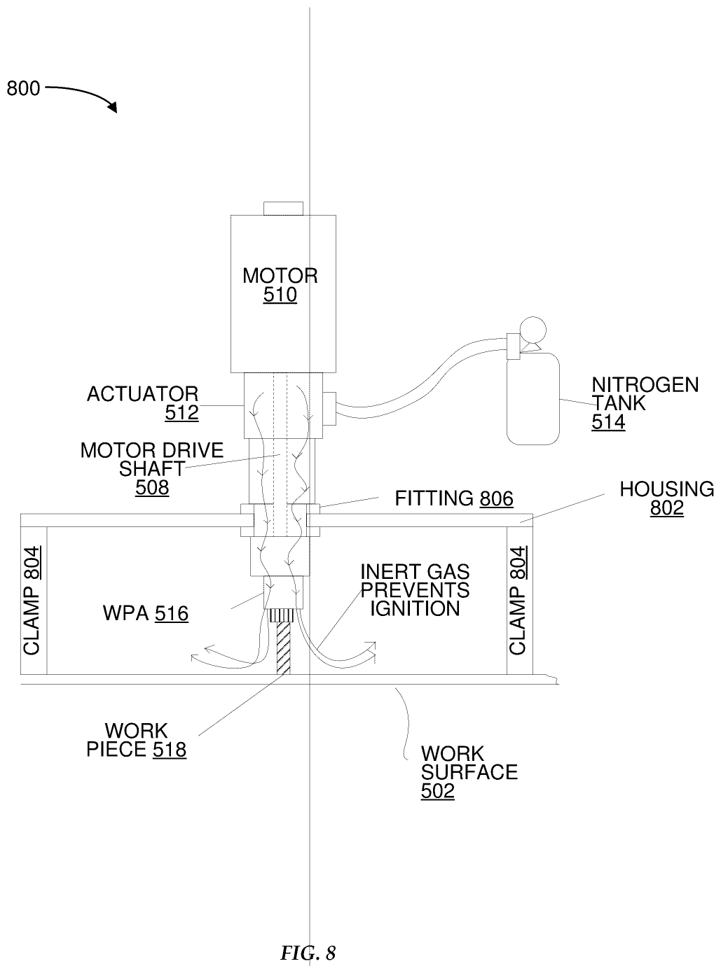

FIG. 8 is a side-view of a block diagram of a friction welding apparatus 800 that uses inert gas. The friction welding apparatus 800 generates less heat to the extent that combustible materials are not combusted. Examples of the inert gas are nitrogen, argon and helium. The friction welding apparatus 800 is positioned over a work surface 502 such as deck 102 in FIG. 1. The friction welding apparatus 800 includes a housing 802 that is secured to the work surface 502 through a number of clamps 804. A fitting 806 provides a substantially air tight seal between the housing 802 and the actuator 512. Indeed, the housing 802, the clamps 804 and the fitting 806 provide a substantially air tight seal with the work surface 502. The substantially air tight seal is not completely airtight but in fact provides deminimus passage of gas out of the enclosure formed by the housing 802, the clamps 804, fitting 806 and the work surface 502. The friction welding apparatus 800 also includes a motor drive shaft 508 that is mechanically coupled to motor 510. Friction welding apparatus 800 also includes an actuator 512 that is removably coupled to an inert gas tank 514. The motor drive shaft 508 is mechanically coupled to a WPA 516, and the WPA is operably coupled to a work piece 518. When the inert gas from the inert gas tank 514 is released into the actuator 512, the inert gas flows through the actuator 512 and down into the enclosure, thus enveloping. The worksite in a non-combustible inert gas thus preventing combustion in the vicinity of the tank.

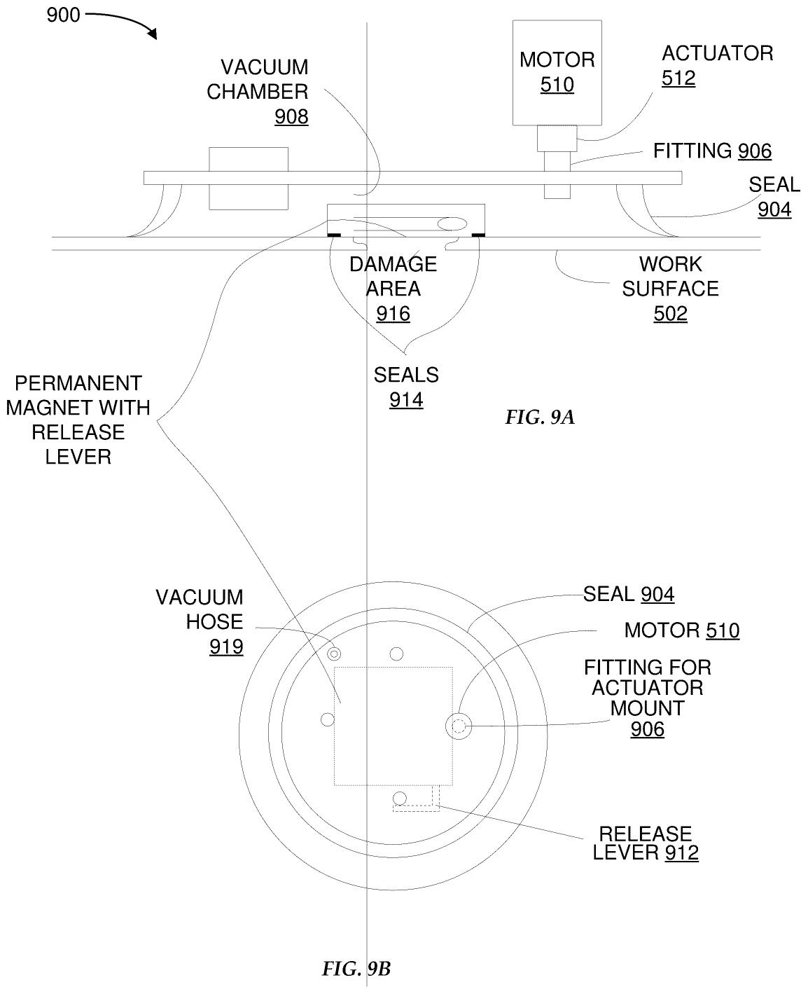

FIG. 9A is a side-view of a block diagram of a friction welding apparatus 900 that uses a vacuum chamber formed from a flexible seal, a housing and a magnetic apparatus. The vacuum prevents combustion of combustible materials. The friction welding apparatus 900 is positioned over a work surface 502 such as deck 102 in FIG. 1. The friction welding apparatus 900 includes a housing 902 that is secured to the work surface 502 through a flexible seal 904. A fitting 906 provides a substantially air tight seal between the housing 902 and actuator 512. The housing 902 and the fitting 906 provide a substantially air tight seal with the work surface 502. The friction welding apparatus 900 also includes motor 510. The housing 902, the fitting 906 and the work surface 502 form a vacuum chamber 908 which prevents combustion in the vicinity of the tank. The friction welding apparatus 900 also includes a permanent magnet 910 the permanent magnet 910 including a release lever 912. The permanent magnet 910 is placed over seals 914 that encompass the perimeter of the damaged area 916.

FIG. 9B is a top-view of a block diagram of a friction welding apparatus 900 that uses a vacuum formed from a flexible seal, a housing and a magnetic apparatus. The housing 902 of the friction welding apparatus 900 includes a hole 917 and a fitting 918 through the housing 902 through which a vacuum hose 919 attaches.

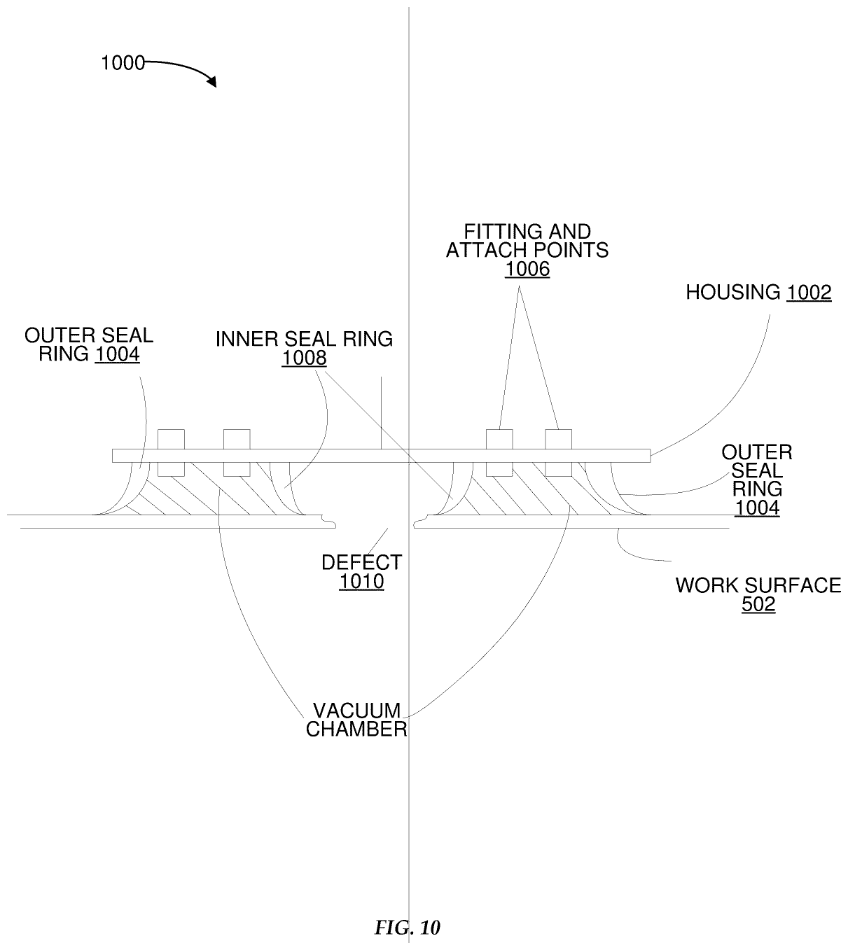

FIG. 10 is a side-view of a block diagram of a friction welding apparatus 1000 that uses a vacuum chamber formed from a flexible outer seal, a housing and a flexible inner seal. The vacuum prevents combustion of combustible materials. The friction welding apparatus 1000 is positioned over a work surface 502 such as deck 102 in FIG. 1. The friction welding apparatus 1000 includes a housing 1002 that is secured to the work surface 502 through a flexible outer seal 1004. Fittings 1006 provide a substantially air tight seal between the housing 1002 and actuator. The friction welding apparatus 1000 also includes flexible inner seals 1008 that encompass the problem or defect area 1010 in the work surface. The housing 1002, seals 1004 and 1008 and the fittings 1006 provide a substantially air tight seal around the work surface 502. The housing 1002, the fittings 1006 and 1008 and the work surface 502 create a vacuum chamber 1008 which prevents combustion in the vicinity of the tank.

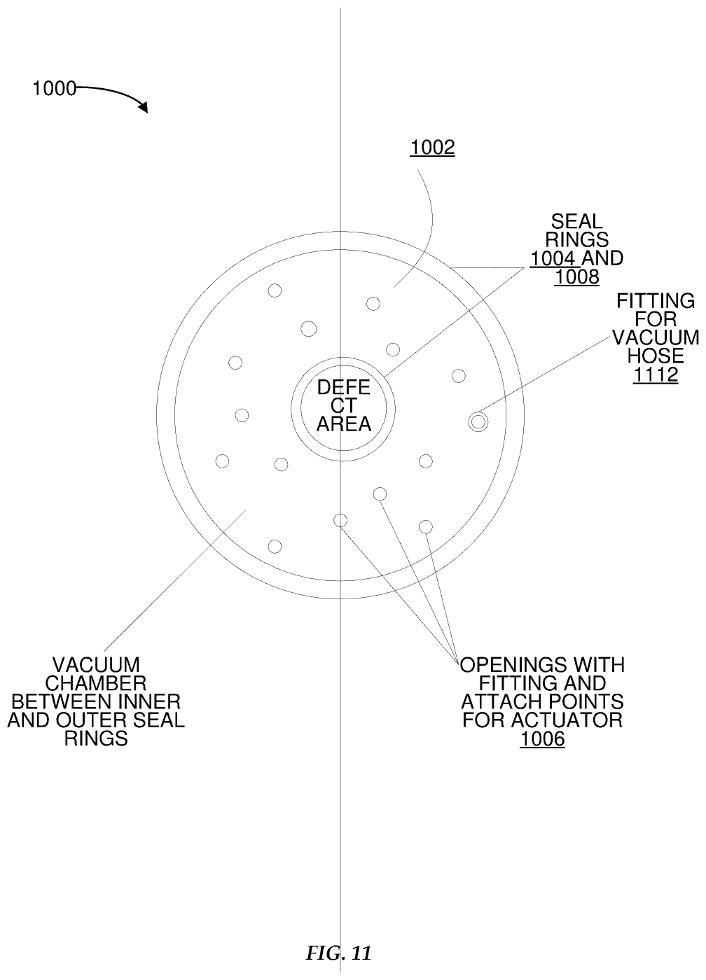

FIG. 11 is a top view of a block diagram of a friction welding apparatus 1000 that uses a vacuum formed from flexible seals and a housing. The housing 1002 of the friction welding apparatus 1000 includes a hole 1112 through the housing through which a vacuum hose attaches.

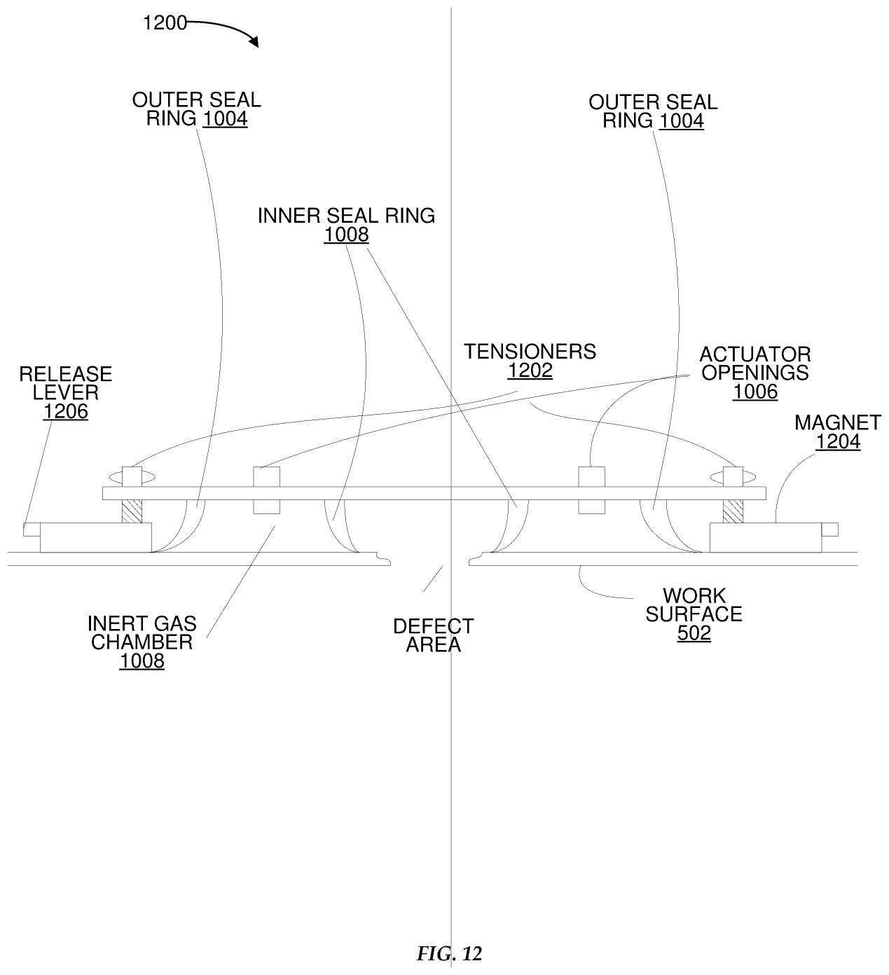

FIG. 12 is a side-view of a block diagram of a friction welding apparatus 1200 that uses an inert gas chamber formed from a flexible outer seal, a housing and a flexible inner seal. The vacuum prevents combustion of combustible materials. The friction welding apparatus 1200 is positioned over a work surface 502 such as deck 102 in FIG. 1. The friction welding apparatus 1200 includes a housing 1002 that is secured to the work surface 502 through a flexible outer seal 1004. Fitting and attach points 1006 provide a substantially air tight seal between the housing 1002 and actuator. The friction welding apparatus 1200 also includes flexible inner seal ring 1008 that encompass the problem or defect area 1010 in the work surface. The housing 1002, outer seal ring 1004 the fitting and attach points 1006 and the inner seal ring 1008 and the fittings 1006 provide a substantially air tight seal around the work surface 502. The substantially air tight seal is not completely airtight but in fact provides de-minimus passage of gas out of the enclosure formed by the housing 1002, the outer seal ring 1004, the fitting, the attach points 1006, the inner seal ring 1008 and the work surface 502. The housing 1002, the outer seal ring 1004, the fitting and attach points 1006, the inner seal ring 1008 and the work surface 502 create a vacuum 1008 which prevents combustion in the vicinity of the tank. Friction welding apparatus 1200 also includes tensioners 1202 that pass through the housing 1002 and are mechanically and rotatably attached to magnets 1204 that are magnetically attached to the work surface 502. The magnets 1204 include a release lever 1206 that releases the magnet 1204 from the work surface 502.

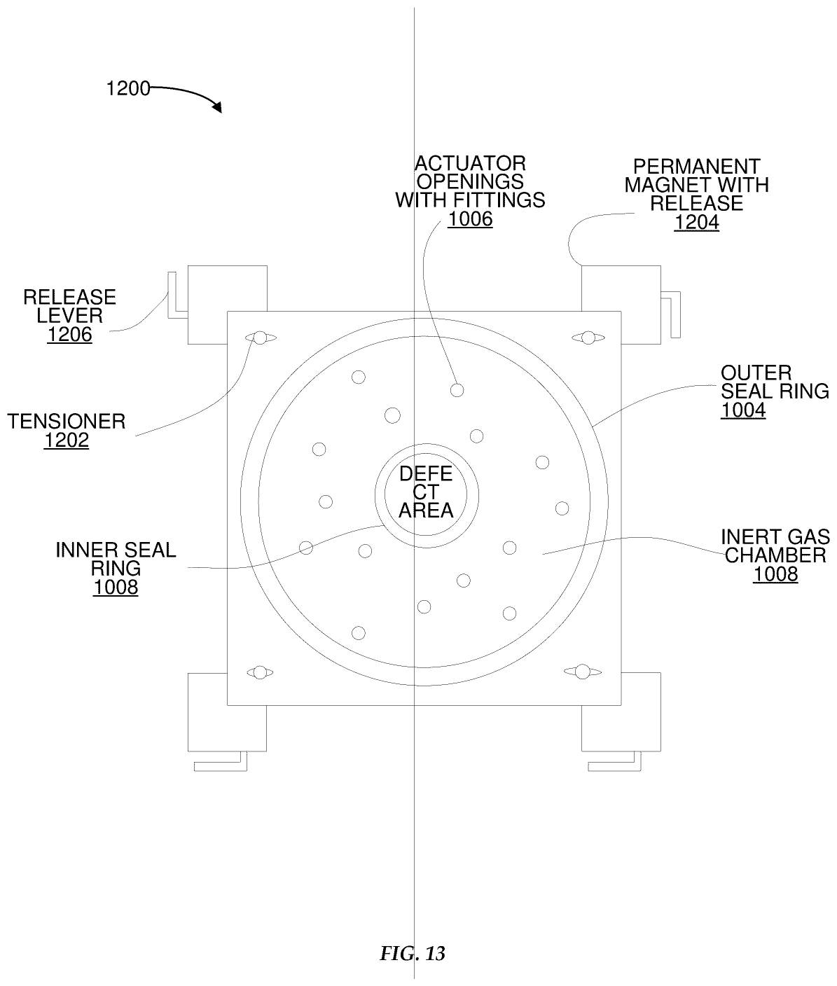

FIG. 13 is a top view of a block diagram of a friction welding apparatus 1200 that uses a vacuum formed from flexible seals and a housing. The housing 1002 of the friction welding apparatus 1200 includes a hole 1112 through the housing through which a vacuum hose attaches.

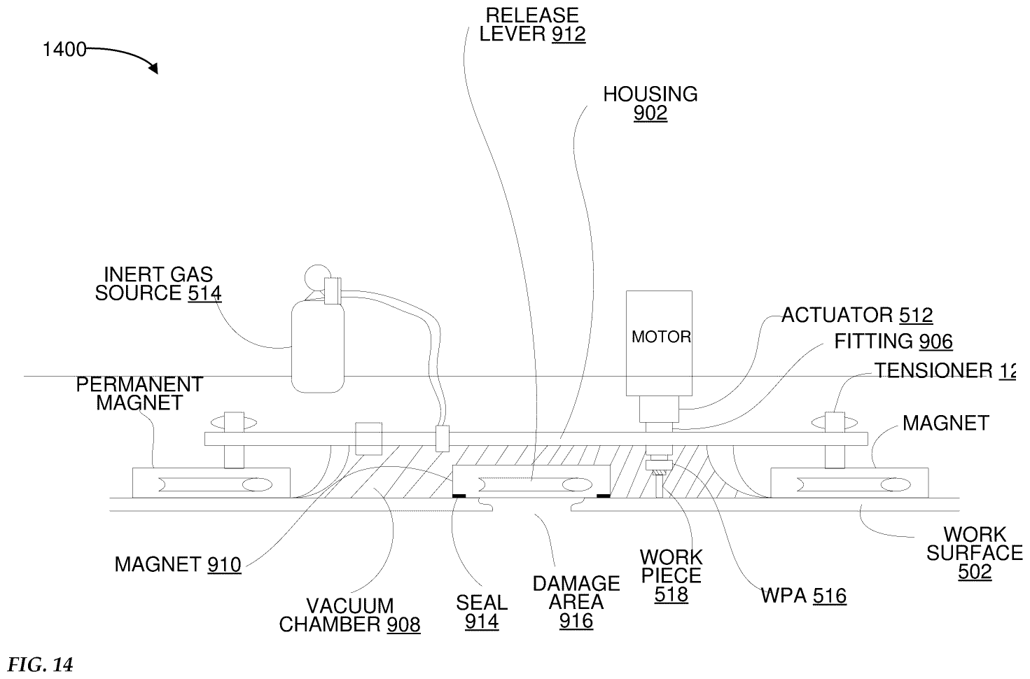

FIG. 14 is a side view of a block diagram of a friction welding apparatus 1400 that uses a chamber of inert gas formed from a flexible seal, a housing and a magnetic apparatus. The chamber of insert gas prevents combustion of combustible materials. The friction welding apparatus 1400 is positioned over a work surface 502 such as deck 102 in FIG. 1. The friction welding apparatus 1400 includes a housing 902 that is secured to the work surface 502 through a flexible seal 904. A fitting 906 provides a substantially air tight seal between the housing 902 and actuator 512. The housing 902 and the fitting 906 provide a substantially air tight seal with the work surface 502. The substantially air tight seal is not completely airtight but in fact provides de minimus passage of gas out of the enclosure formed by the housing 902, the fitting 906 and the work surface 502. The friction welding apparatus 1400 also includes motor 510. Unused fittings in the housing 902 are fitted with caps to prevent pressure equalization in the vacuum chamber 908. The housing 902, the fitting 906 and the work surface 502 form a vacuum chamber 908 that is filled by inert gas from inert gas tank 514 which prevents combustion in the vicinity of the tank. The friction welding apparatus 1400 also includes a permanent magnet 910 the permanent magnet 910 including a release lever 912. The permanent magnet 910 is placed over seals 914 that encompass the problem or the damaged area 916. Friction welding apparatus 1400 also includes tensioners 1202 that pass through the housing 902 and are mechanically and rotatably attached to magnets 1204 that are magnetically attached to the work surface 502. The magnets 1204 include a release lever 1206 that releases the magnet 1204 from the work surface 502.

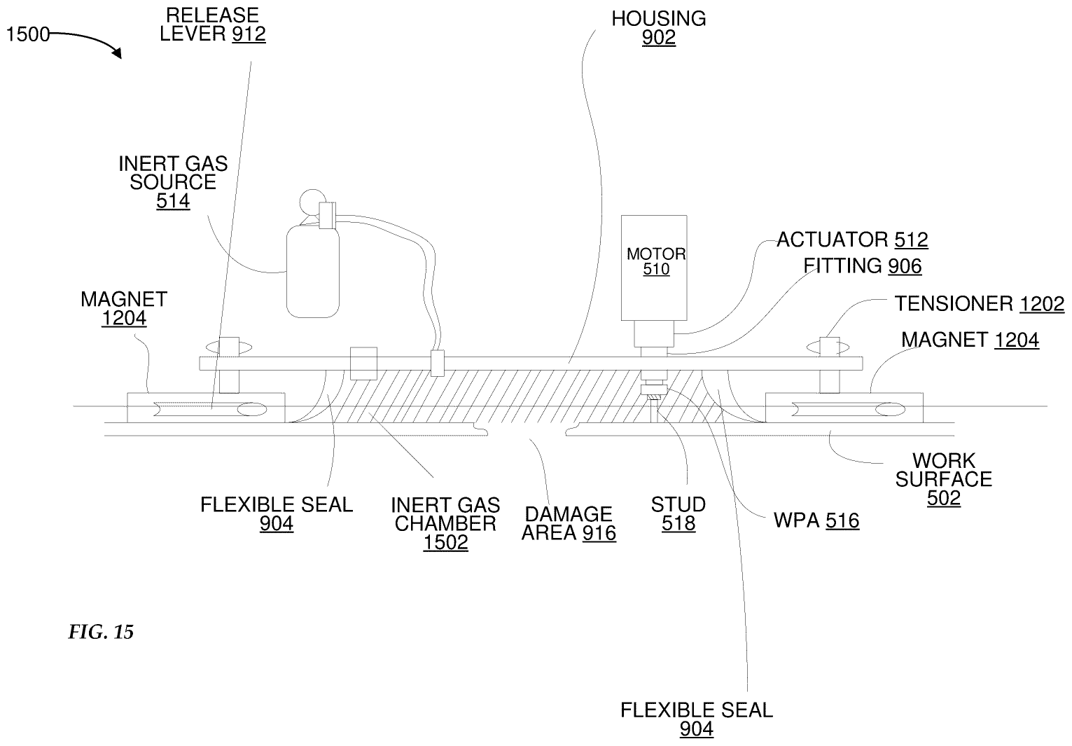

FIG. 15 is a side-view of a block diagram of a friction welding apparatus 1500 that uses a chamber of inert gas formed from a flexible seal, a housing and a magnetic apparatus. The chamber of insert gas prevents combustion of combustible materials. The friction welding apparatus 1500 is positioned over a work surface 502 such as deck 102 in FIG. 1. The friction welding apparatus 1500 includes a housing 902 that is secured to the work surface 502 through a flexible seal 904. A fitting 906 provides a substantially air tight seal between the housing 902 and actuator 512. The housing 902, flexible seal 904 and the fitting 906 provide a substantially air tight seal with the work surface 502. The substantially air tight seal is not completely airtight but in fact provides deminimus passage of gas out of the chamber 1502 formed by the housing 902, the flexible seal 904, the fitting 906 and the work surface 502. The friction welding apparatus 1500 also includes motor 510. The housing 902, the fitting 906 and the work surface 502 form the chamber 1502 that is filled by inert gas from inert gas tank 514 which prevents combustion in the vicinity of the tank. Friction welding apparatus 1500 also include tensioners 1202 that pass through the housing 902 and are mechanically and rotatably attached to magnets 1204 that are magnetically attached to the work surface 502. The magnets 1204 include a release lever 1206 that releases the magnet 1204 from the work surface 502.

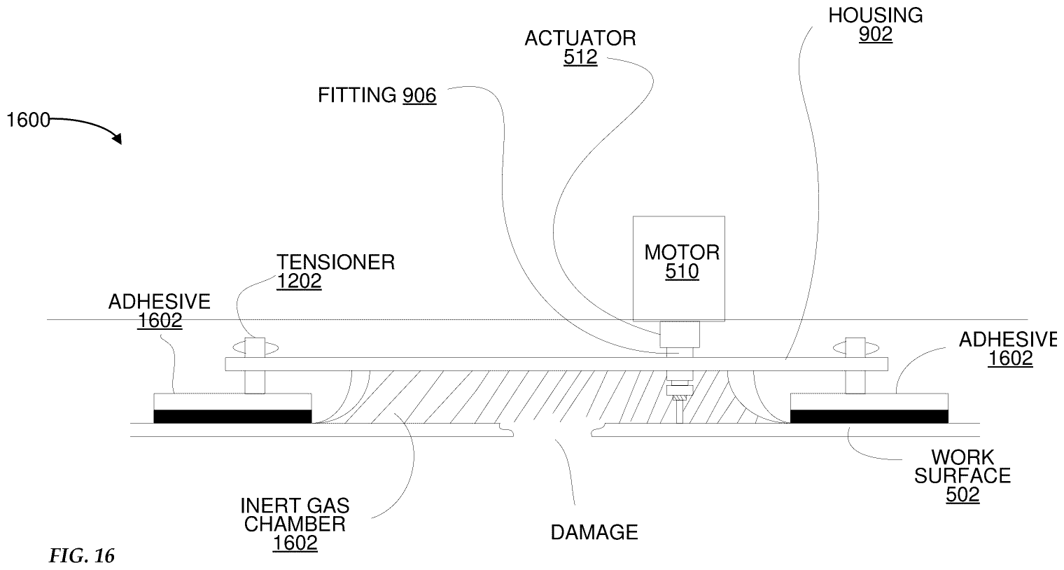

FIG. 16 is a side view of a block diagram of a friction welding apparatus 1600 that uses a chamber of inert gas formed from a flexible seal, a housing and an adhesive apparatus. The chamber of inert gas prevents combustion of combustible materials. The friction welding apparatus 1600 is positioned over a work surface 502 such as deck 102 in FIG. 1. The friction welding apparatus 1600 includes a housing 902 that is secured to the work surface 502 through a flexible seal 904. A fitting 906 provides a substantially air tight seal between the housing 902 and actuator 512. The friction welding apparatus 1600 also includes motor 510. The housing 902, the fitting 906 and the work surface 502 form a chamber 1602 that is filled by inert gas. Friction welding apparatus 1600 also include tensioners 1202 that pass through the housing 902 and are attached to the work surface 502 via adhesive.

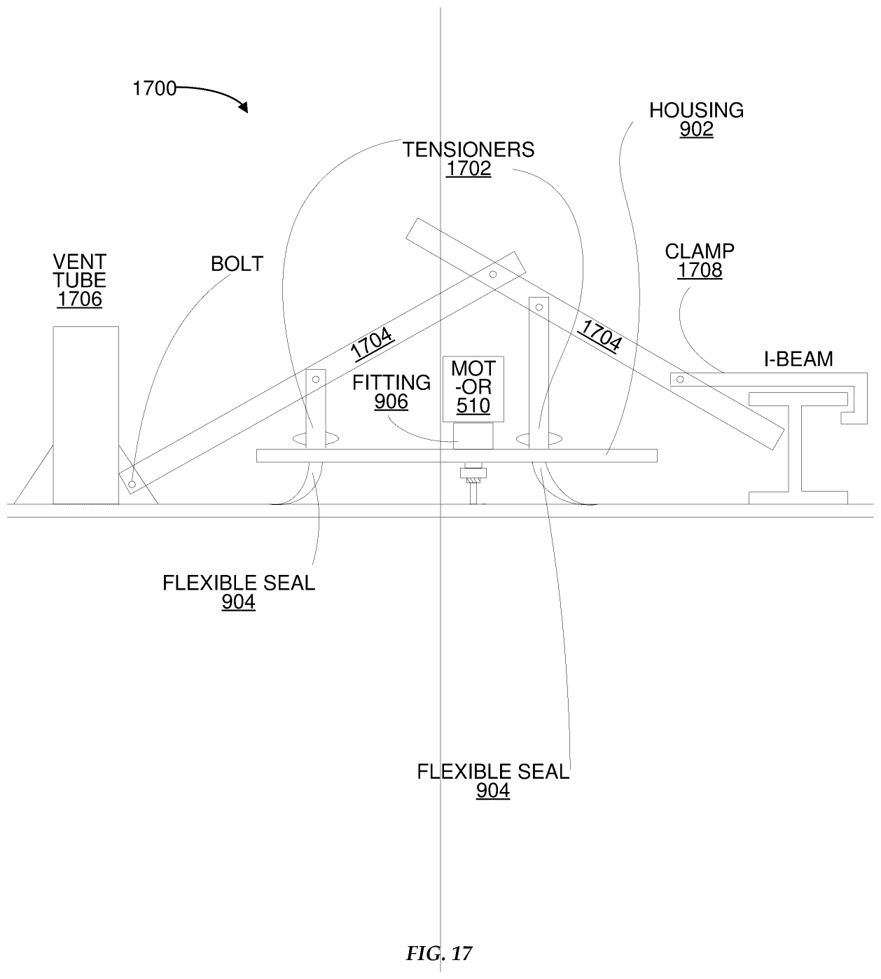

FIG. 17 is a side-view of a block diagram of a friction welding apparatus 1700 that uses wing-nut tensioners and levers. The friction welding apparatus 1700 is positioned over a work surface 502 such as deck 102 in FIG. 1. The friction welding apparatus 1700 includes a housing 902 that is secured to the work surface 502 through a flexible seal 904. A fitting 906 provides a substantially air tight seal between the housing 902 and motor 510. The substantially air tight seal is not completely airtight but in fact provides de minimus passage of gas out of the enclosure formed by the housing 902, the fitting 906 and the work surface 502. The housing 902, the fitting 906 and the work surface 502 form a vacuum chamber 908 which prevents combustion in the vicinity of the tank. The friction welding apparatus 1700 also includes wing-nut tensioners 1702 that are operably coupled to arms 1704. When the wingnut tensioners 1702 are turned, the tensioners 1702 either increase or decrease tension on the housing 902, depending upon which direction the tensioners 1702 are turned. The arms 1704 are rotatably attached to each other and to stationary items, such as vent tube 1706 and clamp 1708.

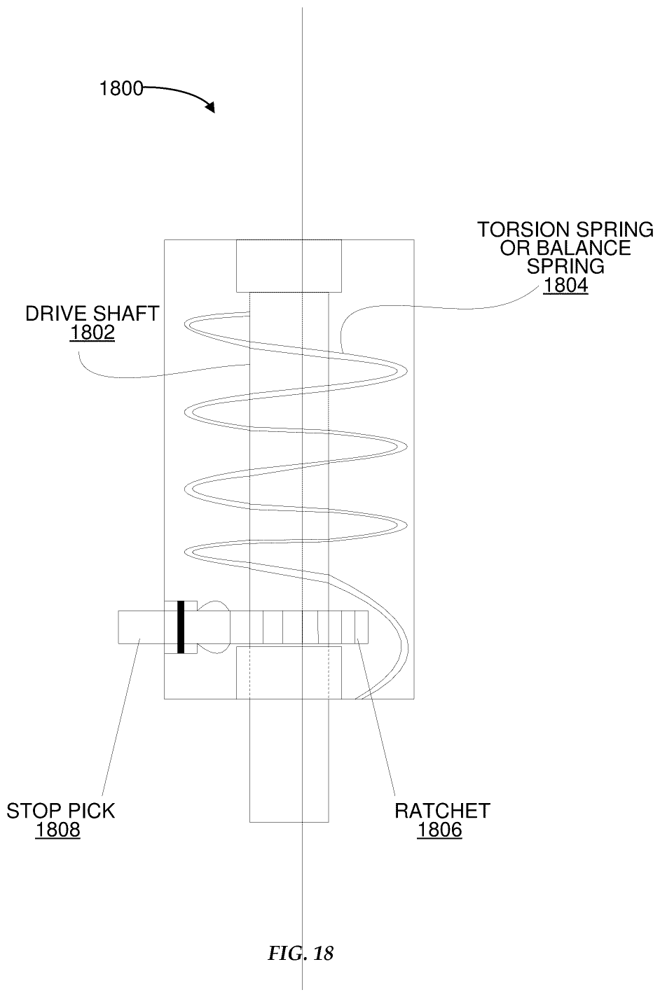

FIG. 18 is a side-view of a motor 1800 or other rotational means. Motor 1800 is one example of motor 510 in the above figures. Motor 1800 includes a drive shaft 1802 that extends through the motor 1800. Drive shaft 1802 is one example of motor drive shaft 508. Motor 1800 also includes a torsion spring or balanced spring 1804. The spring 1804 in some implementations is pre-compressed while on-site on a tank roof top just prior to use. The spring 1804 in some implementations is pre-compressed using a hand crank, a pneumatic crank or any other crank that would not create a spark or other ignition source. In other implementations the spring 1804 is pre-compressed off-site and away from the tank top or even the refinery in general, using any type of motorized crank such as an electric crank or a gas powered crank etc. The spring 1804 is operably coupled to a ratchet 1806 that rotates around the drive shaft 1802 and that includes a stop-pick 1808. When the stop-pick 1808 is disengaged from the ratchet 1806 by rotating the stop-pick 1808 outside the teeth of the ratchet 1806, the ratchet 1806 rotates freely, which allows the drive shaft 1802 to rotate freely under kinetic energy from the spring 1804.

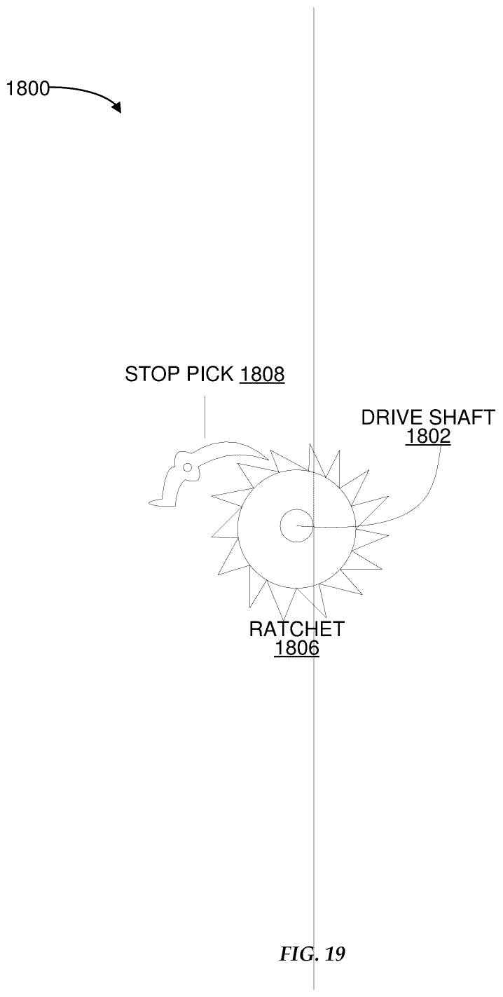

FIG. 19 is a top-view of a motor 1800 or other rotational means. Motor 1800 includes a drive shaft 1802 that extends through the motor 1800. Motor 1800 also includes a torsion spring or balanced spring 1804. The spring 1804 is operably coupled to a ratchet 1806 that rotates around the drive shaft 1802 and that includes a stop-pick 1808. When the stop-pick 1808 is disengaged from the ratchet 1806 by rotating the stop-pick 1808 outside the teeth of the ratchet 1806, the ratchet 1806 rotates freely, which allows the drive shaft 1802 to rotate freely under kinetic energy from the spring 1804.

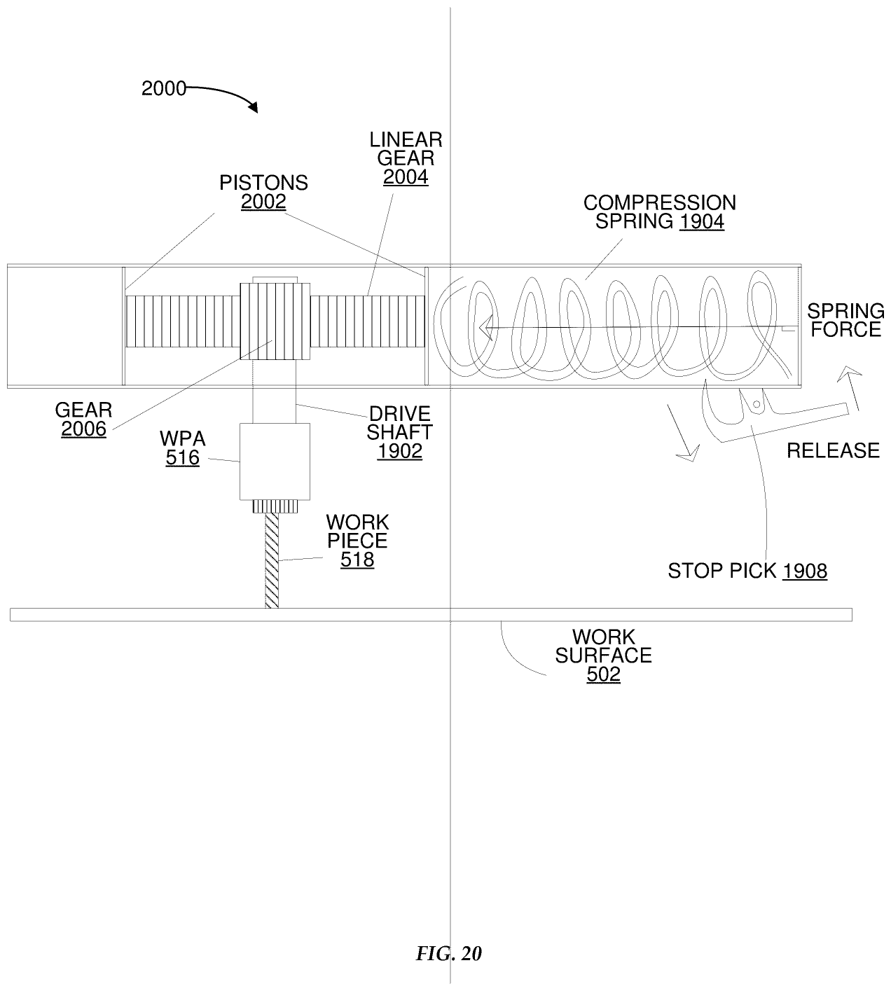

FIG. 20 is a motor 2000 or other rotational means. Motor 2000 is one example of motor 510 in the above figures. Motor 2000 includes a drive shaft 1902 that extends through the motor 2000. Drive shaft 1902 is one example of motor drive shaft 508. Motor 2000 also includes a torsion spring or balanced spring 1904. The spring 1904 in some implementations is pre-compressed while on-site on a tank rooftop just prior to use. The spring 1904 in some implementations is pre-compressed using a hand press, a pneumatic press or any other press that would not create a spark or other ignition source. In other implementations the spring 1904 is pre-compressed off-site and away from the tank top or even away from the refinery in general, using any type of motorized press such as an electric press, a gas powered press etc. The spring 1904 is operably coupled to a stop-pick 1908. When the stop-pick 1908 is rotated outside the diameter of the spring 1904, the spring 1904 moves freely and releases tension on a piston 2002 and moves the piston 2002 that releases force on a linear gear 2004, that causes rotation of a gear 2006 that rotates the drive shaft 1902, which rotates a WPA 516, which rotates a work piece 518.

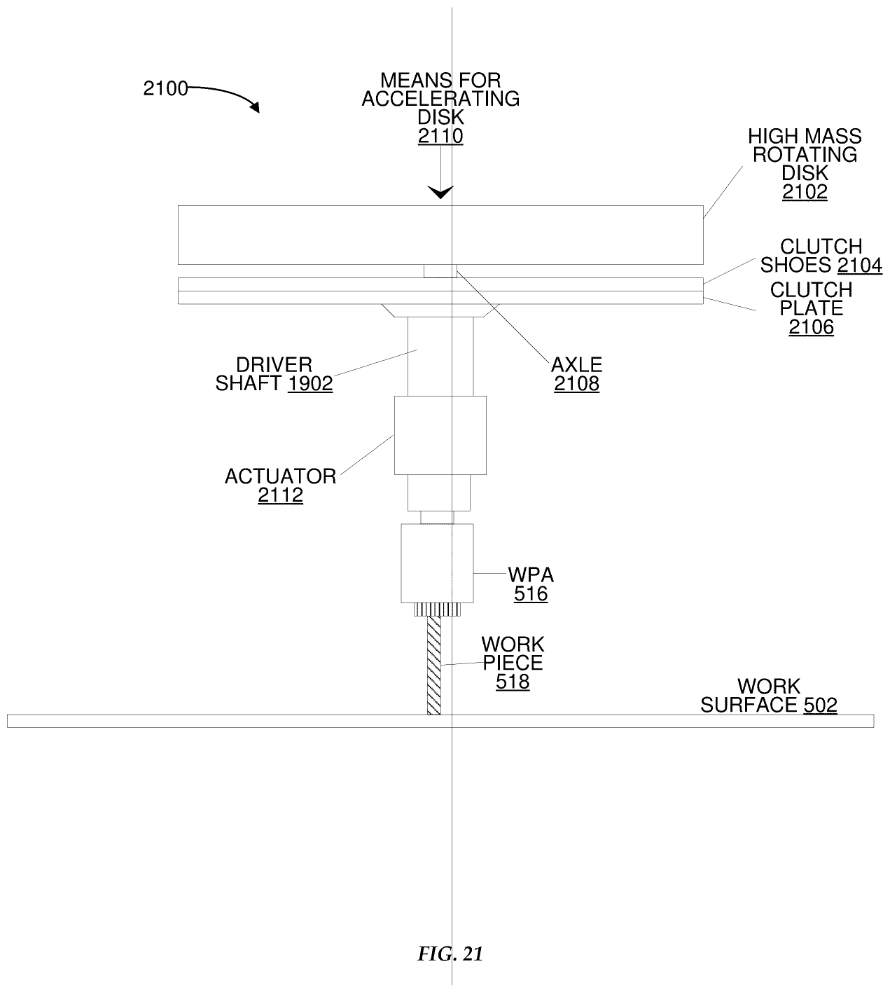

FIG. 21 is a motor 2100 or other rotational means. Motor 2100 is one example of motor 510 in the above figures. Motor 2100 includes a drive shaft 1902. Drive shaft 1902 is one example of motor drive shaft 508. Motor 2100 also includes a high mass rotating disk 2102, clutch shoes 2104, and a clutch plate 2106 that are mounted on an axle 2108, the axle 2108 being fixedly attached to the drive shaft 1902. The axle 2108 allows the high mass rotating disk 2102 to spin when not in contact with the clutch shoes 2104. Rotation of the high mass rotating disk 2102 by a means for accelerating 2110 rotates the drive shaft 1902, which rotates an actuator 2112, which rotates a WPA 516 which rotates a work piece 518. The means for accelerating 2110 can be manual, a pneumatic motor or air pressure. When the high rotating disk 2102 is accelerated to a predetermined speed (such as 1000 rpm), the high mass rotating disk 2102 is positioned in contact with the clutch shoes 2104 and the energy from the high mass rotating disk 2102 is passed through the clutch plate 2106, the actuator 2112, the WPA 516, and to the work piece 518.

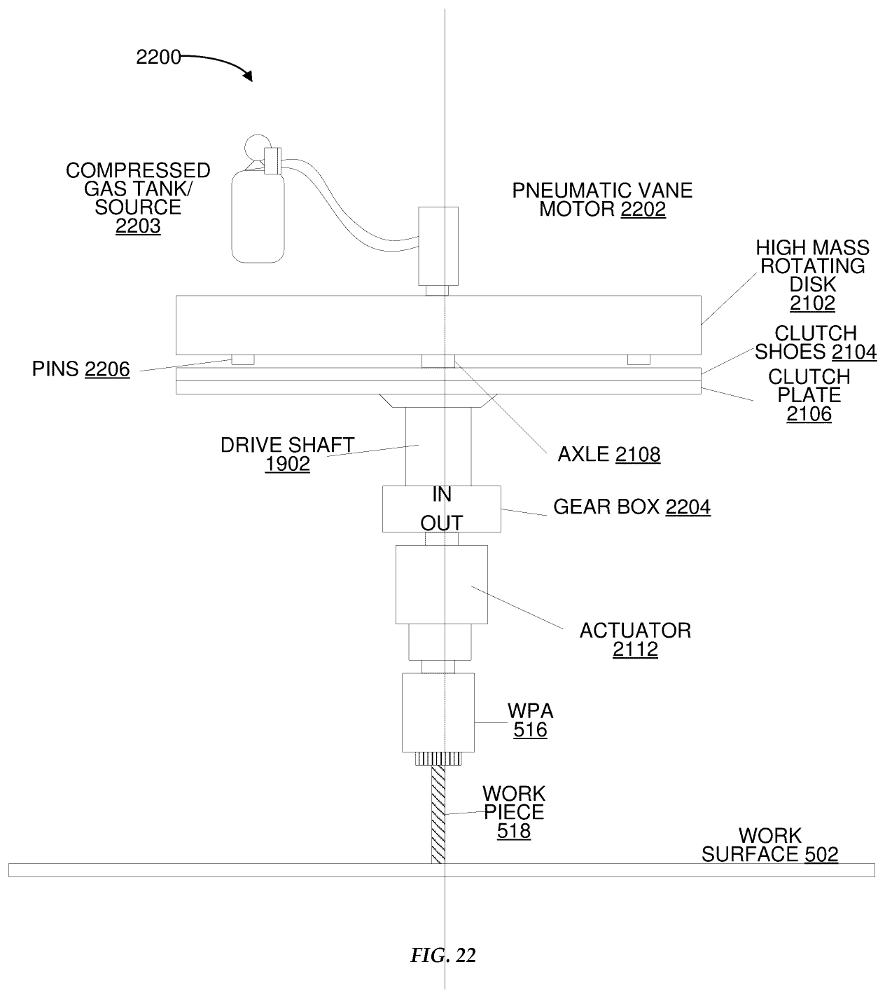

FIG. 22 is a motor 2200 or other rotational means. Motor 2200 is one example of motor 510 in the above figures. Motor 2200 includes a drive shaft 1902. Drive shaft 1902 is one example of motor drive shaft 508. Motor 2200 also includes a high mass rotating disk 2102, clutch shoes 2104, and a clutch plate 2106 that are mounted on an axle 2108, the axle 2108 being fixedly attached to the drive shaft 1902. The axle 2108 allows the high mass rotating disk 2102 to spin when not in contact with the clutch shoes 2104. Rotation of the high mass rotating disk 2102 by powering a pneumatic vane motor 2202 rotates the drive shaft 1902, which rotates a gear box 2204, which rotates an actuator 2112, which rotates a WPA 516 which rotates a work piece 518. The gear box 2204 allows more kinetic energy to be stored in the motor 2200, because rotational kinetic energy is proportional to the square of the rotational speed. For example spinning the high mass rotating disk 2102 at 10,000 RPM and using a 10:1 gear box reduction allows 100 times the energy to be stored in the motor 2200 compared to spinning the high mass rotating disk 2102 at 1000 RPM without using a gear box, such as in motor 2100 in FIG. 21. The pneumatic vane motor 2202 is powered by gas from a compressed gas tank 2203. When the high rotating disk 2102 is accelerated to a predetermined speed (such as 1000 rpm), the high mass rotating disk 2102 is positioned in contact with the clutch shoes 2104 and the energy from the high mass rotating disk 2102 is passed through the clutch plate 2106, the drive shaft 1902, the gear box 2204, the actuator 2112, the WPA 516, and to the work piece 518. As an alternative, pins 2206 can be implemented instead of clutch plate 2106 to couple or lock plates together. A common requirement is approximately 20,000 joules of energy to weld a work piece 518.

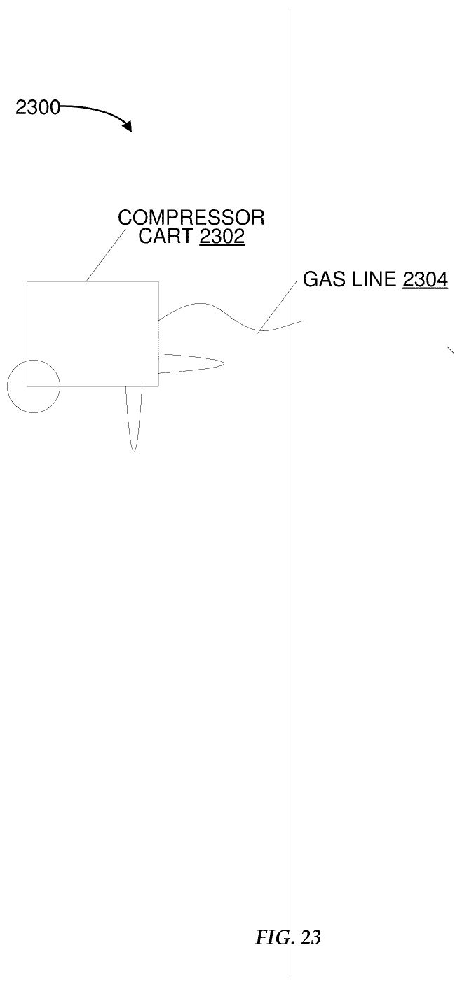

FIG. 23 is a pneumatic motor propulsion source 2300. The pneumatic motor propulsion source 2300 is one example of a compressed gas tank 2203 in FIG. 22. The pneumatic motor propulsion source 2300 includes a wheeled cart 2302 that has an air compressor (not shown). A gas line 2304 couples the air compressor to a pneumatic vane motor, such as pneumatic vane motor 2202 in FIG. 22. As an alternative, a tank of compressed gas can be implemented instead of, or in addition to, the air compressor.

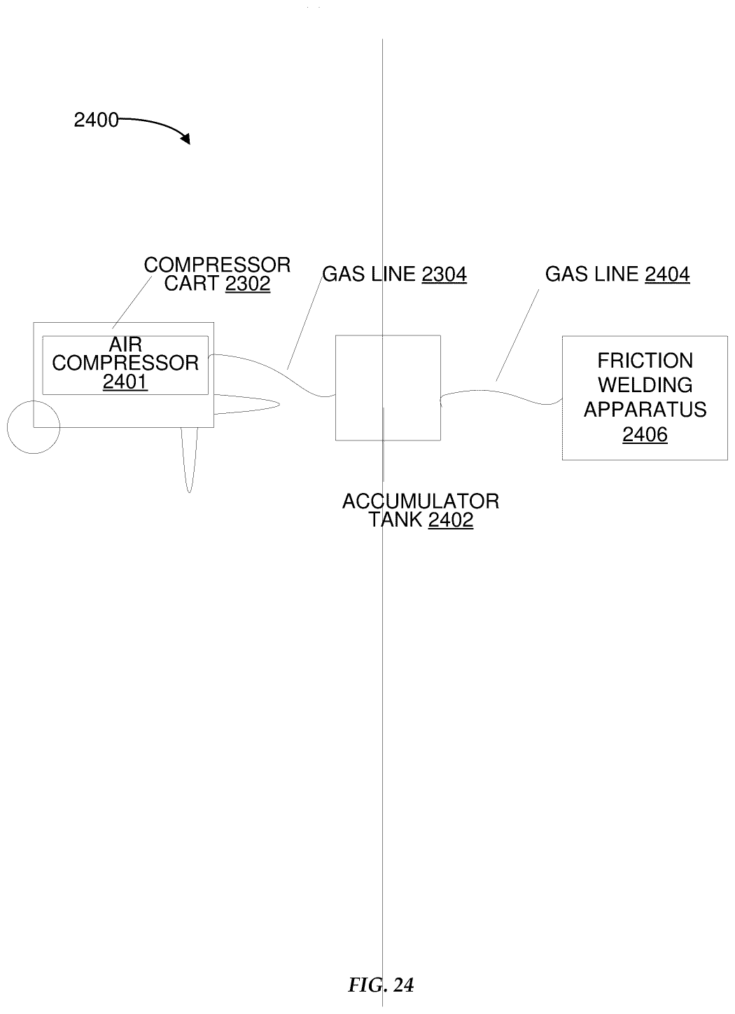

FIG. 24 is a pneumatic motor propulsion source 2400. The pneumatic motor propulsion source 2300 is one example of a compressed gas tank 2203 in FIG. 22. The pneumatic motor propulsion source 2300 includes a wheeled cart 2302 that has an air compressor 2401. A gas line 2304 couples the air compressor 2401 to a gas accumulator tank 2402 that is operably coupled to a second gas line 2404 that can be operably coupled to a pneumatic vane motor, such as pneumatic vane motor 2202 in FIG. 22 or a friction welding apparatus 2406. Examples of the friction welding apparatus 2406 include the friction welding apparatus in FIG. 5-17.

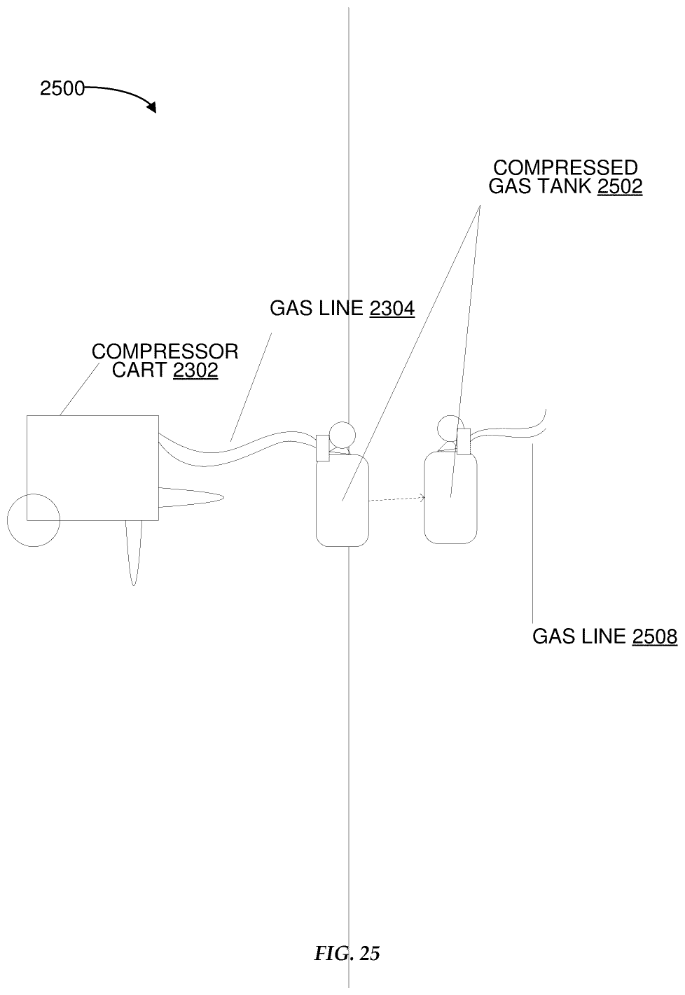

FIG. 25 is a pneumatic motor propulsion source 2500. The pneumatic motor propulsion source 2500 is one example of a compressed gas tank 2203 in FIG. 22. The pneumatic motor propulsion source 2500 includes a wheeled cart 2302 that has an air compressor (not shown). A gas line 2304 couples the air compressor to a compressed gas tank 2502. The compressed gas tank 2502 can be decoupled from the gas line 2304, in which case the compressed gas tank 2502 can be coupled through gas line 2508 to a pneumatic vane motor, such as pneumatic vane motor 2202 in FIG. 22, friction welding apparatus 1500.

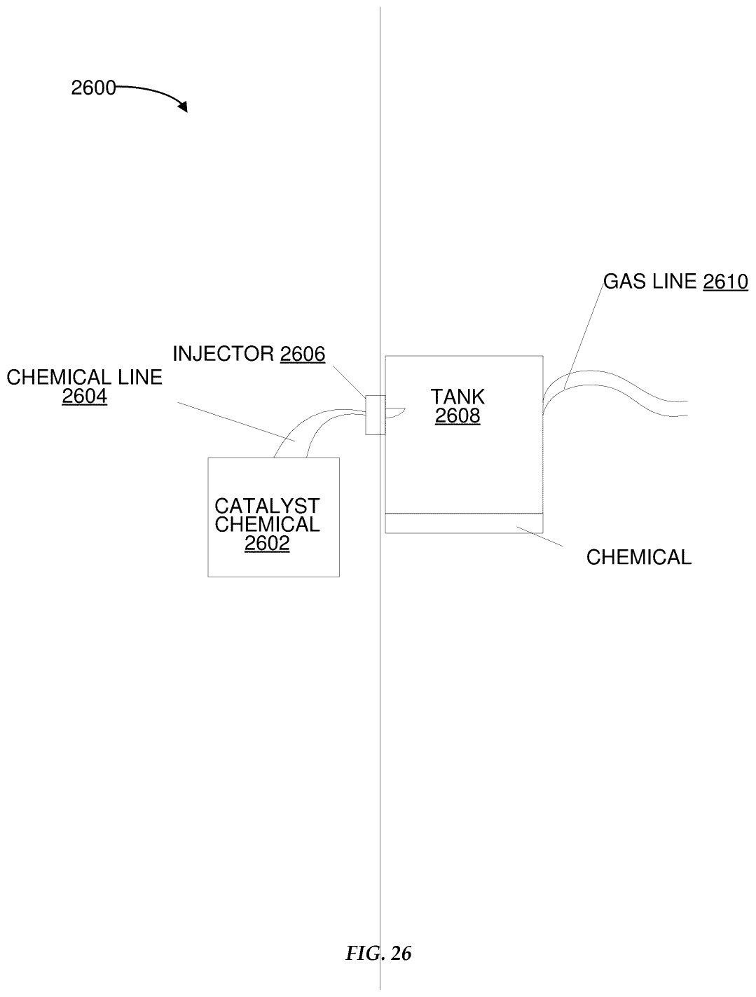

FIG. 26 is a pneumatic motor propulsion source 2600. The pneumatic motor propulsion source 2600 is one example of a compressed gas tank 2203 in FIG. 22. The pneumatic motor propulsion source 2300 includes chemical catalyst tank 2602 in which a chemical reaction creates compressed gas which travels through a chemical line 2604 to an injector 2606 of a gas storage tank 2608. The gas storage tank 2608 is operably coupled to gas line 2610 that is operable to couple to a pneumatic vane motor, such as pneumatic vane motor 2202 in FIG. 22.

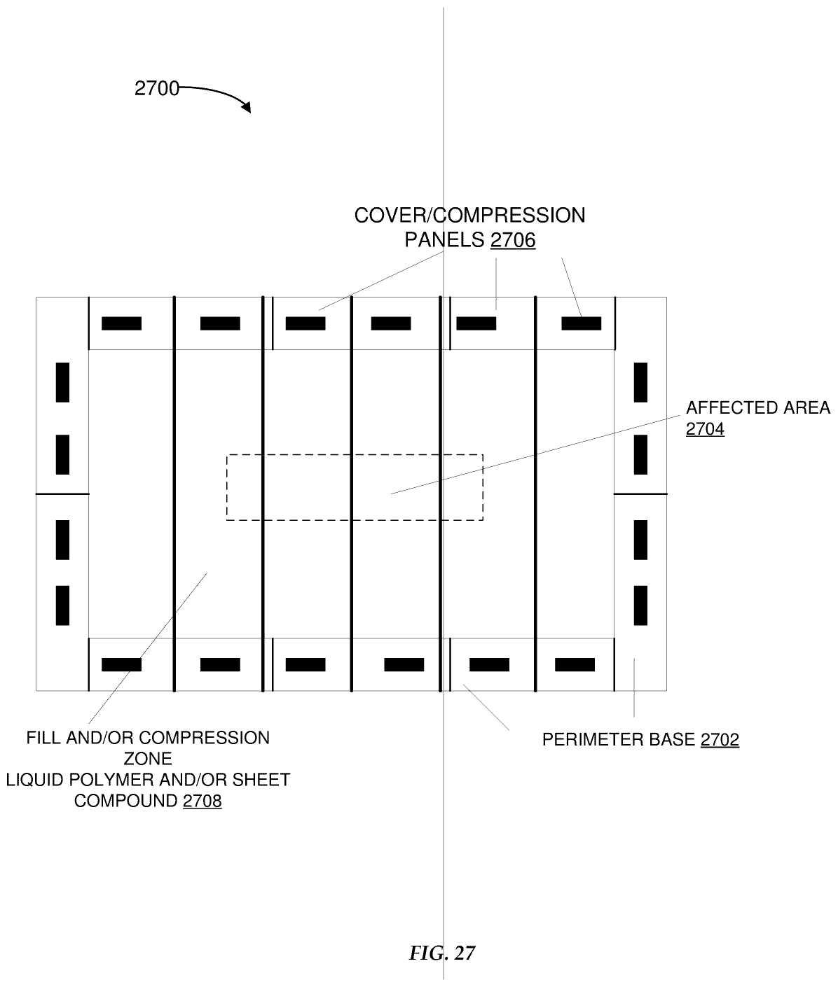

FIG. 27 is a top view of a block diagram of a defect perimeter sealing system 2700. The defect perimeter sealing system 2700 has two particular capabilities. One capability is to provide fill around a defect and another capability is to provide live load compression. The defect perimeter sealing system 2700 includes a number of perimeter base components 2702 that are arranged around a defect 2704 of a tank. The entire top of the perimeter base components 2702 are encompassed or spanned by compression panels 2706. The area between the perimeter base components 2702, the surface of the defect 2704 and the compression panels 2706 is a field or compression zone 2708. A material is injected in the fill or compression zone 2708. One example of the injected material is a liquid polymer. Another example of the injected material is a sheet compound.

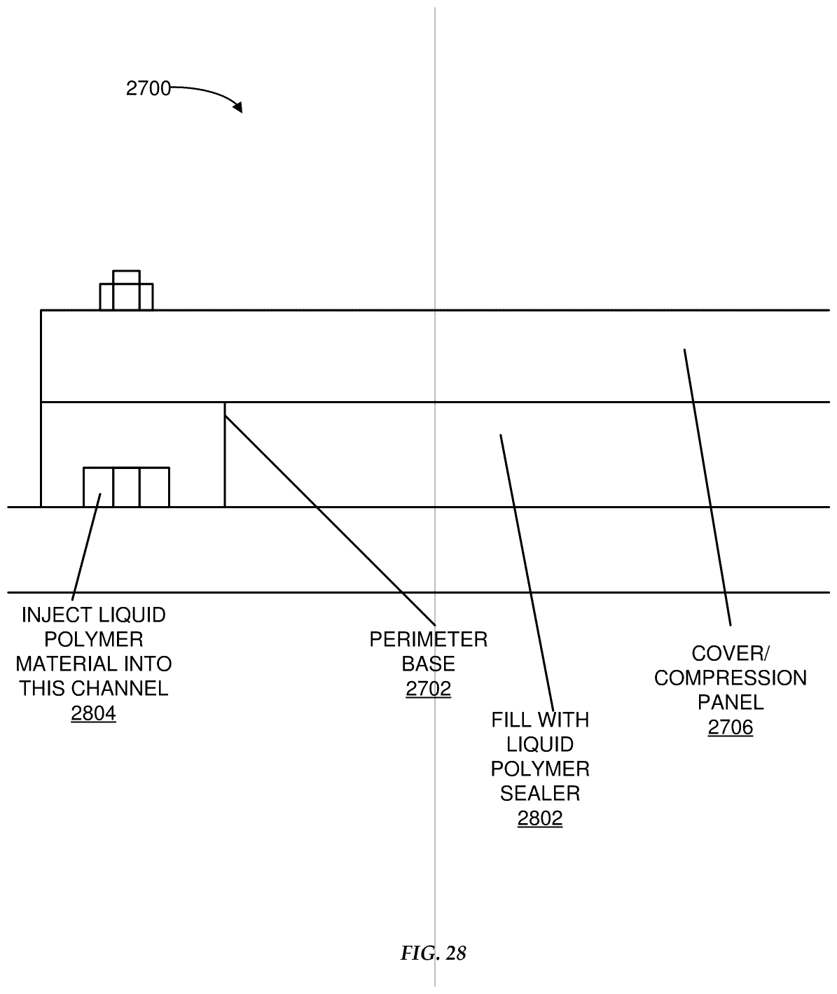

FIG. 28 is a cross-section side-view of a block diagram of a defect perimeter sealing system 2700. The defect perimeter sealing system 2700 has two particular capabilities. One capability is to provide fill around a defect in another capability is to provide live load compression. The defect perimeter sealing system 2700 includes a number of perimeter base components 2702 that are arranged around a defect (not shown in FIG. 28) of a tank. The entire top of the perimeter base components 2702 are encompassed or spanned by compression panels 2706. The area between the perimeter base components 2702, the surface of the defect and the compression panels 2706 is a field or compression zone 2802. A material is injected in the fill or compression zone 2802. One example of the injected material is a liquid polymer. Another example of the injected material is a sheet compound. In addition the perimeter base components 2702 also include a channel 2804 into which the material that is injected into the zone 2802 is also injected, or into which another material is injected.

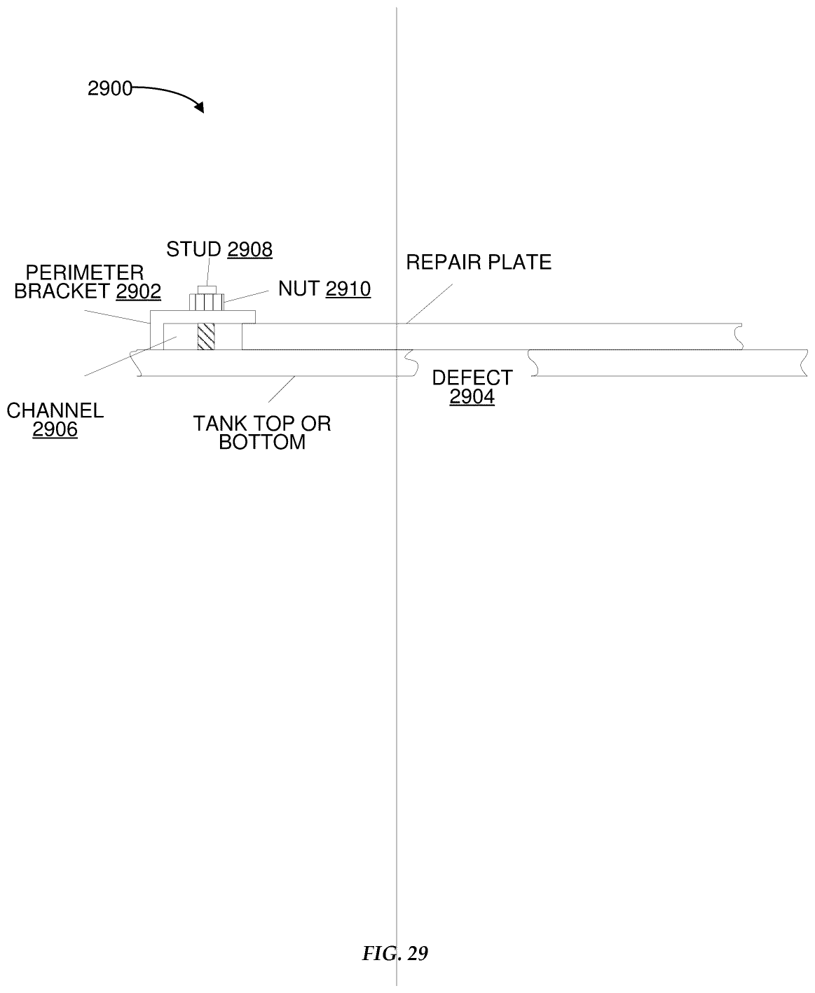

FIG. 29 is a cross-section side-view of a block diagram of a defect perimeter sealing system 2900. The defect perimeter sealing system 2900 provides live load compression. The defect perimeter sealing system 2900 includes a number of perimeter brackets 2902 that are arranged around a defect 2904 of a tank 2905. The entire top of the perimeter brackets 2902 are encompassed or spanned by repair plate. The repair plate is held in place by perimeter brackets 2902. In addition the perimeter brackets 2902 also include a channel 2906 into which a material such as a sealant is injected. Studs 2908 having nuts 2910 pass through the perimeter brackets 2902 and into the surface of the tank top or bottom, but not all the way through the tank top or bottom, to hold the perimeter brackets 2902 in place.

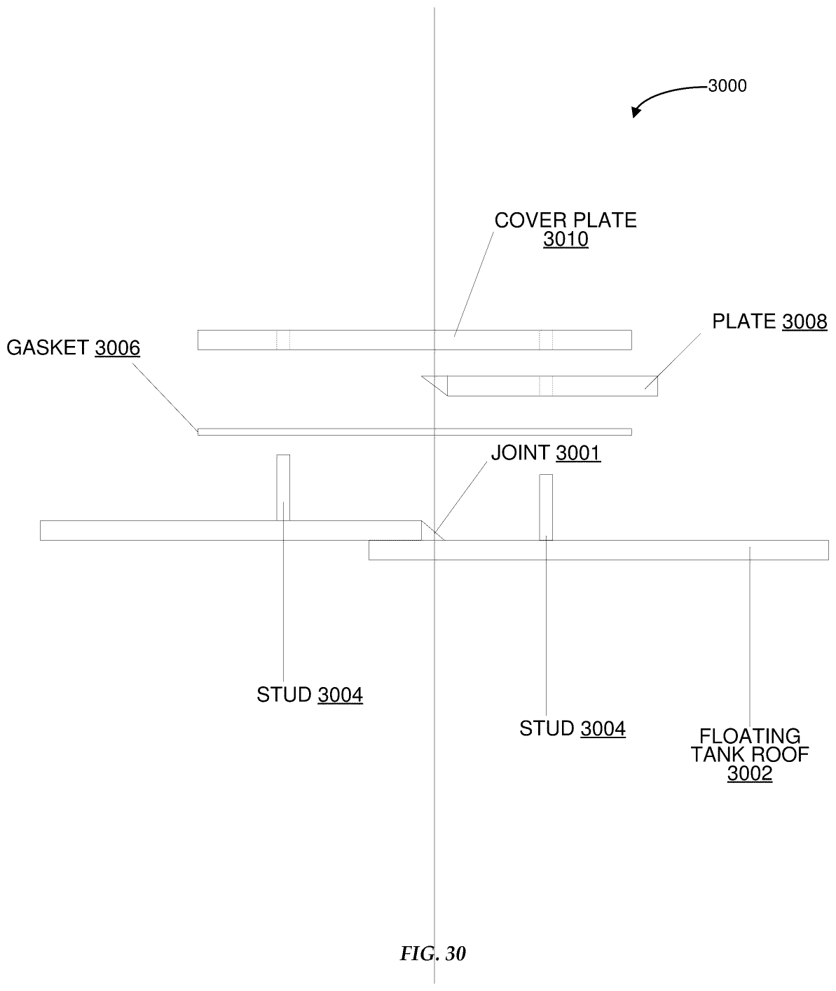

FIG. 30 is a side view of a block diagram of a defect perimeter sealing system 3000. The defect perimeter sealing system 3000 provides live load compression. The defect perimeter sealing system 3000 is placed over a floating tank roof 3002 having a lap joint 3001. The lap joint 3001 is typically created during the original manufacture of the tank. The defect perimeter sealing system 3000 includes friction forged threaded studs 3004, at the least one of which is placed on the floating tank roof 3002. The defect perimeter sealing system 3000 also includes a flexible compression gasket 3006 that is placed over the top of the studs 3004. In some implementations the studs 3004 have unequal lengths to the extent that tops of the studs are parallel with the plane of either portions of the floating tank roof 3002, so that when the flexible compression gasket 3006 is placed on top of the studs 3004 the flexible compression gasket 3006 is also parallel with the plane of either portions of the floating tank roof 3002. The perimeter sealing system 3000 also includes an offset compression plate 3008 that is placed on top of the flexible compression gasket 3006. The perimeter sealing system 3000 also includes a cover plate 3010 that is placed on top of the offset compression plate 3010. The perimeter sealing system 3000 is adapted to lap joints on tank roof tops.

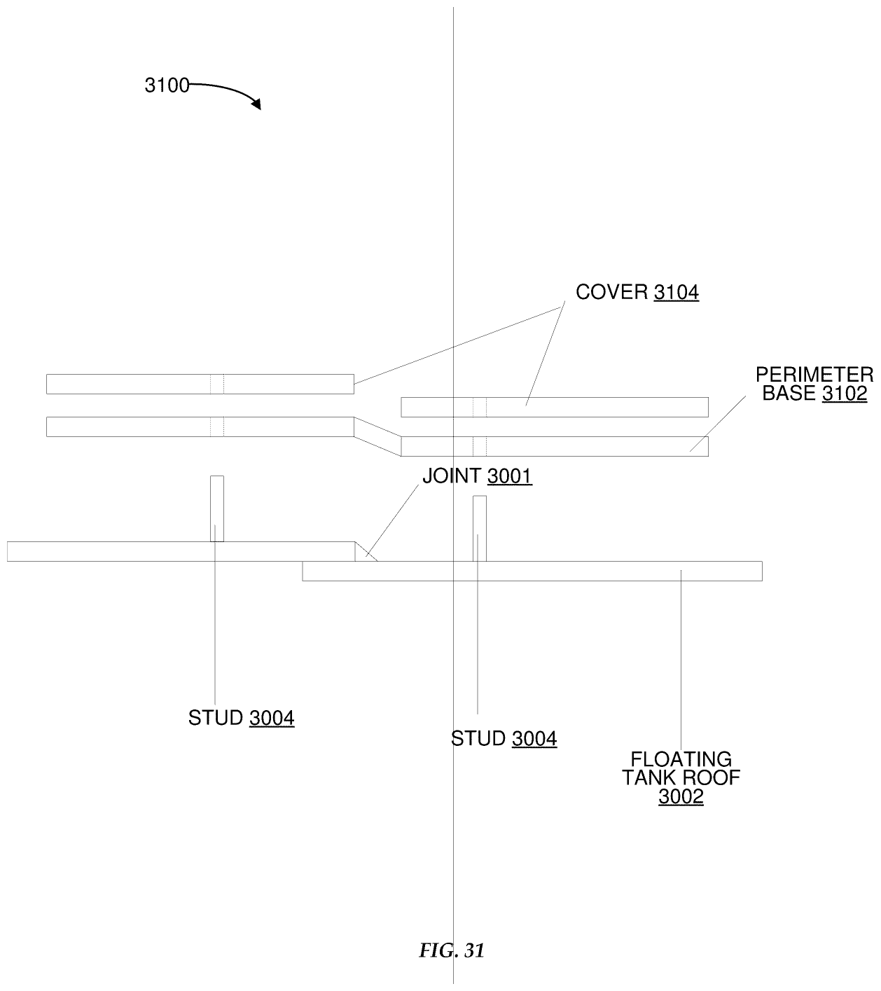

FIG. 31 is a side-view of a block diagram of a defect perimeter sealing system 3100. The defect perimeter sealing system 3100 provides live load compression. The defect perimeter sealing system 3100 is placed over a floating tank roof 3002 having a repair lap joint 3001. The defect perimeter sealing system 3100 includes friction forged threaded studs 3004, at the least one of which is placed on the floating tank roof 3002. The defect perimeter sealing system 3100 also includes a perimeter base 3102 that is placed over the top of the studs 3004. The studs 3004 have equal lengths so that tops of the studs are not parallel with the plane of either portions of the floating tank roof 3002, but the perimeter base 3102 includes an offset portion that is of equal offset to the lap joint 3001 so that when the perimeter base 3102 is placed on top of the studs 3004 the perimeter base 3102 is not parallel with the plane of either portions of the floating tank roof 3002. The perimeter sealing system 3100 also includes a cover 3104 that is placed on top of the perimeter base 3102. The perimeter sealing system 3100 is adapted to lap joints on tank roof tops.

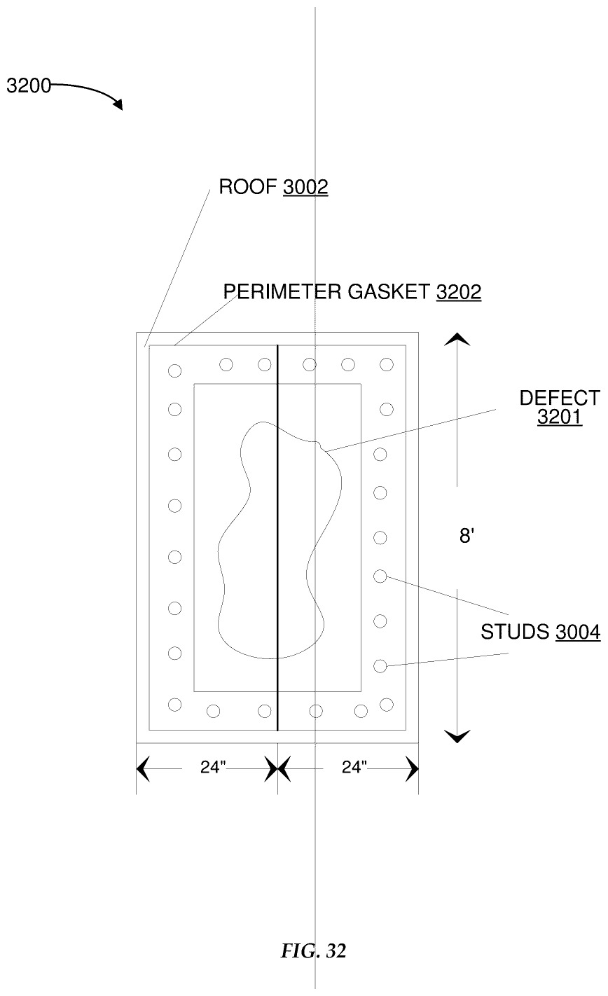

FIG. 32 is a top-view of a block diagram of a defect perimeter sealing system 3200. The defect perimeter sealing system 3200 provides live load compression. The defect perimeter sealing system 3200 is placed over a floating tank roof 3002 having a defect 3201. The defect perimeter sealing system 3200 includes a perimeter gasket 3202. The defect perimeter sealing system 3200 also includes studs 3004. The perimeter sealing system 3200 has the dimensions of 8 feet in length and 48 inches in width however the structure of the defect perimeter sealing system 3200 is not limited by those dimensions. The perimeter sealing system 3200 is adapted to lap joints on tank roof tops. Perimeter sealing system 3200 has long and narrow dimensions to fit through small 24″×36″ manways in the walls of the tank.

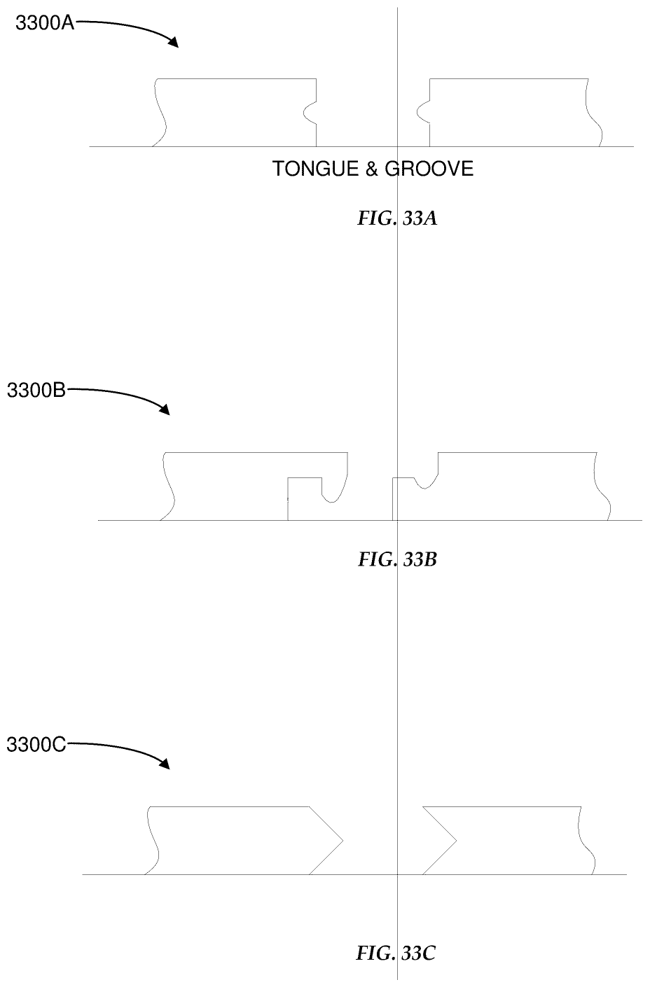

FIG. 33A is a side view of a block diagram of interlocking sections 3300A of the perimeter base component 2702 or the compression panel 2706 of the defect perimeter sealing system 2700. The interlocking sections 3300A have a tongue and groove structure.

FIG. 33B is a side-view of a block diagram of interlocking sections 3300B of the perimeter base component 2702 or compression panel 2706 of the defect perimeter sealing system 2700. The interlocking sections 3300B have a cantilevered tongue and groove structure.

FIG. 33C is a side-view of a block diagram of interlocking sections 3300C of the perimeter base component 2702 or the compression panel 2706 of the defect perimeter sealing system 2700. The interlocking sections 3300C have a diagonal tongue and groove structure.

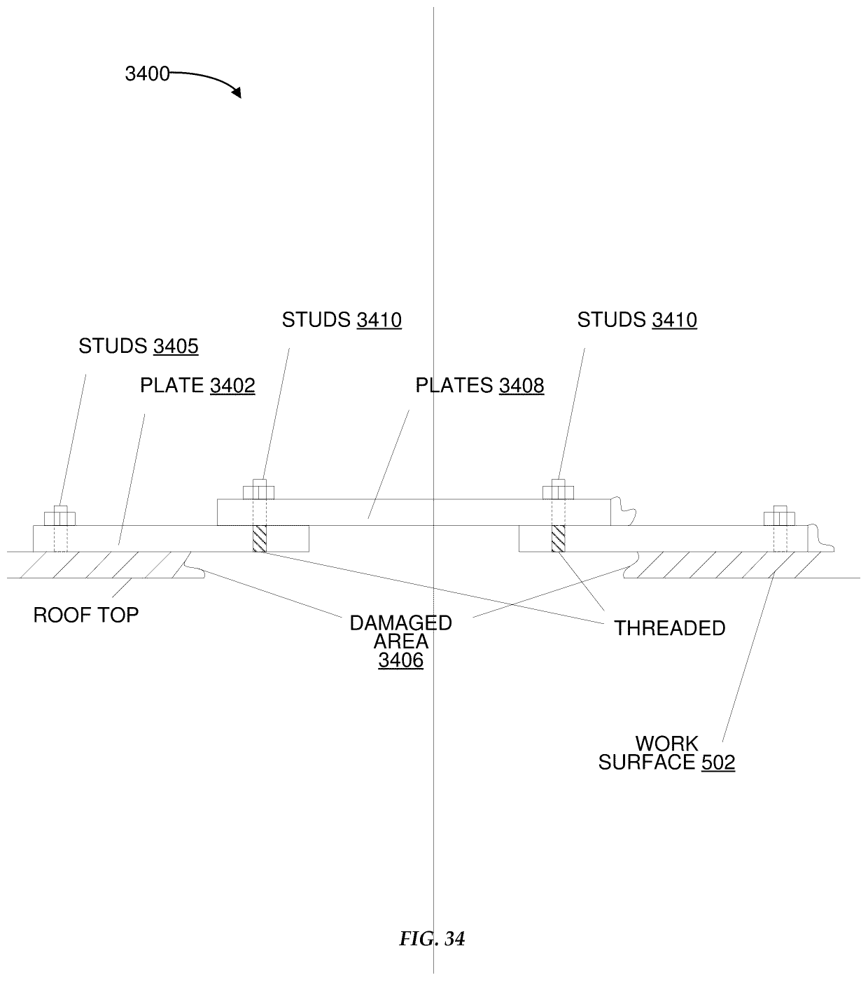

FIG. 34 is a cross-section side-view of a block diagram of a layered defect perimeter sealing system 3400. The layered defect perimeter sealing system 3400 provides live load compression. The layered defect perimeter sealing system 3400 includes a first layer plate 3402 that is secured by a stud 3405 to a work surface 502 around a damaged area 3406 of a tank roof top. The entire top of the first layer plate 3402 is encompassed or spanned by second layer plate 3408. The second layer plate 3408 is secured to the first layer plate 3402 via studs 3410.

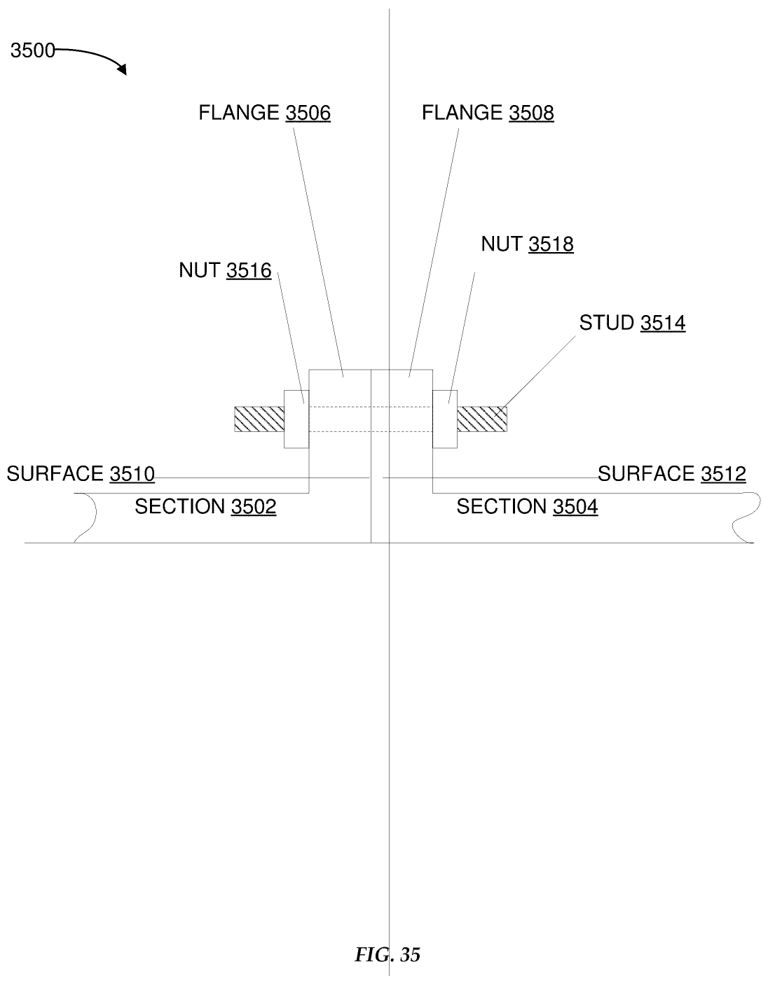

FIG. 35 is a side view of a block diagram of interlocking sections 3500 of a cover/compression panels of a defect perimeter sealing system 3200. The interlocking sections 3502 and 3504 each have a vertical flange 3506 and 3508 with flat surfaces 3510 and 3512 through which a stud 3514 passes and is held secure by nuts 3516 and 3518.

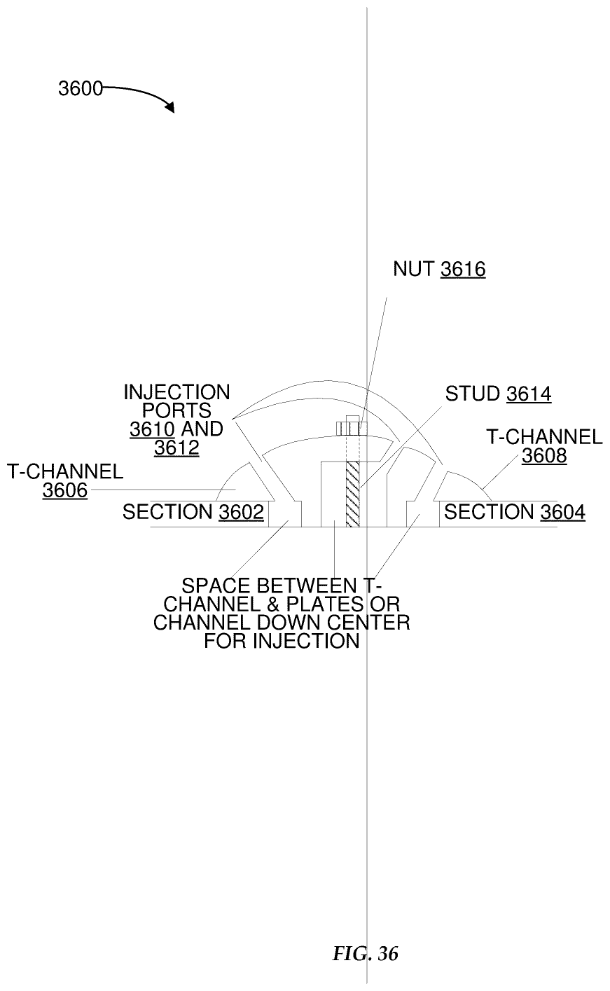

FIG. 36 is a side-view of a cross section block diagram of T-channel interlocking sections 3600 of a perimeter gasket of a defect perimeter sealing system 3200. The interlocking sections 3602 and 3604 each have a t-channel 3606 and 3608 with injection ports 3610 and 3612 through liquid polymer or other adhesive passes and is held secure by stud 3614 and nut 3516.

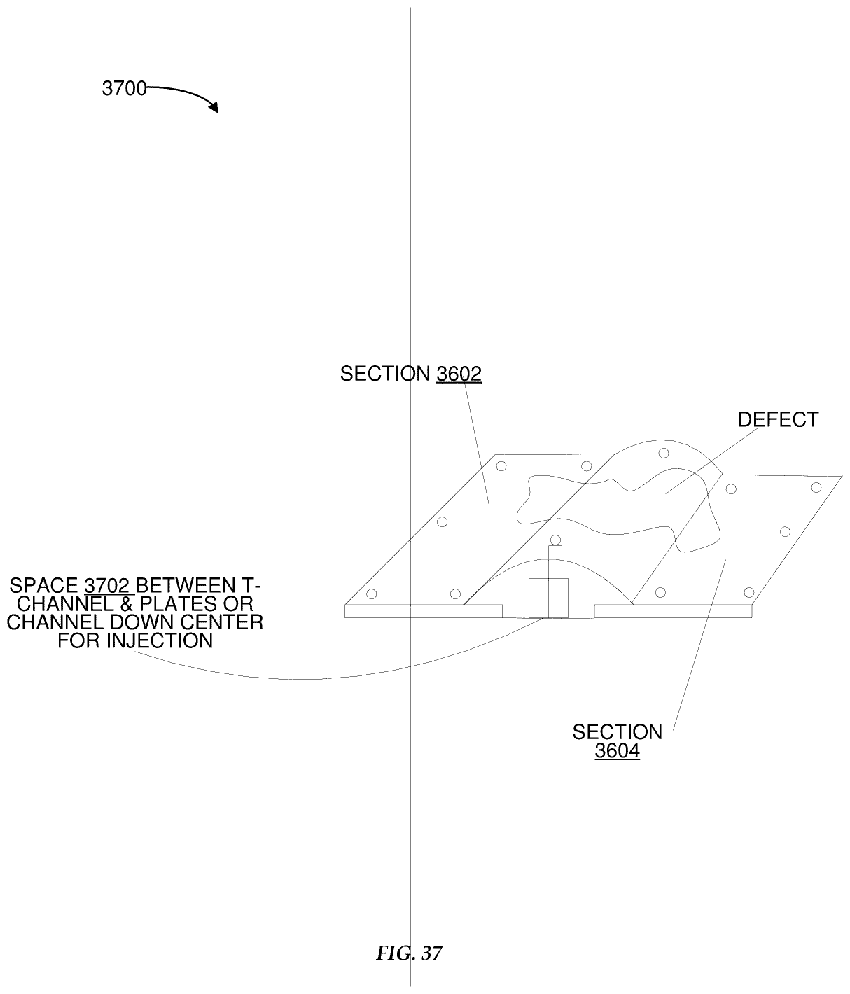

FIG. 37 is an isometric view of a block diagram of T-channel interlocking sections 3600 of a perimeter gasket of a defect perimeter sealing system 3200. The interlocking sections 3602 and 3604 have a channel 3702 into which liquid polymer or other adhesive passes can be injected.

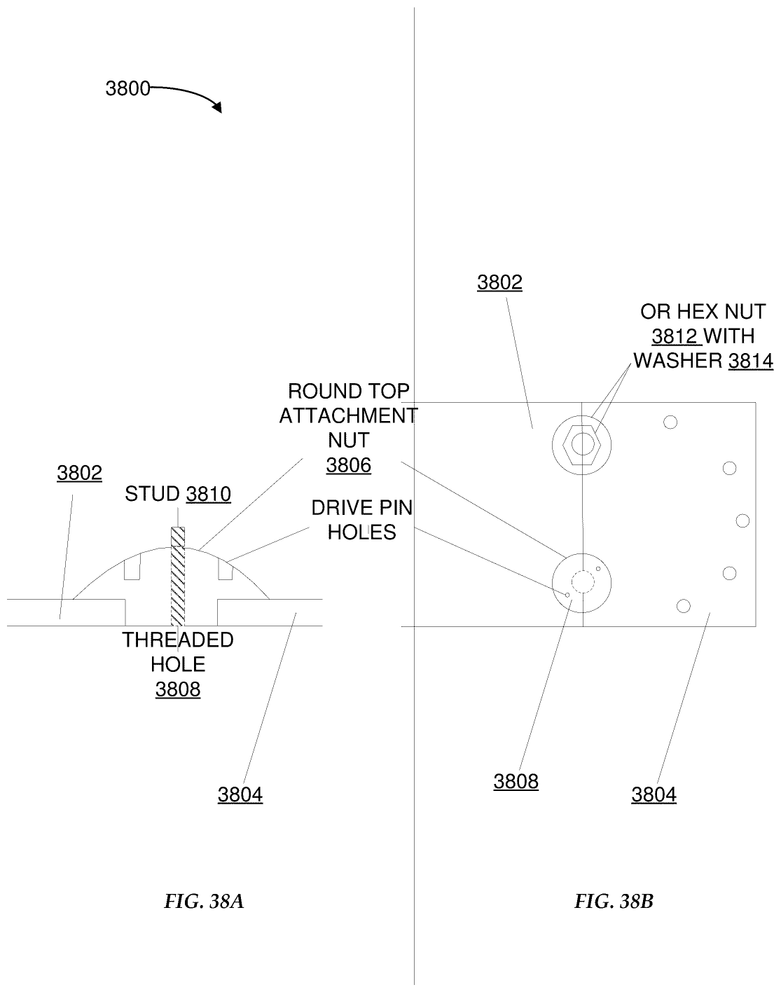

FIG. 38A is a cross-section side-view of a block diagram of sections 3800 of a perimeter gasket of a defect perimeter sealing system 3200. The sections 3802 and 3804 are positioned adjacent to a round top attachment nut 3806 having a threaded hole 3808 that is secured via a stud 3810.

FIG. 38B is a top view of a block diagram of sections 3800 of a perimeter gasket of a defect perimeter sealing system 3200. The sections 3802 and 3804 are positioned adjacent to a round top attachment nut 3806 having a threaded hole 3808 that is secured via a stud 3810. In the alternative to the stud 3810 and the round top attachment nut 3806, a conventional hex nut 3812 with a washer 3814 can be implemented.

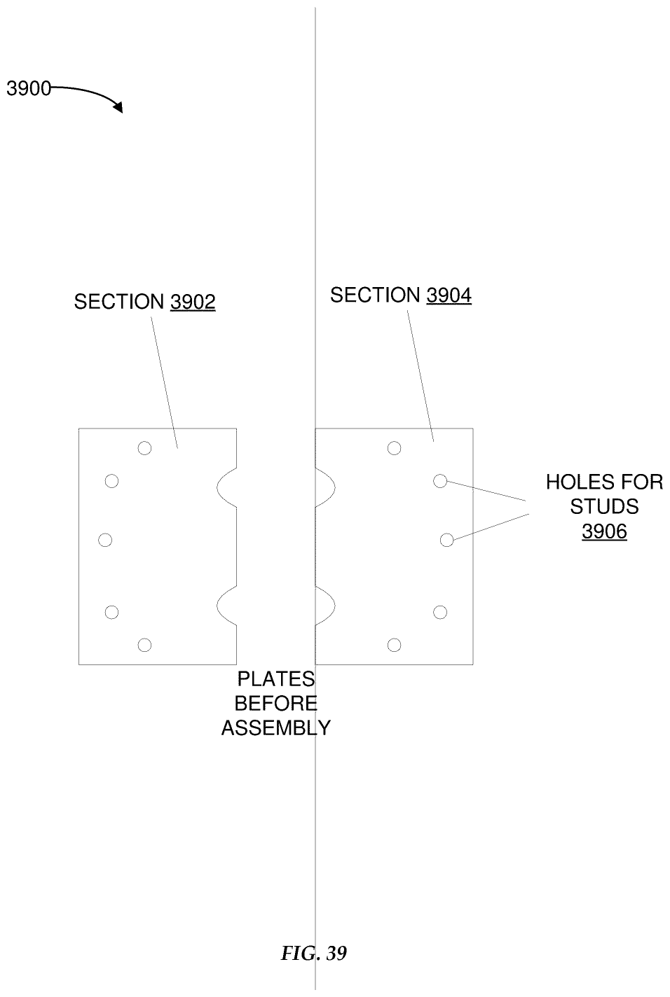

FIG. 39 is a top view of a block diagram of sections 3900 of a perimeter gasket of a defect perimeter sealing system 3200. The sections 3902 and 3904 have holes 3906 for studs.

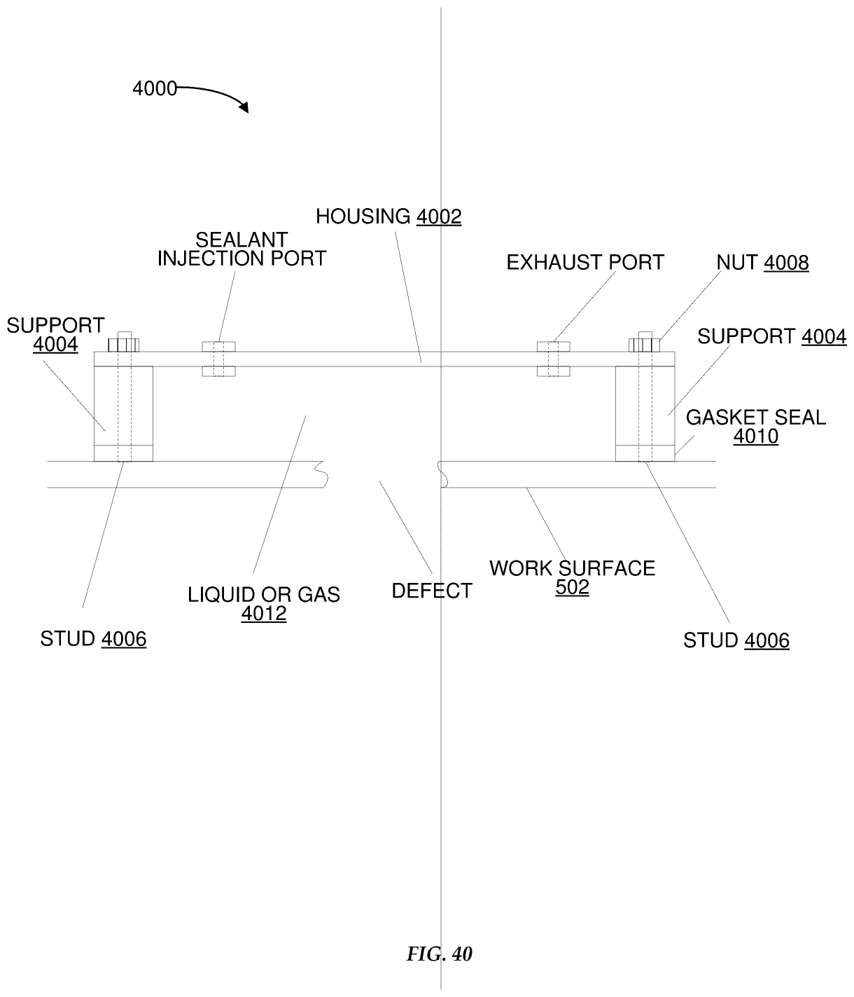

FIG. 40 is a side-view of a cross section block diagram of a friction welding apparatus 4000. The friction welding apparatus 4000 is positioned over a work surface 502 such as deck 102 in FIG. 1. The friction welding apparatus 4000 includes a housing 4002 that is secured to the work surface 502 through a number of supports 4004 between the work surface 502 and the housing 4002, the supports 4004 including a stud 4006 and a nut 4008. The supports 4004 also include a gasket seal 4010 between the support 4004 and the work surface 502. Inert gas 4012 can be released into the chamber formed by the work surface 502 is supports 4004 and the housing 4002 the actuator 512, thus preventing combustion in the vicinity of the tank.

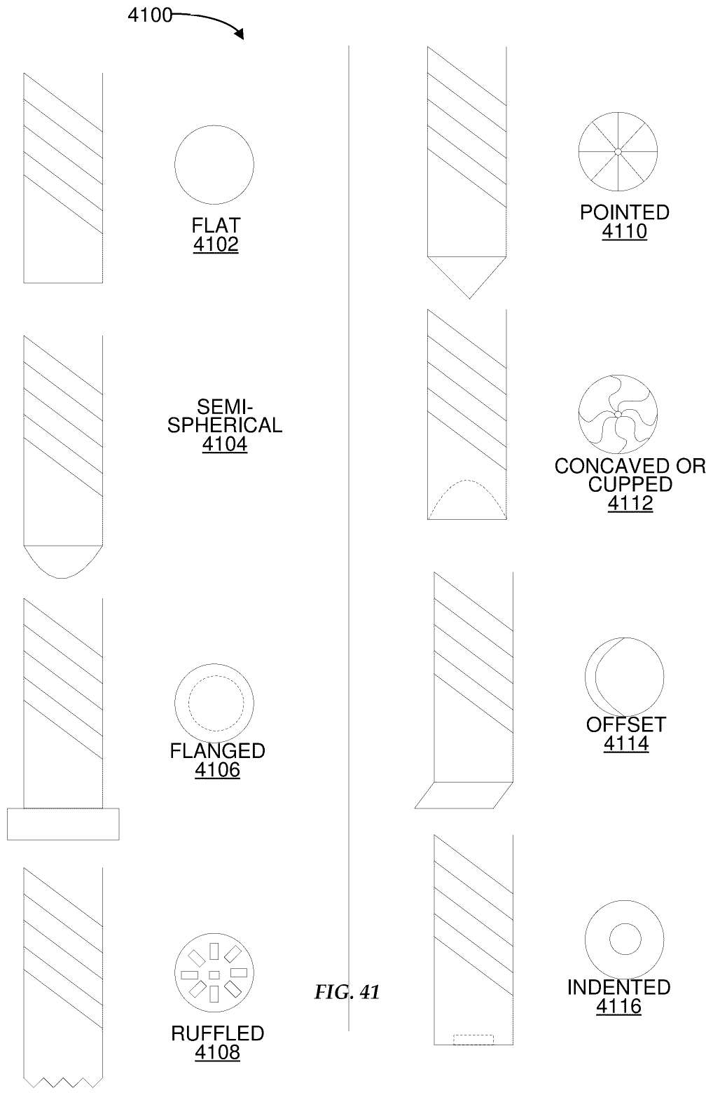

FIG. 41 illustrates eight different stud geometries 4100, such as such as a flat-end stud 4102, a semi-spherical-end stud 4104, a flanged end stud 4106, a ruffled-end stud 4108, a pointed-end stud 4110, a concave or cupped-end stud 4112, and offset-end stud 4114 and an indented-end stud 4116.

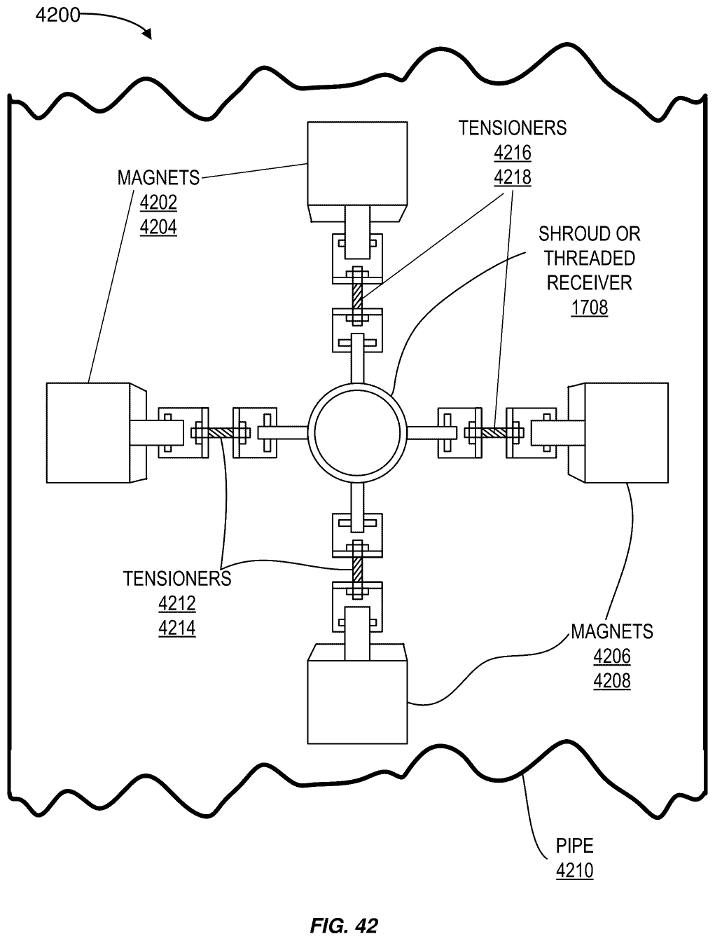

FIG. 42 is a block diagram of a side view of a magnet clamp 4200 operable on a large pipe, according to an implementation. Four permanent magnets 4202, 4204, 4206 and 4208 with disconnects hold a shroud or threaded receiver 1708 against a pipe 4210 during a friction bonding procedure. Tensioners 4212, 4214, 4216 and 4218 connecting each magnet 4202, 4204, 4206 and 4208 to the shroud or threaded receiver are employed to ensure adequate holding force against the pipe 4210. The actuator, with chuck and boss, are attached to the motor and the shroud or threaded receiver 1708 and held in place during the bonding process by the shroud or threaded receiver 1708.

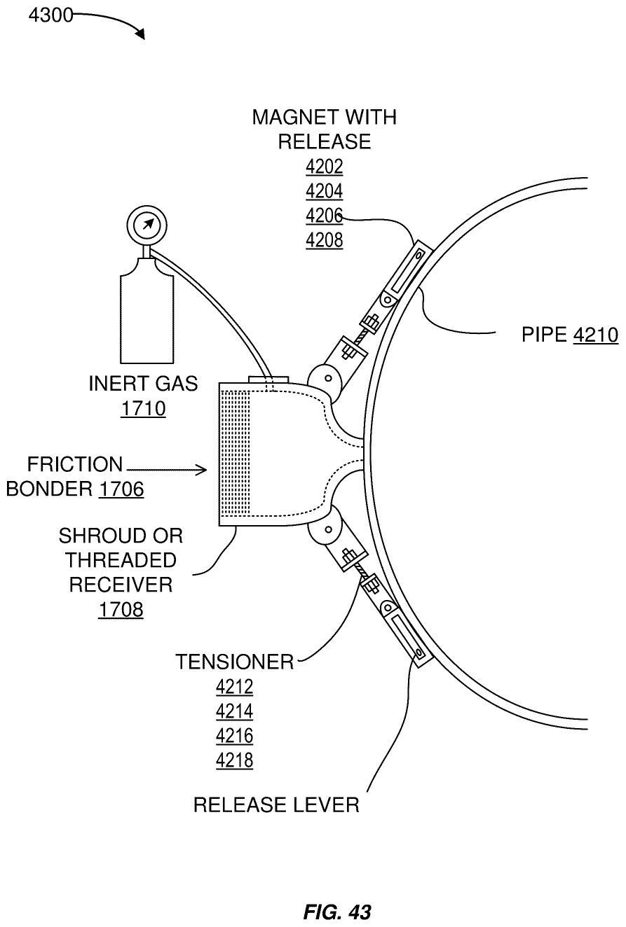

FIG. 43 is cross section block diagram of a top view of the magnet clamp 4200, according to an implementation. The magnet clamp 4200 includes a tensioner (4212, 4214, 4216 or 4218) coupled to a magnet (4202, 4204, 4206 or 4208) with a release that is coupled to a pipe 4210. The tensioner (4212, 4214, 4216 or 4218) is rotatably coupled to a shroud or threaded receiver that receives a friction bonder. Inert gas is injected into the shroud or threaded receiver 1708 during the bonding process. Each tensioner (4212, 4214, 4216 or 4218) is made of a bolt and nut with two flanges. When the bolt is tightened, the flanges are pulled together and tension the shroud against the pipe. Other tensioners could be used instead of the bolting tensioners shown.

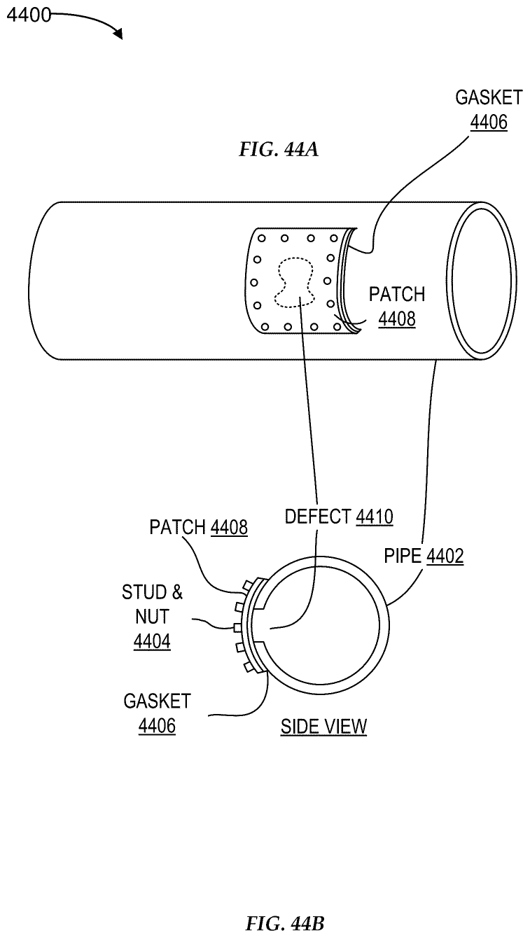

FIG. 44A is an isometric diagram and 44B is a cross section diagram of a repaired pipe 4400 using a metal patch, according to an implementation. A clamp, such as clamp 4200 or clamp 4300, is used to secure the friction welder to a surface of the pipe 4402 to bond a series of studs and nuts 4404 to the pipe 4402. A gasket 4406 is then placed over the studs and nuts 4404 followed by a patch 4408. In some implementations, the gasket 4406 is made of rubber, but in other implementations the gasket 4406 is made of any poly compound or soft material suitable for a gasket. In some implementations, the patch 4408 is made of steel, but in other implementations of the patch 4408 is made out of any rigid, strong material. The patch 4408 is then pulled tightly against the gasket 4406 and the surface of the pipe 4402 by tightening the studs and nuts 4404, which seals the defect 4410 area in the pipe 4402.

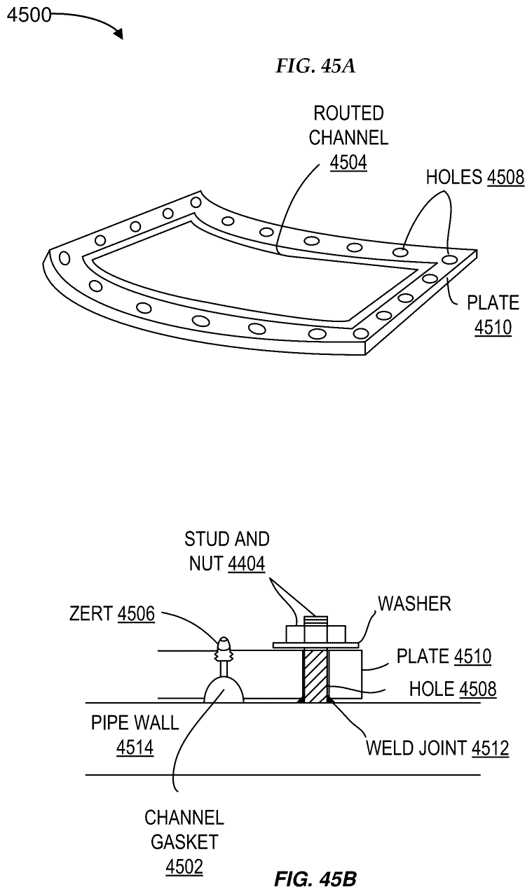

FIG. 45A is an isometric diagram and 45B is a cross section diagram of a repair plate 4500 that uses a channel gasket, according to an implementation. A channel gasket 4502 is a long round flexible gasket shaped somewhat like a smooth rope that lies in a routed channel 4504 routed around the perimeter of the pre-warped plate 4510. In some implementations, zerts 4506 are added to allow sealant to be injected into the routed channel 4504. A simple set screw or bolt could also be used in place of zerts 4506 to close the opening after the routed channel 4504 is injected with sealant. Though the channel gasket 4502 is shown to be semicircular in shape it is round before installation. The channel gasket 4502 could be rectangular, square or any other shape. A series of studs and nuts 4404 are attached to the pipe wall 4514 by weld joints 4512. Studs and nuts 4404 pass through holes 4508 in plate 4510 to attach plate 4510 to pipe wall 4514.

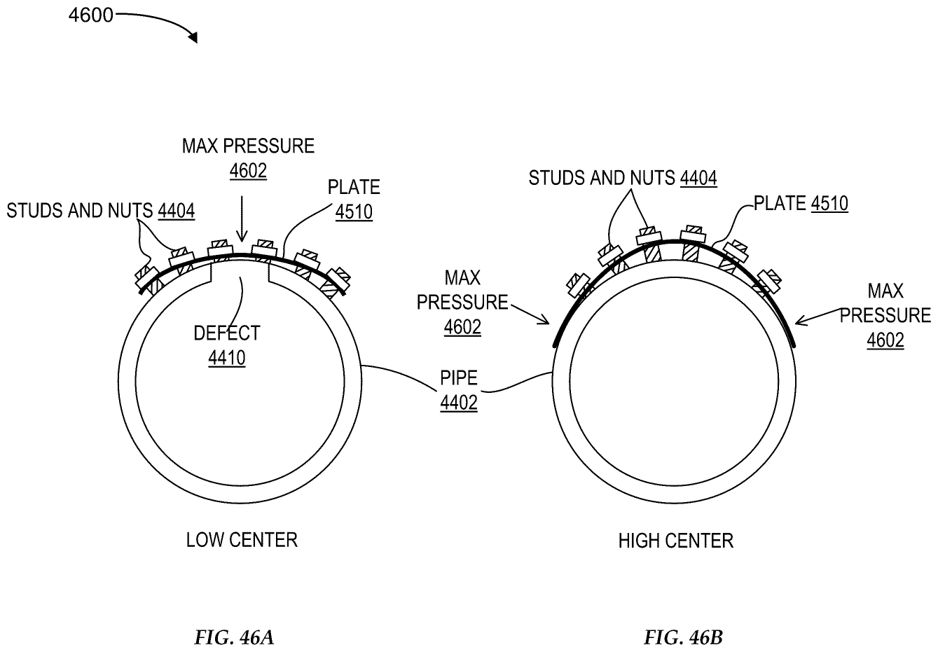

FIGS. 46A and 46B are cross section diagrams 4600 of a plate that is pre-warped to mismatch the curvature of a pipe, according to an implementation. Any pre-warped plate 4510 creates uneven pressure across the entire plate 4510. If the plate 4510 is low-center pre-warped as shown in FIG. 46A, higher pressure 4602 will be created at the center of the plate 4510. If the plate 4510 is high-center pre-warped as shown in FIG. 46B, higher pressure 4602 will be created at the edge of the plate 4510. By selectively pre-warping the plate a seal with higher integrity can be made at specific locations under the plate 4510.

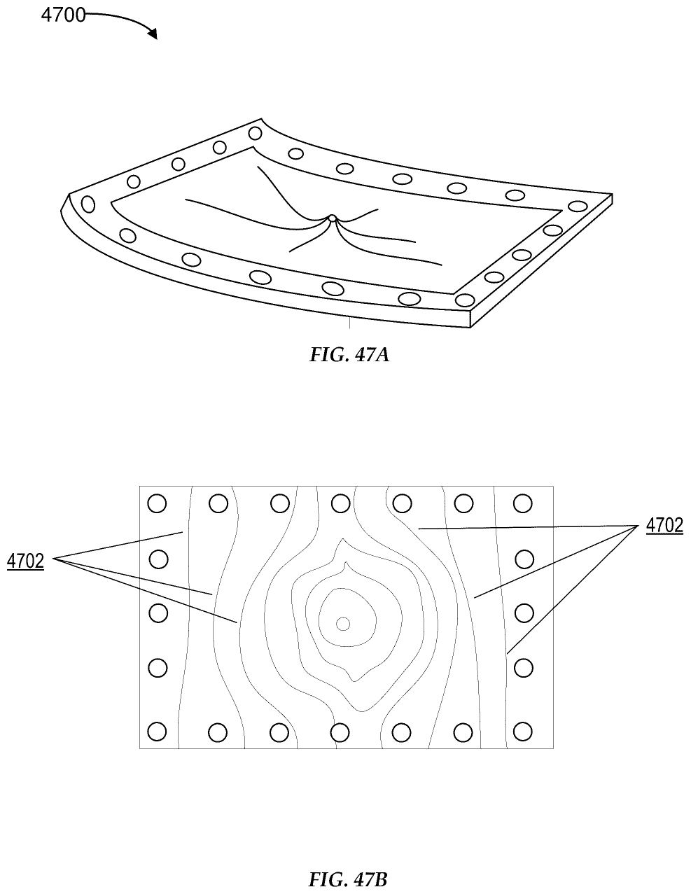

FIG. 47A is an isometric diagram and 47B is a block diagram of a plate 4700 that is pre-warped with a gradient to alter the location of the maximum pressure on the pipe to enhance sealing at the defect area 4410, according to an implementation. FIG. 47B shows topographical lines 4702 of a gradient pre-warped plate.

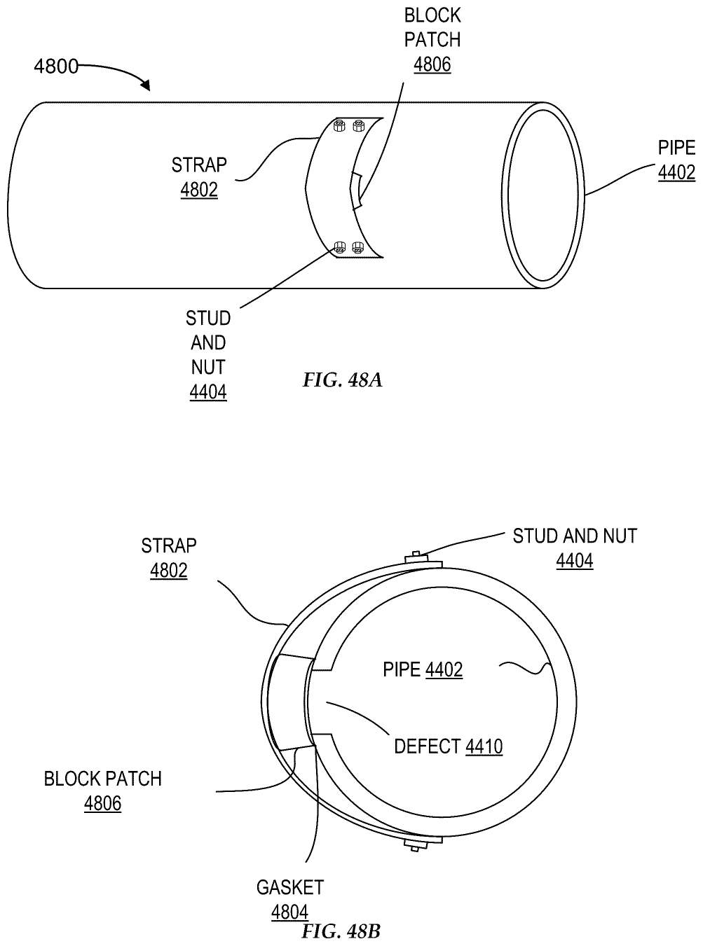

FIG. 48A is an isometric diagram and 48B is a cross section diagram 4800 of a block patch used to add more pressure at a defect area of a pipe to enhance sealing of the defect, according to an implementation. A strap 4802 is made of a strong yet slightly flexible material such as sheet metal. A gasket 4804 is placed between the block patch 4806 and the pipe 4402. Block patch 4806 could be made of a semi-soft material like hard rubber to eliminate the need for gasket 4804. The strap 4802 is pulled taught by the studs and nuts 4404 to apply pressure to the block patch 4806. The advantage of this type of patch over the pre-warped plate in FIG. 46A, 46B, 47A and FIG. 47B is that this repair can be prepared and performed on site. The thickness of block patch 4806 could be of any thickness that enhances the seal.

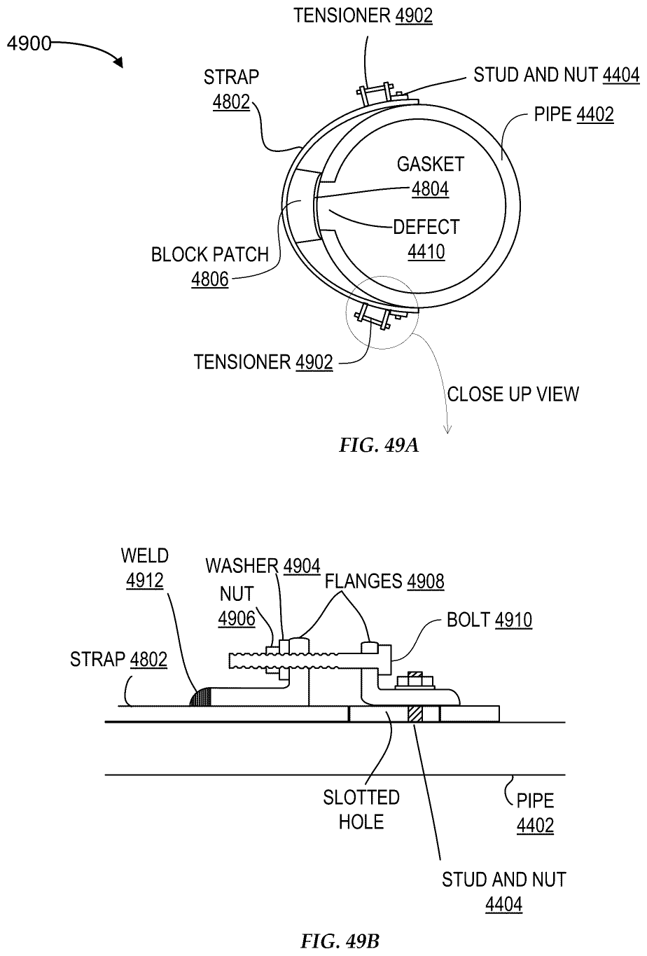

FIG. 49A is a cross section block diagram and 49B is a cross section block diagram of a block patch with tensioners 4900, according to an implementation. The patch is similar to the patch in FIGS. 48A and 48B, but with the addition of tensioners 4902 to apply pressure to the block patch 4806. A close up of a low-cost implementation of the tensioner 4902 is shown in the FIG. 49B, which includes a washer 4904 and a nut 4906 that passes through flanges 4908 and are secured to a bolt 4910. The flanges 4908 are secured to the pipe 4402 or the strap 4802 either through a stud and nut 4404 or a weld 4912. Other tensioners could be used to serve the same purpose.

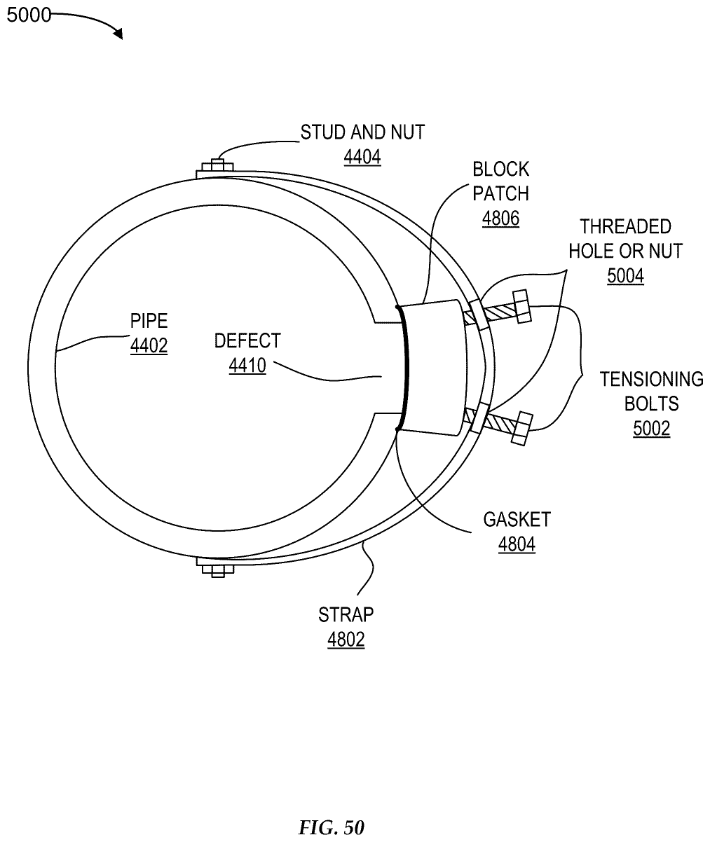

FIG. 50 is cross section diagram of a block patch with adjusters 5000, according to an implementation. Instead of using tensioners to add pressure to the block patches as shown in FIG. 49A and FIG. 49B, adjusters or tensioning bolts 5002 through a threaded hole or nut 5004 can be screwed or tightened against the block patch 4806 to apply pressure. Tensioning bolts 5002 do not require slotted holes drilled in the strap 4802. Stud and nut 4404 are standard friction bonded studs and do not require slotted holes drilled in the strap 4802.

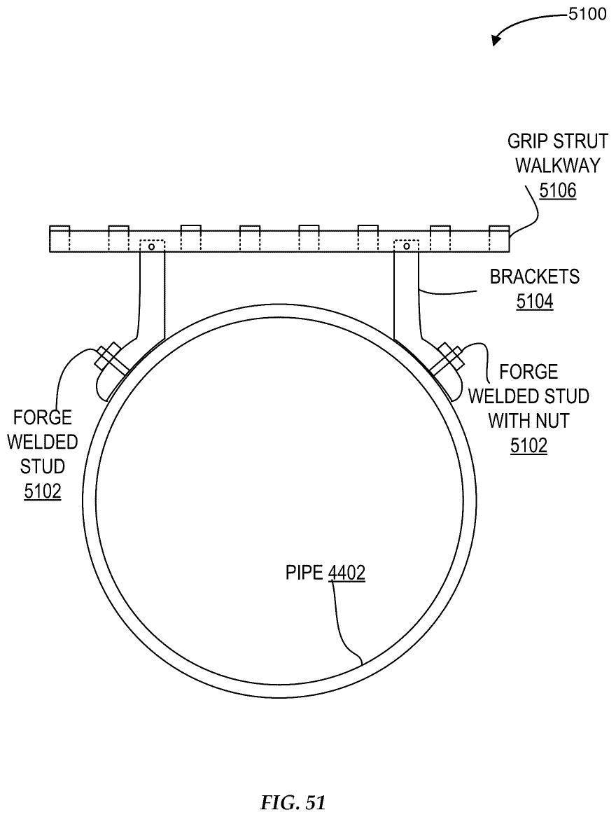

FIG. 51 is a cross section diagram of friction forge bonded studs being used to secure a walkway to a pipe 5100, according to an implementation. Studs 5102 are first attached to the pipe 4402, then walkway brackets 5104 are installed. Once the brackets 5104 are installed the walkways 5106, such as Grip Strut®, are bolted to the brackets 5104. The brackets 5104 could also be pre-welded to the Grip Strut® walkways 5106. Ladders (not shown in FIG. 51) could be attached to vertical pipes in the same way even if volatile material is flowing in the pipe 4402.

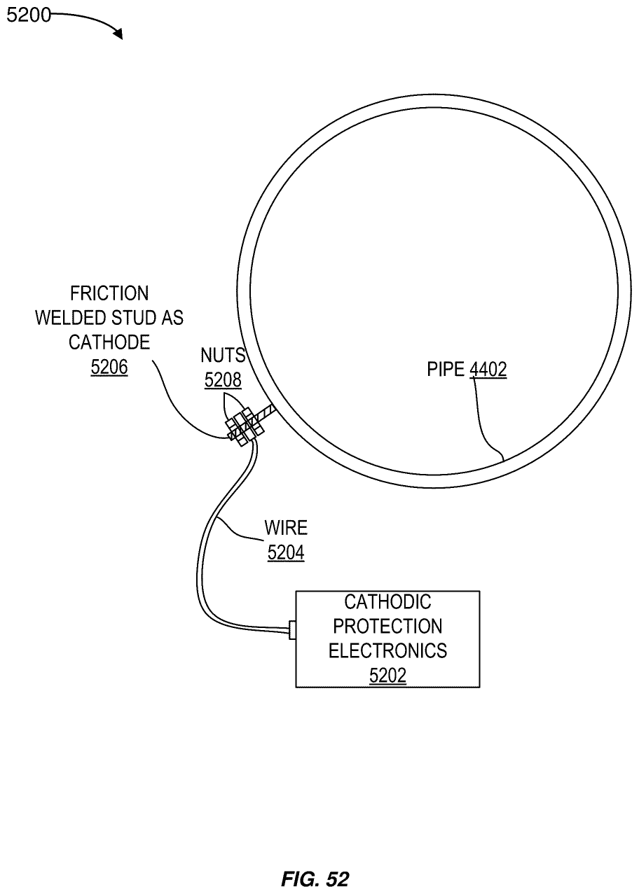

FIG. 52 is a cross section diagram of a cathodic protected pipe 5200 where a friction forge bonder (PFFB) attaches cathodes for cathodic protection on pipelines, according to an implementation. A cathodic protected pipe includes cathodic protection electronics 5202 coupled via a wire 5204, a friction welded stud 5206 and nuts 5208 that acts as a cathode. A friction forge bonded stud is a better electrical contact than drill and tap and is much stronger and less likely to break off from accidental impact. A friction welded cathode is also less likely to corrode over time.

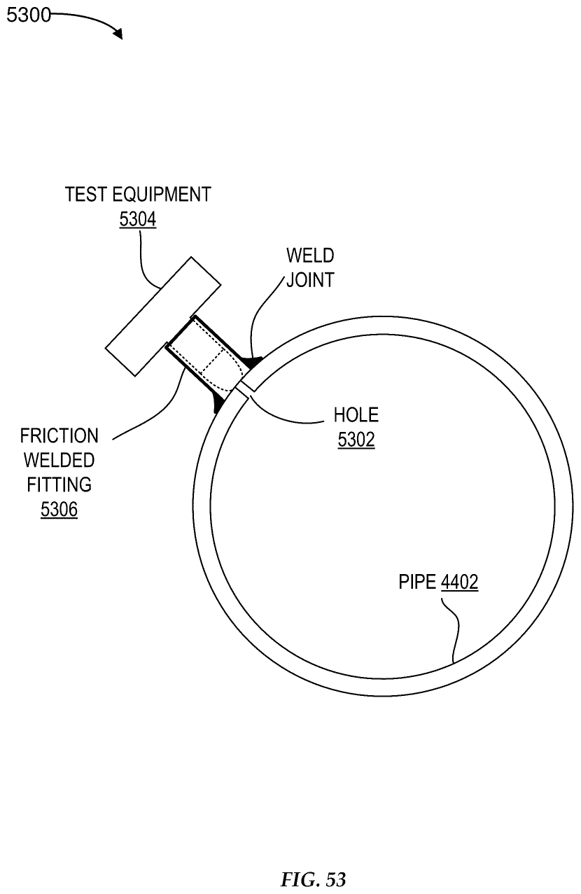

FIG. 53 is a cross section diagram of a large 2″ fitting attached for testing or sampling chemicals or conditions in a pipe 5300, testing of the environment outside the pipe or both, according to an implementation. A hole 5302 is drilled in the pipe 4402. This allows chemicals in the pipe 4402 to be sampled or measured. Test equipment 5304 can be mounted to a friction welded fitting 5306 or the test equipment 5304 can be cable connected (not shown) or connected to a bracket (also not shown).

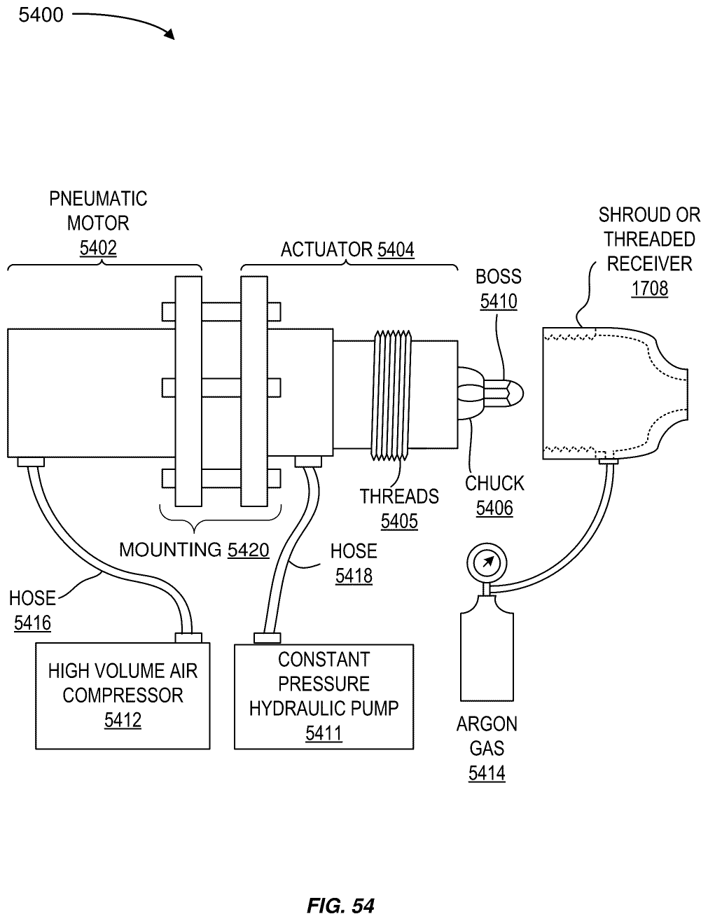

FIG. 54 is a block diagram of a portable friction forge bonder (PFFB) 5400, according to an implementation. The portable friction forge bonder (PFFB) 5400 includes a pneumatic motor 5402, an actuator 5404 and a chuck 5406. A shroud or threaded receiver allows the PFFB to be connected to the device being enhanced or repaired. The chuck 5406 holds and couples the rotational driving force from the motor 5402 and the axial load force from the actuator 5404, to a boss 5410. The actuator 5404 that has threads 5405 applies a predetermined amount of load to the chuck 5406 and the boss 5410 through pressure from a constant pressure hydraulic pump 5411. The motor 5402 derives its power from a high volume air compressor 5412. The shroud or threaded receiver bathes the boss 5410 in an inert gas such as argon gas 5414 to eliminate air and thus any possibility of ignition from the welding area and to improve the quality of the weld. The constant pressure hydraulic pump 5411 is operably coupled to the actuator 5404 through a hose 5418. The high volume air compressor 5412 is operably coupled to the pneumatic motor 5402 through a hose 5416. The high volume air compressor 5412 can be connected to the constant pressure hydraulic pump 5411 to provide power for the constant pressure hydraulic pump 5411. A hand pump (not shown) could also be used to power constant pressure hydraulic pump 5411.

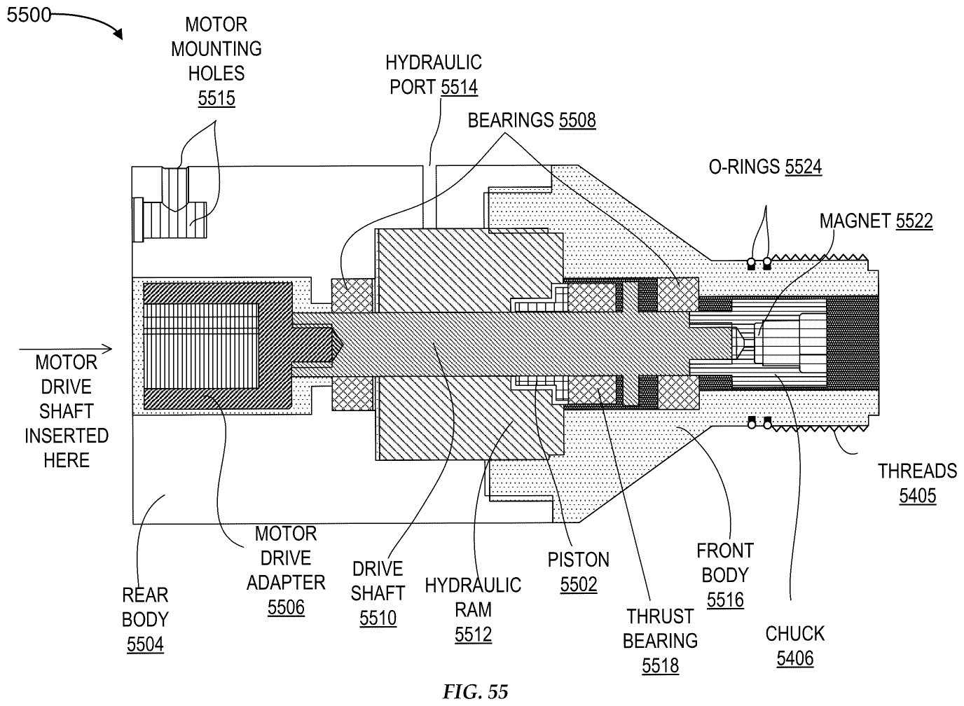

FIG. 55 is a cross-sectional drawing of an actuator 5500, according to an implementation. Constant pressure hydraulic pump 5411 applies hydraulic pressure through hose 5418, through hydraulic port 5514, to the hydraulic ram 5512 which applies pressure to the thrust bearing 5518 which then applies pressure to the drive shaft 5510, which in turn applies pressure to the chuck 5406 in FIG. 54 and the boss 5410 (boss 5410 not shown in FIG. 55) in FIG. 54. Magnet 5522 holds boss 5410 in place during initial setup of the welding process. The thrust bearing 5518 allows drive shaft 5510 to rotate under pressure from hydraulic ram 5512 while allowing axial force to be applied to the chuck 5406. The threads 5405 hold the actuator 5404 in FIG. 54 to the shroud or threaded receiver, so that the pressure on the boss 5410 in FIG. 54 is transferred to the valve during friction welding. As the boss 5410 in FIG. 54 is driven into the surface of tank 100 during the welding process, the constant pressure hydraulic pump 5411 in FIG. 54, and the piston 5502 with hydraulic ram 5512 absorbs the spatial difference. The mounting 5420 in FIG. 54 is an attachment apparatus between the pneumatic motor 5402 in FIG. 54 and actuator 5404 in FIG. 54. A drive shaft 5510 is inserted into a rear body 5504 of the actuator 5500 that includes a motor drive adapter 5506 and bearings 5508. The motor drive adapter 5506 is operably connected to a drive shaft 5510 which is operably connected to a hydraulic ram 5512. The rear body 5504 includes a hydraulic port 5514 and motor mounting holes 5515 (a portion of mounting 5420 in FIG. 54). A front body 5516 is operably connected to the rear body 5504, and contains bearings 5508, a thrust bearing 5518, a motor drive adapter 5506 and a magnet 5522. The front body 5516 also includes O-ring 5524 that seals to a shroud or threaded receiver such as a hydraulic clamp and the front body 5516 includes threads 5526 to connect to the shroud to a threaded receiver. Chuck 5406 in FIG. 54 is shown to protrude from actuator 5404 in FIG. 54 and chuck 5406 in FIG. 55 is shown to be contained within actuator 5500. These are two different implementations that perform the same function.

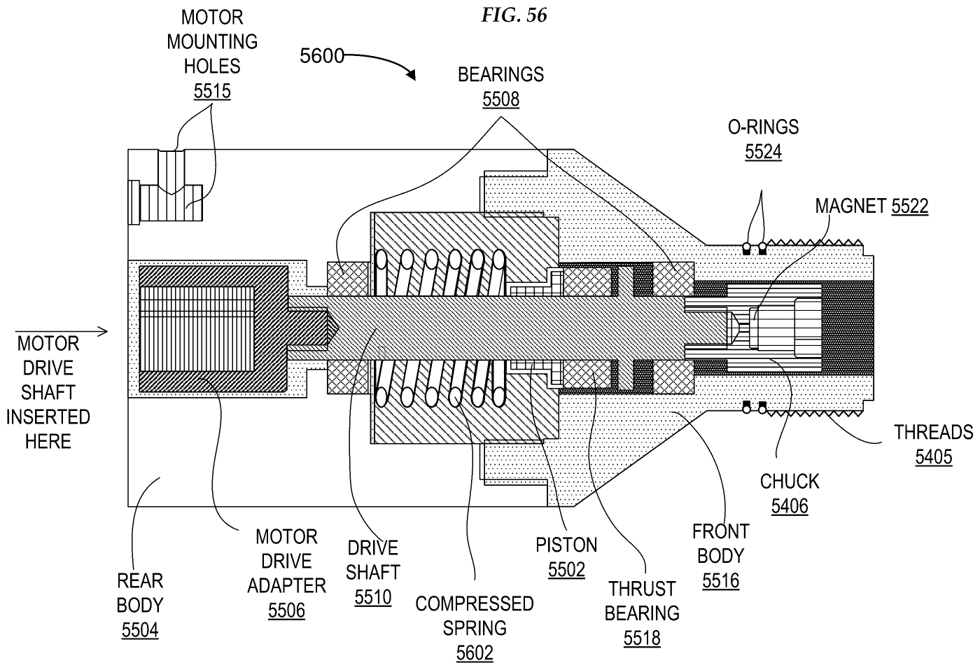

FIG. 56 is the cross-sectional drawing of an actuator 5600, according to an implementation. Actuator converts spring force into force on the piston 5502 which in turn applies a force to the chuck 5406 in FIG. 54 and the boss 5410 in FIG. 54. The threads 5405 hold the actuator 5600 to the clamping device, so that the force on the boss 5410 in FIG. 54 is transferred to the tank 100 during friction welding. The compressed spring 5602 maintains constant pressure on the piston 5502. As the boss 5410 in FIG. 54 is driven into the surface of tank 100 during the welding process, the compressed spring 5602 and piston 5502 absorb the spatial difference. The mounting holes 5515 (a portion of mounting 5420 in FIG. 54) provide an attachment apparatus for the pneumatic motor. A driveshaft is inserted into a rear body 5504 of the actuator 5600 that includes a motor drive adapter 5506 and bearings 5508. The motor drive adapter 5506 is operably connected to a drive shaft 5510 and passes through a compressed spring 5602, piston 5502 and thrust bearing 5518. The rear body 5504 includes motor mounting holes 5515. A front body 5516 is operably connected to the rear body 5504, and contains bearings 5508, a thrust bearing 5518, a chuck 5406 and a magnet 5522. Magnet 5522 holds boss 5410 in place during initial setup for a weld process. The front body 5516 also includes O-ring 5524 that seals to a shroud or threaded receiver such as a chain clamp and the front body 5516 includes threads 5526 to connect to the shroud to a threaded receiver. Different strength springs can be used to vary the axial force applied by the actuator 5600. Also, coaxial springs or smaller springs placed inside of larger springs can be used to select the axial force applied by actuator in smaller increments.

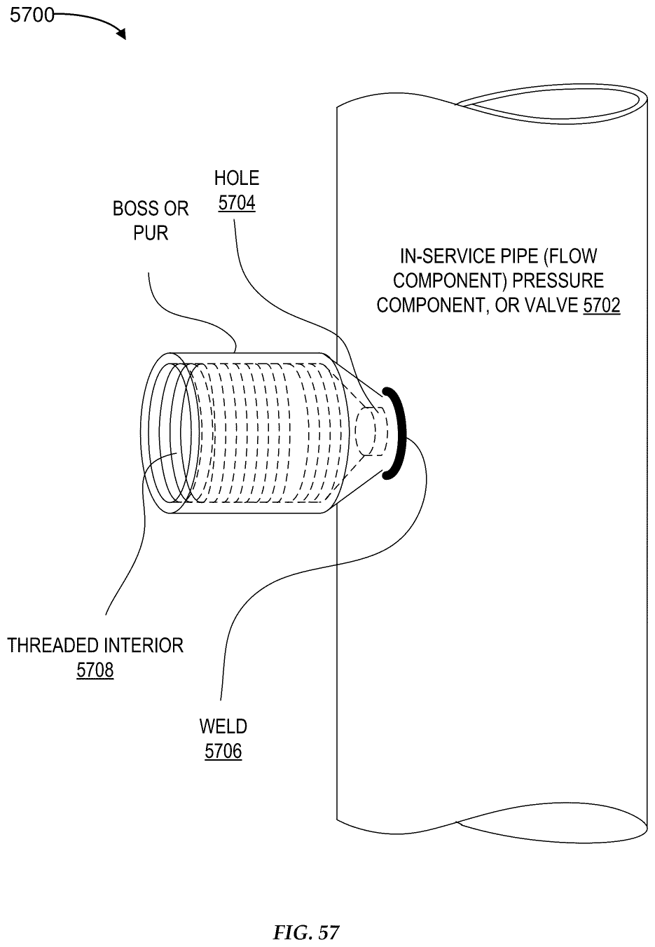

FIG. 57 is an isometric diagram of a boss or Permanent Universal Receiver (PUR) attached through friction welding, also known as solid state joining or friction bonding, to an in-service pipe (flow component), pressure component or a valve, according to an implementation. Friction welding is also known as solid-state joining or friction bonding. Friction welding has superior qualities to other types of welding, joining or bonding such as; lower temperature, spark-free, welding of dissimilar metals and materials, welding under water and within liquids, welding in hazardous environments, welding without needing to clean the work surface, higher tensile and sheer strength and higher torque capacity. The pressure component could contain a positive, negative or ambient pressure. An in-service pipe, pressure component, a valve or other container 5702 may be in or out of service when the PUR is being attached however, there is great value in attaching PUR while pipe (flow component), pressure component, or valve 5702 is in-service. The PUR is attached to the in-service pipe 5702 by friction welding the PUR to the in-service pipe 5702 wall, creating a weld 5706. To gain access to the inside of pipe, pressure component or valve 5702 or to the contents within it, a hole 5704 may be drilled. The in-service pressure component 5702 may also be a valve flange or the valve bonnet. The PUR contains at least one set of threads 5708 for receiving a multitude of devices, equipment or sensors. Any other attachment apparatus could be used such as threads, cam locks, unions, flanges, twist locks, clamps or external threads. An internal set of threads are shown in FIG. 57. A second set of outer threads could be added and used to receive additional devices or to accept a protective cover for the PUR. With a single PUR, an unlimited number of devices can be designed for attachment to the in service pipe, pressure component or valve 5702. In repairing valves, the boss or PUR receives an injection system. This allows the valve 5702 to be repaired and still allow additional devices or equipment to be attached. For example, a tag indicating repair date or status, regulatory body compliance, maintenance tracking information or bar codes can be attached. Sensors for temperature, vibration, acoustics, chemical analysis, radio frequency or strain, for example, could be attached to the PUR. Also, sensors that collect data inside, on the surface of or outside pipe, pressure component or valve 5702 could be attached to PUR. Any type of sensor could be attached to the PUR. The PUR can be attached as a hot tap to pipes to sense, for example, flow rate, temperature, viscosity, pressure, chemical composition, gaseous state, contamination or color. Any hot tapping device could be attached to the PUR including a bleeder or an injection port. By using a single PUR to receive any type of device, far more flexibility is achieved allowing for a far greater variety of uses and since fewer PUR designs can meet many needs, the cost could potentially be lower. In addition, custom or industry standard equipment, devices or sensors can be installed in the PUR.

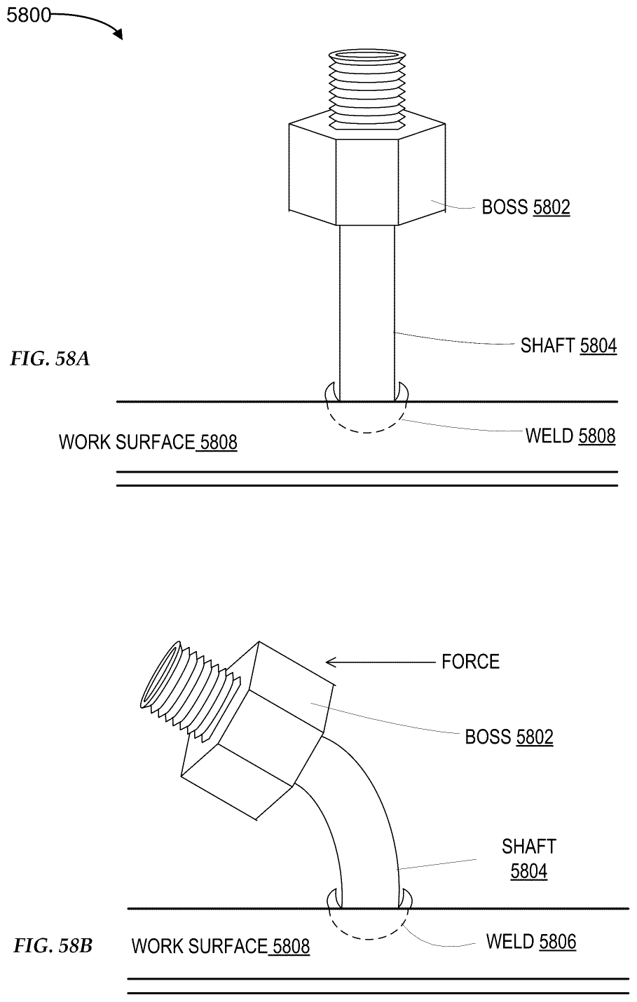

FIG. 58A and FIG. 58B are isometric drawings of a PUR or boss that is bonded to a work surface through friction welding and subjected to a lateral force at the top of the PUR or boss, according to an implementation. The PUR 5802 in FIG. 58A and FIG. 58B has a shaft 5804 that is weaker and more flexible than the weld 5806 or the work surface 5808, allowing a bending of the shaft 5804 to occur when a lateral force is applied as shown in the bottom drawing. The shaft 5804 prevents the weld 5806 or the work surface 5808 from being damaged, protecting the technician and the environment from hazardous chemical release. Standard stainless steel is used to manufacture the PUR 5802, however, any metal can be used that provides the above mentioned advantages. Generally, a softer metal used to manufacture the PUR 5802, will provide more stress relief. An additional advantage of using a softer metal to manufacture the PUR 5802 is that a softer metal generates less heat in the welding process and reduces the temperature at the backside of the work surface 5808. This reduction in temperature provides more safety and less alteration of the chemicals in contact with the backside of the work surface 5808.

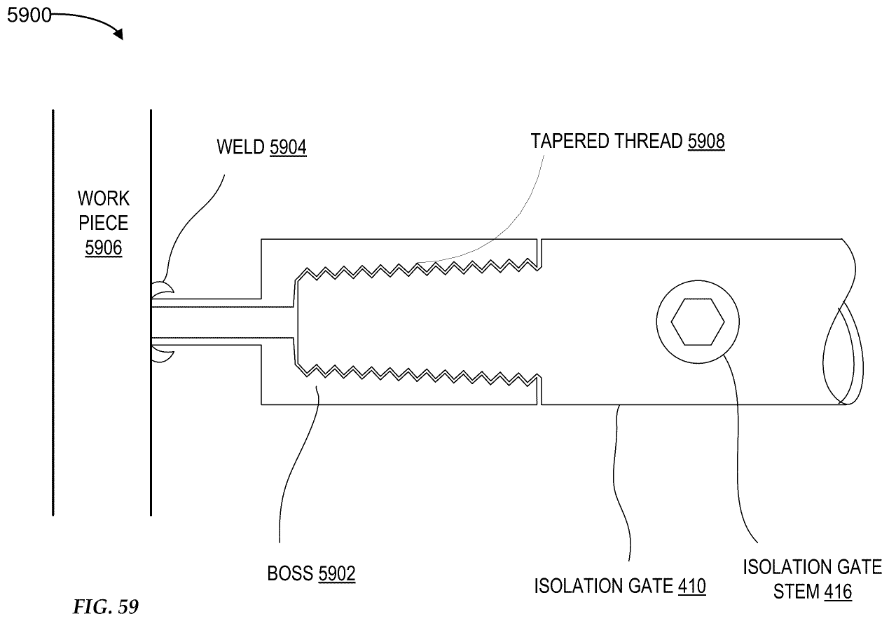

FIG. 59 is an isometric cross section drawing of a PUR or boss that has been attached to a work surface by friction welding or bonding, or solid-phase or solid-state welding and is threaded with a tapered thread 5900, according to an implementation. The PUR or boss 5902 is attached to a work surface by friction welding or bonding, or solid-phase or solid-state welding to create a weld 5904 between the PUR or boss 5902 and a work piece 5906. The PUR or boss 5902 receives an isolation gate that has a tapered thread 5908, such as a tapered thread in accordance with American National Standard Pipe Thread (NPT) published by the American Society of Mechanical Engineers of New York City, NY, providing a better seal and better resistance to vibration, temperature cycling and leakage than non-tapered threads.

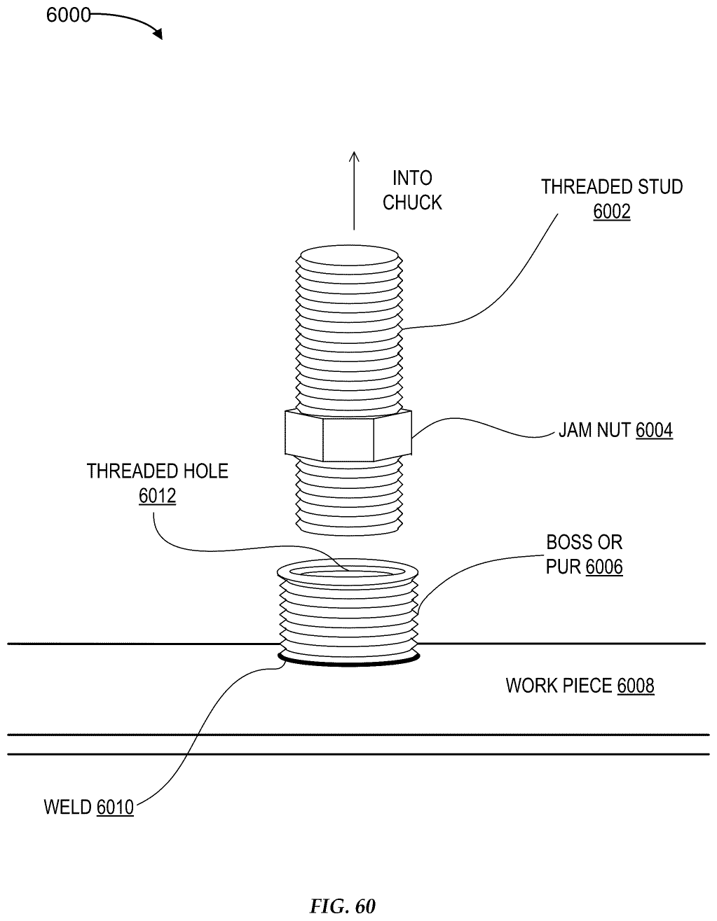

FIG. 60 is an isometric drawing of a very low-profile boss or PUR that is solid-state welded to a work piece, the PUR for receiving a threaded stud and jam nut which is screwed into a chuck, according to an implementation. A threaded stud 6002 and jam nut 6004 are used to operably couple the PUR 6006 to the chuck (not shown in FIG. 60) during the solid-state welding process. As the chuck is rotated by the motor and actuator (not shown in FIG. 60), the threaded stud 6002 transfers this rotational energy to the PUR 6006. Once the PUR 6006 is bonded to the work piece 6008 by a friction weld 6010, the jam nut 6004 and threaded stud 6002 are loosened from a threaded hole 6012 in the PUR 6006 and the threaded stud 6002 and jam nut 6004 are removed from both the chuck and the PUR 6006. A second jam nut (not shown) could be used to lock the stud into the chuck. Any number of bonding techniques can be used to attach the PUR 6006 to the work piece 6008. The work piece 6008 can be a pressure component, a pipe or a valve. The PUR 6006 allows installation in environments where mechanical interference is an issue.

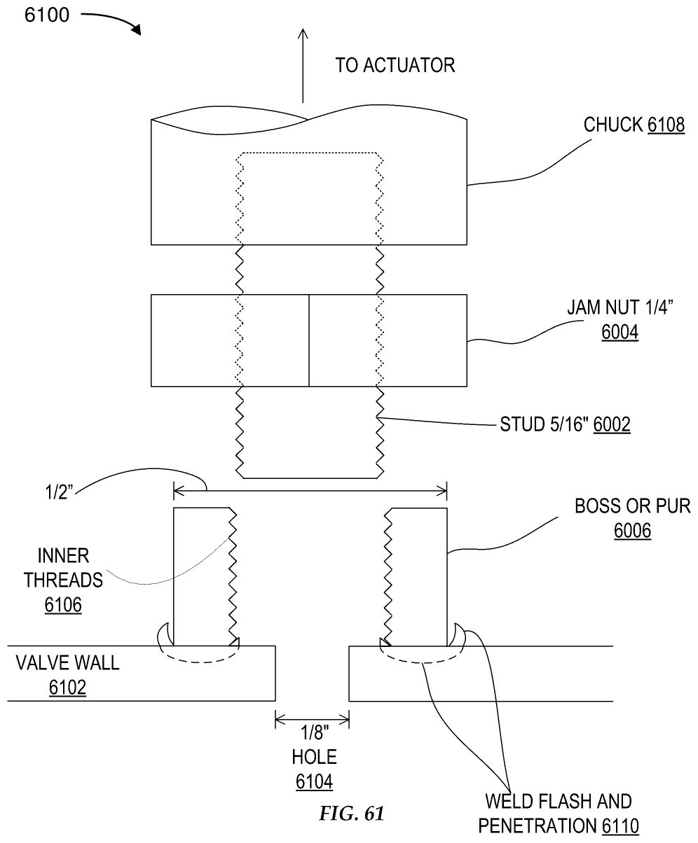

FIG. 61 is a cross-sectional side view of the very low-profile boss in FIG. 60, according to an implementation having internal threads on the very low-profile boss. The very low-profile boss or PUR 6006 is shown friction welded to a valve wall 6102 with a hole 6104 drilled through the valve wall 6102. The hole 6104 in the valve wall 6102 is drilled with a narrower diameter than inner threads 6106 of the PUR 6006 to ensure that during the drilling process, the inner threads 6106 of the PUR 6006 are not damaged. To prepare for the friction welding process, the stud 6002 is screwed into the PUR 6006 and the jam nut 6004 is tightened against the PUR 6006 to prevent the stud 6002 from extending beyond the lower edge of the PUR 6006 which prevents the stud 6002 from interfering with the valve wall 6102 during the friction welding process. If the stud 6002 is not long enough to bottom out in the chuck 6108 or if the chuck 6108 does not have a stop for the stud 6002, then a second jam nut (not shown) can be added and tightened against the bottom of the chuck 6108. Any kind of thread (course thread or a fine thread) could be used for the stud 6002 and the PUR 6006. The chuck 6108 does not have to be threaded, but could be any type of chuck 6108 that could hold the stud 6002 during friction welding. The stud 6002 does not have to be threaded at its top if the chuck 6108 is capable of holding the stud 6002 without threads. Also shown in FIG. 61 is the weld flash and penetration zone 6110 from the friction weld 6010 in FIG. 60.

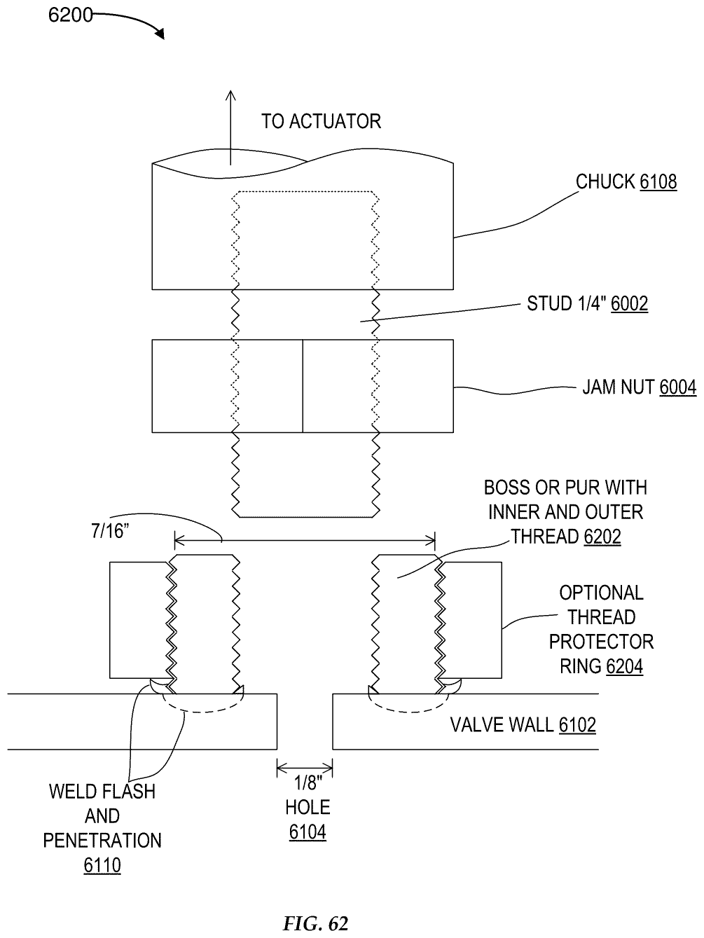

FIG. 62 is a cross-sectional side view of the very low-profile boss in FIG. 60, according to an implementation having external threads on the very low-profile boss. The very low-profile boss or PUR 6202 having external threads for receiving an optional thread protector ring or any apparatus is shown friction welded to a valve wall 6102 with a hole 6104 drilled through the valve wall 6102. The external threads of the very low-profile boss or PUR 6202 can be used to receive a secondary sealing cap, but with the threads on the inside of the cap and outside of the PUR), sensors, test equipment, valves, gates, handles, walkway or ladder supports, tags, bar codes, lighting, drill supports, tools and/or antennas. The hole 6104 in the valve wall 6102 is drilled with a narrower diameter than inner threads 6106 of the PUR 6202 to ensure that during the drilling process, the inner threads 6106 of the PUR 6202 are not damaged. To prepare for the friction welding process, the stud 6002 is screwed into the PUR 6202 and the jam nut 6004 is tightened against the PUR 6202 to prevent the stud 6002 from extending beyond the lower edge of the PUR 6202 which prevents the stud 6002 from interfering with the valve wall 6102 during the friction welding process. If the stud 6002 is not long enough to bottom out in the chuck 6108 or if the chuck 6108 does not have a stop for the stud 6002, then a second jam nut (not shown) can be added and tightened against the bottom of the chuck 6108. Any kind of thread (course thread or a fine thread) could be used for the stud 6002 and the PUR 6202. The chuck 6108 does not have to be threaded, but could be any type of chuck 6108 that could hold the stud 6002 during friction welding. The stud 6002 does not have to be threaded at its top if the chuck 6108 is capable of holding the stud 6002 without threads. Also shown in FIG. 61 is the weld flash and penetration zone 6110 from the friction weld 6010 in FIG. 60.

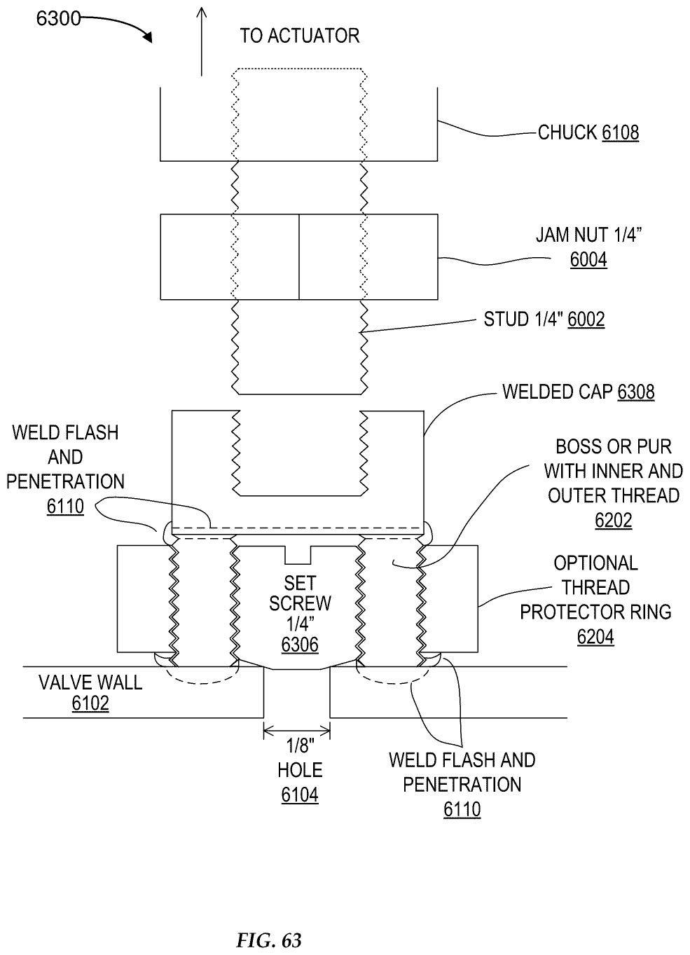

FIG. 63 is a cross-sectional side view of the very low-profile boss in FIG. 60, according to an implementation. The very low-profile boss or PUR 6202 is shown friction welded to the valve wall 6102 with the hole 6104 drilled through the valve wall 6102. The hole 6104 in the valve wall 6102 is drilled with a narrower diameter than the inner threads 6106 of the PUR 6202 to ensure that during the drilling process, the inner threads 6106 of the PUR 6202 are not damaged. The hole 6104 is usually drilled after PUR 6006 is bonded to valve wall 6102. To prepare for the friction welding process, the stud 6002 is screwed into the PUR 6202 and the jam nut 6004 is tightened against the PUR 6202 to prevent the stud 6002 from extending beyond the lower edge of the PUR 6202. This prevents the stud 6002 from interfering with the valve wall 6102 during the friction welding process. If the stud 6002 is not long enough to bottom out in the chuck 6108 or if the chuck 6108 does not have a stop for the stud 6002, then a second jam nut (not shown) can be added and tightened against the bottom of the chuck 6108. Any kind of thread (course thread or a fine thread) could be used for the stud 6002 and the PUR 6202. The chuck 6108 does not have to be threaded, but could be any type of chuck 6108 capable of holding the stud 6002 during friction welding. The stud 6002 does not need to be threaded at the top if the chuck 6108 is capable of holding the stud 6002. Also shown in FIG. 63 is the weld flash and penetration 6110 from the friction weld. The PUR 6202 is shown with outer threads that can be used for any number of attachments such as a protective cap, a mount for a threaded receiver or a tag or bar code indicating the repair date or status and particulars of the repair. An optional thread protector ring 6204 is shown and is used to protect the threads from damage. A set screw 6306 is inserted into the PUR 6202 after the hole 6104 is drilled through the valve wall 6102 to prevent chemical from leaking out of the valve after the valve repair or valve sealing is complete. Though a threaded seal may be far more reliable than other types of seals, it is not considered a permanent seal and can eventually leak. To eliminate this leak source, a welded cap 6308 is shown in FIG. 63. After the set screw 6306 is inserted into the PUR 6202, the welded cap 6308 is attached to the PUR 6202 by friction welding, creating a seal that is considered to be permanent. To friction weld the welded cap 6308 to the PUR 6202, the stud 6002 and jam nut 6004 are inserted into the welded cap 6308 to prepare for the friction welding process as before. If access to the hole 6104 is desired at a future time, a hand tool, machine tool or hand-held machine tool can be used to cut the welded cap 6308 away from the PUR 6202. The drilling of the hole 6104 in the valve wall 6102 and the insertion and removal of the set screw 6306 can be accomplished while contained in an injection system to prevent leakage of chemicals into the atmosphere. The welded cap 6308 can be welded to the PUR 6202 using any other welding or bonding technology other than friction welding.

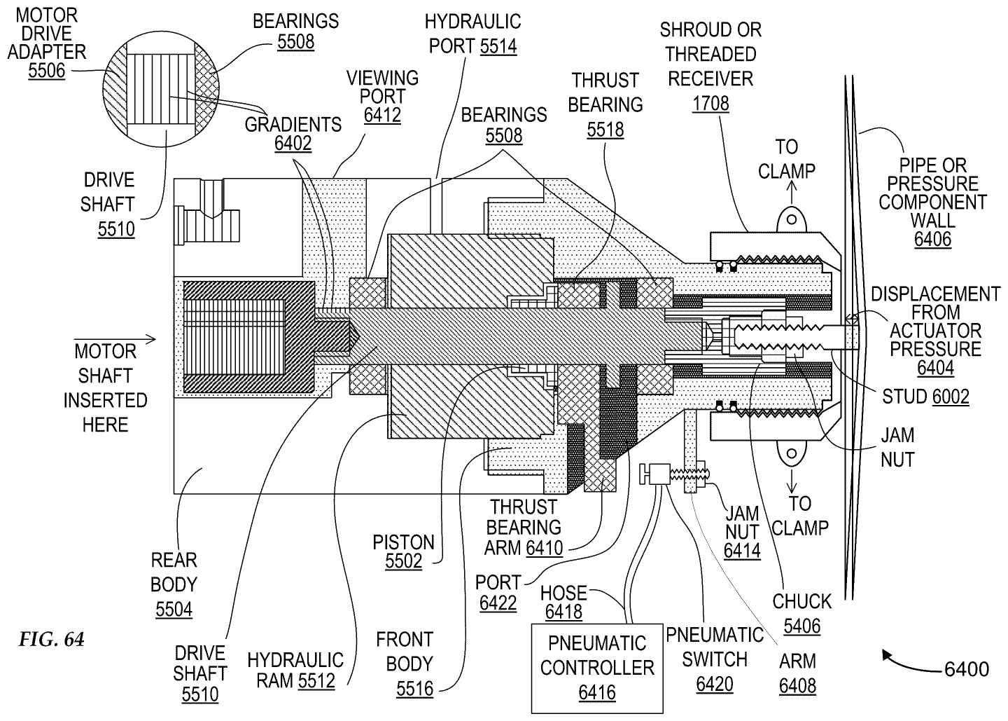

FIG. 64 is a cross section diagram of an apparatus 6400 for measuring, sensing and/or controlling stud or PUR displacement during the friction welding process, according to an implementation. As a boss or PUR 4302 is friction welded to a pipe or pressure component 6406, a portion of the boss or PUR 4302 is consumed by the weld. The consumption causes a displacement 6404 or reduction in length of the boss or PUR 4302. Also, as the actuator applies pressure to the pipe or pressure component 6406 through the boss or PUR 4302, the pipe or pressure component 6406 flexes causing excess displacement 6404. If the pipe or pressure component 6406 has thinned due to corrosion or wear such that it is at risk of punch through during the welding process, then it is desirable to indicate this to the operator or to prevent a large pressure from being applied or a weld from taking place. There is a need to measure or sense displacement 6404 of the boss or PUR2 in a friction welder. The apparatus in FIG. 64 includes two apparatus of measuring or sensing the displacement 6404 with one apparatus capable of controlling the friction welding process based on this displacement 6404. At the top left corner of FIG. 64 is a viewing port 6412 in rear body 5504. The viewing port 6412 exposes the drive shaft 5510. The drive shaft 5510 includes precision circumferential gradients 6402 that can be seen through the viewing port 6412. The precision circumferential gradients 6402 on drive shaft 5510 can be etched, cut, painted, inked or marked and must be accurately installed so that they appear relatively stationary as drive shaft 5510 rotates during a friction welding process. The precision circumferential gradients 6402 allow the displacement 6404 to be measured visually through the viewing port 6412. A crosshair (not shown) could be added in line with the viewing port 6412 to allow more accurate reading of the precision circumferential gradients 6402. In one application, the displacement caused by the actuator pressure on the pipe or pressure component 6406 is measured to determine the thickness and/or strength of the pipe or pressure component 6406. The pipe or pressure component 6406 thickness and strength are almost always known and a predetermined displacement will indicate the condition of the pipe or pressure component 6406. If corrosion has thinned the pipe or pressure component 6406 a larger amount of displacement 6404 than the predetermined amount of displacement 6404 will occur when pressure is applied by the actuator. In another application, the displacement 6404 is measured before and after the friction weld is complete to determine the amount of displacement 6404 that has occurred during a friction weld. This measurement can be used as feedback to the operator, allowing the operator to adjust the welding process to improve it. For example, if excess displacement 6404 occurs during a weld, the operator can reduce the axial pressure on the boss or PUR 4302, reduce the weld time or reduce the welder's rotational speed.

The apparatus in FIG. 64 includes another apparatus of measuring the displacement 6404 and controlling the friction welding process based on the measured displacement 6404. The apparatus in FIG. 64, also includes a pneumatic switch 6420 mounted to the body of the actuator through an arm 6408. Above and in line with the pneumatic switch 6420 is a thrust bearing arm 6410 extending off of the thrust bearing 5518 through a port 6422 cut in front body 5516. A jam nut 6414 locks the pneumatic switch 6420 in position at a predetermined distance from the thrust bearing arm 6410. Operably coupled to the pneumatic switch 6420 is a pneumatic controller 6416 that controls the welding process. As the thrust bearing 5518 is driven downwards, the thrust bearing arm 6410 presses the pneumatic switch 6420 which in turn shuts down the friction welding process. The friction welding process may also be shut down by disengaging the motor that drives the friction welder. In this way, a pneumatic switch 6420 can be used to measure displacement 6404 and control the friction welding process based on the measured displacement 6404. The pneumatic switch 6420 may generate a continually variable control signal and the pneumatic controller 6416 may be capable of receiving this continuously variable control signal through the hose 6418 from the pneumatic switch 6420. In yet another application, the pneumatic switch 6420 is used to shut down the welding process once the weld has reached a predetermined displacement or it could be used to slow the welding process by altering any number of weld parameters such as rotational speed or axial pressure as the pneumatic switch is activated.

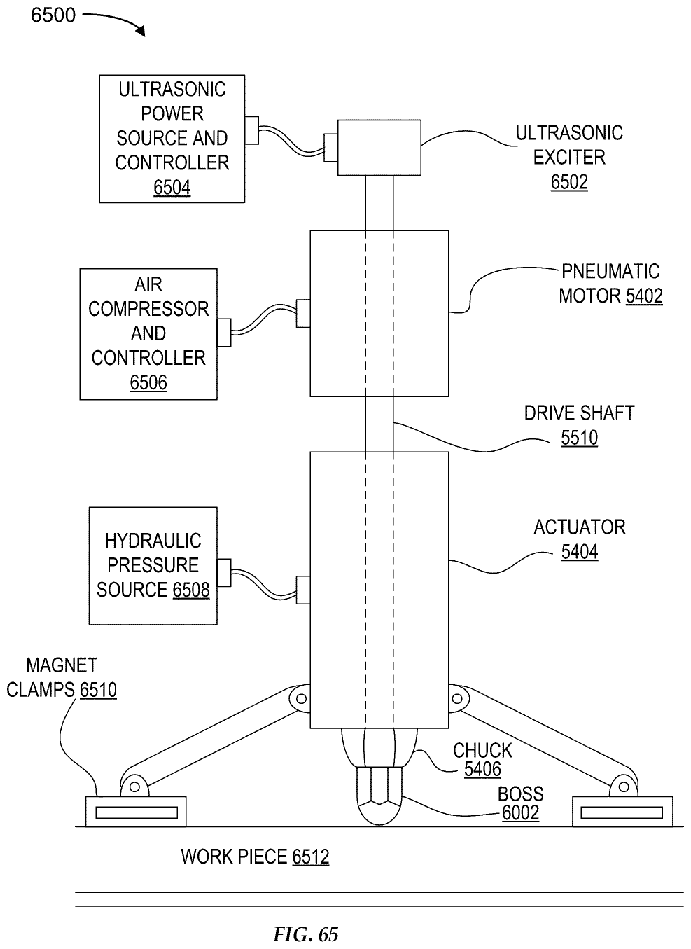

FIG. 65 is side view diagram of an ultrasonic enhanced friction welder 6500, according to an implementation. An ultrasonic exciter 6502, an ultrasonic power source and controller 6504 are added to the portable friction forge bonder (PFFB) 5400. The ultrasonic exciter 6502 is operably coupled to drive shaft 5510. By adding ultrasonic energy to the welding process, an enhanced weld can be achieved. The ultrasonic energy is transferred from the ultrasonic exciter 6502 down drive shaft 5510, through the pneumatic motor 5402, actuator 5404 and chuck 5406, down through the boss or PUR 4302 and into the work piece. This ultrasonic energy provides a stirring of the weld as it forms, creating a weld with a more homogenous metallurgical structure. In addition, the energy imparted by the ultrasonic exciter is additive with the rotational energy produced by the motor and transferred through the actuator 5404. This reduces the energy output requirement of the pneumatic motor 5402 and actuator 5404. An ultrasonic exciter 6502 is only one of many devices that can be attached to the friction welder to add mechanical vibrational energy to the welding process. Any type of vibrational energy could be used in place of the ultrasonic energy for improving the weld joint. The drive shaft 5510 could be solid or comprised of more than one piece connected together. If the drive shaft 5510 is more than one piece connected together, the connections would have to be capable of transferring the vibrational energy to the boss 6006. The ultrasonic exciter 6502 can also be placed between pneumatic motor 5402 and actuator 5404.

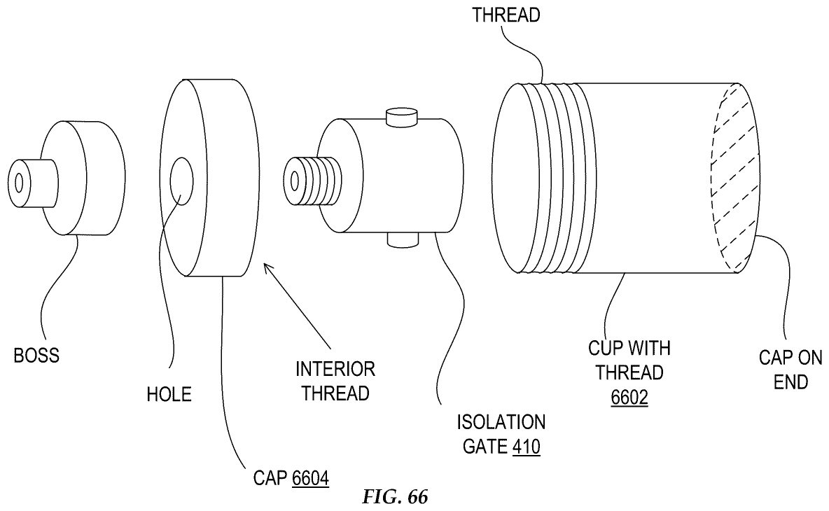

FIG. 66 is an isometric view of a threaded cup containment device 6600 for adding a backup seal for the isolation gate, according to an implementation. After a valve is repaired and an isolation gate is left in place, in time the gate or the threads between the isolation gate and the boss may start to leak. To contain this leak, a cup with thread 6602 can be mounted over the isolation gate to provide a second layer or backup seal for the isolation gate. Before the isolation gate is operably coupled to the boss, a cap 6604 is installed and held in place by the isolation gate. The threaded cup 6602 is installed over the isolation gate and screwed into the cap 6604 with interior threads. This cup 6602 and cap 6604 assembly combination is used to collect any chemical leakage from the isolation gate. If the interface between the boss, cap 6604 and isolation gate does not create a good seal, then washers with center holes about the diameter of the isolation gate threads can be installed on each side of the cap 6604. The cup 6602 and cap 6604 can be made out of metal, carbon fiber, polymers, compounds or any material that is capable of providing a good seal with durability.

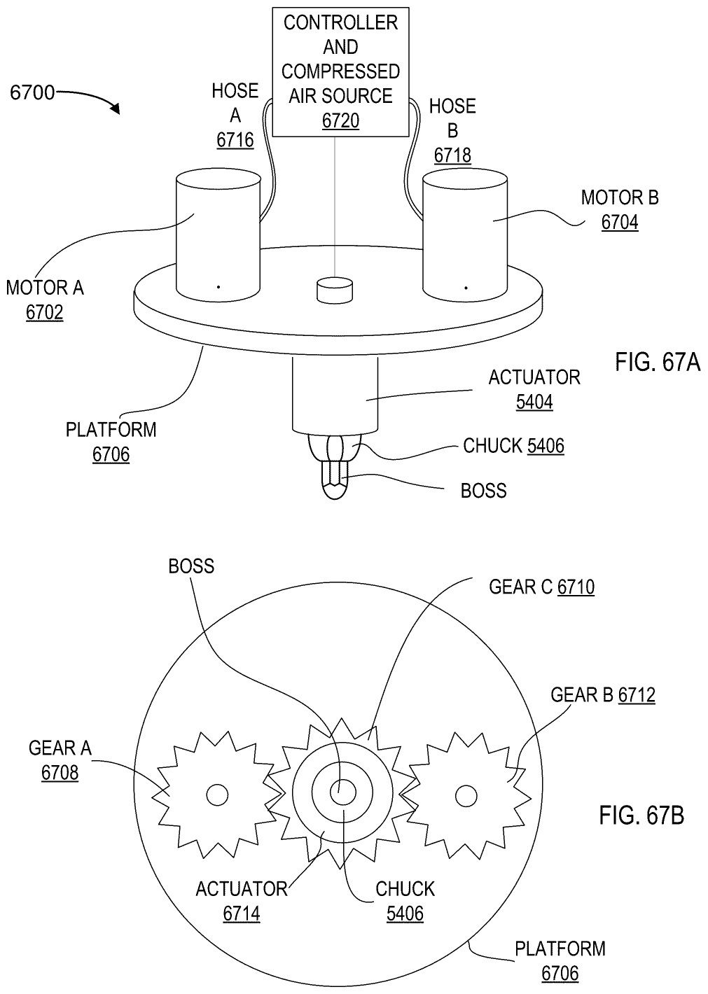

FIG. 67A is an isometric diagram of a multi-motor drive system for doubling the drive capability of a portable friction welding system 6700, according to an implementation. FIG. 67B is a bottom view block diagram of a multi-motor drive system for doubling the drive capability of a portable friction welding system 6700, according to an implementation. Motor A 6702 and motor B 6704 are mounted on a platform 6706. In some implementations, motors 6702 and 6704 are pneumatic motors. Gear A 6708 is connected to the end of the drive shaft of motor A 6702 on the bottom side of the platform 6706 and gear B is connected to the end of the drive shaft of motor B 6704 on the bottom side of the platform 6706. Gear C 6710 is meshed with gear A 6708 and gear B 6712 on the bottom side of the platform 6706 and connected to the drive shaft of the actuator 6714. The chuck 5406 is connected axially to the actuator 6714 and the boss is mounted in the chuck 5406. Hose A 6416 and hose B 6718 connect a controller and a compressed air source 6720 to motor A 6702 and motor B 6704. When the controller and compressed air source 6720 activate motor A 6702 and motor B 6704, gear A 6708 and gear B 6712 drive gear C 6710 in the opposite rotational direction which in turn drives the actuator 5404 in that same opposite rotational direction. If gear A 6708, gear B 6712 and gear C 6710 are the same size, then the torque and horsepower transferred to the actuator will be double that of a single motor, which will allow a larger diameter stud or boss to be friction welded to a work piece with a portable friction welder. Three or more motors could be added to the portable friction welding system 6700 to further to multiply the torque and horsepower transferred to the actuator 5404. Different gear ratios could be used multiply or divide the torque transferred from the motors 6702 and 6704 to the actuator 5404. For example, if gear A 6708 and gear B 6712 contain half the number of teeth as gear C 6710, torque transferred to the actuator 5404 would increase by a factor of two and the rotational speed would be reduce by a factor of two. Likewise, if gear A 6708 and gear B 6712 have more teeth than gear C 6710, torque would be decreased and rotational speed would be increased. It is necessary for the compressed air source 6720 to be capable of delivering twice the air volume at the same pressure as is necessary for driving a portable friction forge bonder (PFFB) 5400. A chain and sprocket or belt and sprocket drive mechanism can add together and transfer the energy from the motors 6702 and 6704 to the actuator 5404. A transmission, differential or any mechanical coupler could also be used in place of the gears 6708, 6710 and 6712 shown in FIG. 67B. Two separate controller and compressed air sources 6720 could be used, one controller with two compressed air sources or two controllers with one compressed air source. It should be obvious to one skilled in the art that other power sources and controllers could be used in place of the controller and compressed air source 6720 and different controllers could be used for controlling these differing power sources. If different controllers and power sources are use, different motors would also have to be used. For example if electric controllers and power sources are used, then electric motors must also be used.

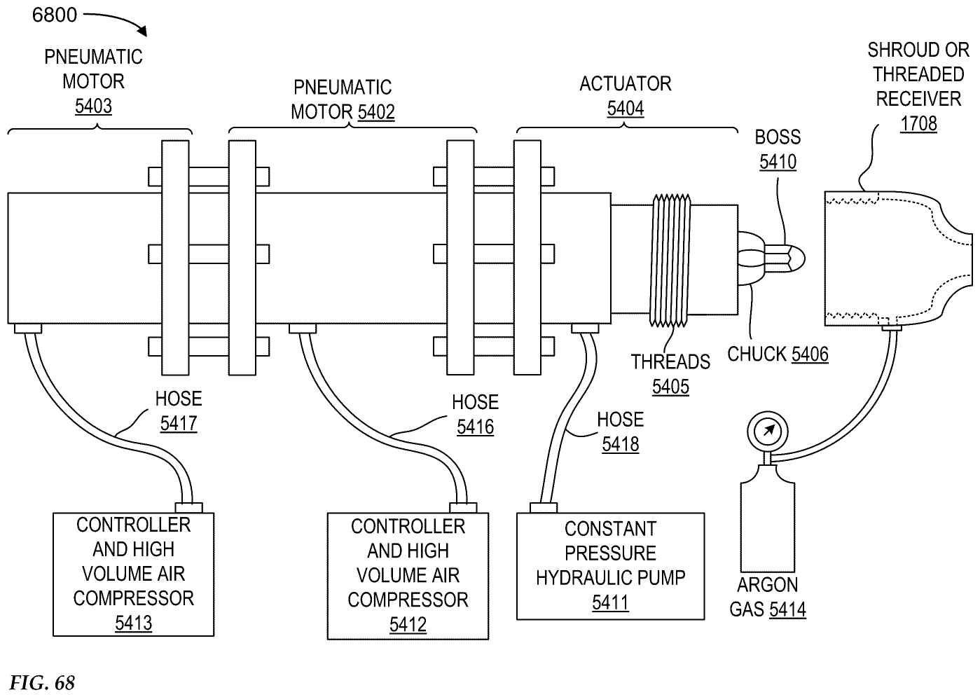

FIG. 68 is a block diagram of a multi-motor drive system for doubling the drive capability of a portable friction welding system, according to an implementation. Pneumatic motor 5402 and pneumatic motor 5403 are mounted together, axially aligned in a series configuration. The drive shaft of motor 5402 and motor 5403 are operably and axially coupled together. Motor 5402 is axially and operably coupled to one end of the actuator 5404 and the boss 5410 is operably and axially connected to the other end of the actuator 5404. A boss or boss 5410 is mounted in the chuck 6406 in preparation for a weld. Hose 5416 connects controller and high volume air compressor 5412 to motor 5402 and hose 5417 connects controller and high volume air compressor 5413 to motor 5403. Controller and high volume air compressor 5412 controls the flow of air to motor 5402 and controller and high volume air compressor 5413 controls the flow of air to motor 5403. The controller portion of controller and high volume air compressor 5412 and 5413 control the volume and pressure of air in an on and off manner. A more sophisticated controller could be used to vary the volume and/or pressure of air during the friction welding process. When controller and high volume air compressor 5412 and 5413 activate motor 5402 and motor 5403, the coupled drive shafts transfer the torque from motor 5402 and motor 5403 in the same rotational direction to drive the actuator 5404. Unlike the multi-motor drive system of FIG. 67, different gear ratios cannot be used without the addition of a gear box between motor 5402 and actuator 5404. Therefore, the torque and horsepower transferred to the actuator 5404 will be double that of a single motor, which will allow a larger diameter stud or boss 5410 to be friction welded to a work piece with a portable friction welder. Three or more motors could be added to this multi-motor drive system 6800 in series to further multiply the torque and horsepower transferred to the actuator 5404. It is necessary for the controller and high volume air compressor to be capable of delivering twice the air volume at the same pressure as is necessary for driving a two motor system. One controller and high volume air compressor could be used, one controller with two high volume air compressors or two controllers with one high volume air compressor. Other power sources and controllers could be used in place of the controller and high volume air compressor and different controllers could be used for controlling these differing power sources. If different power sources are use, different motors would also have to be used. For example if electric controllers and power sources are used, then electric motors must also be used.

The apparatus and methods of FIG. 42-68 of this disclosure can be implemented with the apparatus and methods of FIG. 1-41.

In this disclosure, friction welding, friction bonding, solid-state welding, friction forging, friction forge bonding, friction forge welding, inertia welding and inertia bonding are all used synonymously. Boss and permanent universal receiver (PUR) are also used synonymously. MIG welding, TIG welding, GMAW, GTAW, FCAW, SMAW and arc welding are used synonymously in this disclosure.

The techniques and apparatus of the drawings and detailed description can be implemented in the energy industry in petrochemical, oil and gas, nuclear, coal and gas power plants, solar and wind, hydro-electric and transportation of energy products by rail, truck, ships, pipeline and air; the drawings and detailed description can be implemented in the construction of buildings, bridges and towers; the drawings and detailed description can be implemented in marine construction of ships, commercial and military, submarines, tankers and barges at ship yards, docks, offshore and semisubmersibles; and the drawings and detailed description can be implemented in mining, underground, agriculture, grain storage and aviation and space.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure.

This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

1. An apparatus comprising:
a curved portion of a storage tank having an exterior surface, having an interior surface and having a defect;
a gasket positioned over the defect in the curved portion of the storage tank, the gasket having a length, a width and a thickness;
a rigid patch positioned over the gasket, and curved to match the curved portion of the storage tank around the defect, the rigid patch having a length, a width and a thickness, the length of the rigid patch being greater than the length of the gasket, the width of the rigid patch being greater than the width of the gasket; and
a plurality of studs and a plurality of nuts positioned near an outer perimeter of the rigid patch, the plurality of studs being friction welded to the exterior surface of the curved portion of the storage tank.

2. The apparatus of claim 1 wherein the gasket further comprises:
a rubber gasket.

3. The apparatus of claim 1 wherein the gasket further comprises:
an epoxy resin or polymer.

4. The apparatus of claim 1 wherein the gasket further comprises:
a perimeter gasket.

5. The apparatus of claim 1 wherein the rigid patch further comprises:
a metal patch.

6. The apparatus of claim 1 wherein the rigid patch further comprises:
a soft metal patch.

7. The apparatus of claim 1 wherein the rigid patch further comprises:
a polymer patch.

8. The apparatus of claim 1 wherein the rigid patch has an equal number of mounting holes as studs and each of the studs passes through a corresponding mounting hole.

9. The apparatus of claim 1 wherein a geometric shape of the rigid patch further comprises:
a square geometric shape.

10. The apparatus of claim 1 wherein a geometric shape of the rigid patch further comprises:
a round geometric shape.

11. The apparatus of claim 1 wherein a geometric shape of the rigid patch further comprises:
a rectangular geometric shape.

12. The apparatus of claim 1 wherein each of the nuts further comprise:
a standard nut.

13. The apparatus of claim 1 wherein each of the nuts further comprise:
a locking nut.

14. The apparatus of claim 1 wherein each of the nuts further comprise:
a tamper resistant nut.

15. An apparatus comprising:
a curved portion of a storage tank having an exterior surface, having an interior surface and having a defect;
a steel patch positioned over the curved portion of the storage tank; and
a plurality of studs and a plurality of nuts positioned near an outer perimeter of the steel patch, the plurality of studs being friction welded to the exterior surface of the curved portion of the storage tank.

16. The apparatus of claim 15 further comprising:
a gasket positioned over the defect in the curved portion of the storage tank and under the steel patch.

17. The apparatus of claim 16 wherein the gasket further comprises:
a rubber gasket.

18. The apparatus of claim 16 further comprising:
the steel patch being curved to match the curved portion of the storage tank around the defect, the steel patch having a length, a width and a thickness.

19. The apparatus of claim 16 wherein the gasket further comprises:
an o-ring.

20. An apparatus comprising:
a curved portion of a storage tank having an exterior surface, having an interior surface and having a defect;
a gasket positioned around the defect in the curved portion of the storage tank, the gasket having a length, a width and a thickness;
a rigid patch positioned over the gasket, the rigid patch having a length and a width and a thickness; and
a plurality of studs and nuts positioned near an outer perimeter of the rigid patch, the plurality of studs being friction welded to the exterior surface of the curved portion of the storage tank.
